(19) United States
(12) Patent Application Publication
(10) Pub. No.: US 2025/0385427 A1
(43) Pub. Date: Dec. 18, 2025

(54) Antenna and Electronic Device

(71) Applicant: Huawei Technologies Co., Ltd., Shenzhen (CN)

(72) Inventors: Pengfei Wu, Shanghai (CN); Hanyang Wang, Reading (GB); Meng Hou, Shanghai (CN)

(21) Appl. No.: 18/832,333

(22) PCT Filed: Dec. 14, 2022
(86) PCT No.: PCT/CN2022/139115

§ 371 Date: Jan. 31, 2025

(30) Foreign Application Priority Data
Jan. 28, 2022 (CN) 202210108537.4
Aug. 4, 2022 (CN) 202210932953.6

(51) Int. Cl. H01Q 1/52; H01Q 1/24; H01Q 1/48; H01Q 5/10; H01Q 5/335

(52) U.S. Cl. CPC H01Q 1/521; H01Q 1/242; H01Q 1/48; H01Q 5/10; H01Q 5/335

(57) ABSTRACT

An antenna includes a first radiator and a transmission line having a first end and a second end. The first end is coupled proximate to a ground end or an open end of the first radiator, and a length T of the transmission line is set to satisfy T=¼λ or T=½λ, where λ is a dielectric wavelength corresponding to one of resonances generated by the antenna when the antenna is fed. A feeding circuit is coupled to a coupling point of the transmission line in a configuration for feeding the first radiator through the transmission line.

### TECHNICAL FIELD

Embodiments of this application mainly relate to the antenna field. More specifically, embodiments of this application relate to an antenna and an electronic device including the antenna.

### BACKGROUND

With rapid development of key technologies such as curved displays and flexible displays, lightness and thinness and an ultimate screen-to-body ratio have become a trend of terminal electronic devices such as mobile phones. This design greatly compresses antenna space. In addition, a user has an increasingly high requirement on photographing or another function for an electronic device such as a mobile phone. As a result, a quantity of cameras and volumes of the cameras gradually increase, leading to an increasingly complex antenna design for the electronic device. Moreover, 3G, 4G, and 5G frequency bands will coexist as communication frequency bands of mobile phones for a long time. This leads to an increasing quantity of antennas, wider frequency band coverage, and more serious mutual influence. In this environment, it is increasingly difficult to design an antenna that satisfies a communication requirement such as a high efficiency bandwidth, and it is difficult to satisfy the requirement by using a conventional antenna. In a current state, based on these situations, it is urgent to implement a new antenna with a wide frequency band, high efficiency, and miniaturization on the mobile phones.

In addition, with development of mobile systems, multi-band and multi-antenna systems have become an important trend of development of mobile communication. However, strong mutual coupling is more likely to occur between antenna elements with small space. As a result, performance of an array antenna is distorted. For example, a multiple-input multiple-output (multi-input multi-output, MIMO) technology, as a main technology for improving a system channel capacity and improving spectrum resource utilization, greatly expands space for increasing a data transmission rate, and is a current research focus in the field of wireless communication. An antenna is an indispensable terminal component of a wireless system. Performance of the antenna determines overall performance of the system. As the wireless system continuously develops towards miniaturization, distances between a plurality of antennas in a MIMO system are continuously reduced, and mutual coupling between antenna elements is continuously enhanced. As a result, performance of the plurality of antennas is sharply reduced, and an advantage of the MIMO system is severely weakened. A research focus of the antenna field is improving isolation between the plurality of antennas while keeping miniaturization of an antenna system.

### SUMMARY

To provide a multi-mode broadband antenna or an antenna pair with high isolation, embodiments of this application provide an antenna and a related electronic device.

In a first aspect of the present disclosure, an antenna is provided. The antenna includes a first radiator, including a ground end and an open end; a transmission line, having a first end and a second end, where the first end is coupled to the ground end or the open end of the first radiator, and the second end is open or grounded; and a feeding unit, coupled to a coupling point of the transmission line and feeding the first radiator through the transmission line. When the feeding unit performs feeding, the first radiator is configured to generate a first resonance, and the transmission line is configured to generate a resonance in an adjacent frequency band of the first resonance.

In an implementation, the coupling point deviates from a midpoint of the transmission line.

In an implementation, the antenna further includes a second radiator, including a ground end and an open end. The second end of the transmission line is coupled to the ground end or the open end of the second radiator. When the feeding unit performs feeding, the second radiator is configured to generate a second resonance, and the transmission line is further configured to generate a resonance in an adjacent frequency band of the second resonance. In an implementation, the first end of the transmission line is coupled to the ground end of the first radiator, and the second end is grounded or coupled to the ground end of the second radiator. The coupling point is located close to the first end or the second end.

In an implementation, the first end of the transmission line is coupled to the open end of the first radiator, and the second end is open or coupled to the open end of the second radiator. The coupling point is located close to the midpoint.

In an implementation, the first end of the transmission line is coupled to the ground end of the first radiator, and the second end is open or coupled to the open end of the second radiator. The coupling point is located close to the first end.

In an implementation, a length T of the transmission line satisfies ½λ1≤T≤½λ2, and λ1 and λ2 are respectively a minimum dielectric wavelength and a maximum dielectric wavelength of an operating frequency band corresponding to a lowest resonance generated by the antenna when the feeding unit performs feeding.

In an implementation, a length T of the transmission line satisfies ¼λ1≤T≤¼λ2, and λ1 and λ2 are respectively a minimum dielectric wavelength and a maximum dielectric wavelength of an operating frequency band corresponding to a lowest resonance generated by the antenna when the feeding unit performs feeding.

In an implementation, the transmission line includes two sections connected by a capacitor. The coupling point is located on one of the two sections.

In an implementation, the transmission line is coupled to the first radiator through a first matching circuit, and/or the transmission line is coupled to the second radiator through a second matching circuit.

In an implementation, the transmission line may include any one of the following items; a microstrip, a coaxial line, a liquid crystal polymer material, a support antenna body, a glass antenna body, and any combination of the foregoing items.

In an implementation, the antenna further includes a regulation circuit 105, coupled between a predetermined position of the transmission line and ground, and includes at least one of a capacitor and an inductor.

In a second aspect of this application, an antenna is provided. The antenna includes a radiator pair, where a first radiator and a second radiator in the radiator pair each include a ground end and an open end; at least one transmission line, coupled to the radiator pair, where the at least one transmission line includes a first transmission line, and the first transmission line includes a first section and a second section of unequal lengths; and a feeding unit, where the feeding unit includes a first feeding part, and the first feeding part is coupled to the first radiator and the second radiator respectively through the first section and the second section.

The two sections of unequal lengths are coupled to the feeding unit to feed the radiator pair. According to an embodiment of this application, an asymmetrically fed antenna is provided, and therefore excitation currents with a phase difference can be introduced between the radiator pair. In this manner, a multi-mode broadband antenna may be formed, and an antenna pair with high isolation may further be formed.

In an implementation, the antenna further includes a matching circuit coupled between the first feeding part and the first transmission line. The matching circuit includes a capacitor and/or an inductor. A length of the first transmission line is less than or equal to 1/10 of a dielectric wavelength corresponding to a lowest operating frequency band of the antenna.

In an implementation, a difference (T2−T1) between the lengths of the two sections of the first transmission line satisfies 0 mm≤(T2−T1)≤8 mm, or a ratio T1/T2 of the lengths of the two sections of the first transmission line satisfies ½≤T1/T2≤2.

In an implementation, the at least one transmission line further includes a second transmission line, and the second transmission line includes a third section and a fourth section of unequal lengths. The feeding unit includes a second feeding part, and the second feeding part is separately coupled to the radiator pair through the third section and the fourth section. In this manner, the antenna pair with high isolation may be implemented in a simple and effective manner.

In an implementation, both the first feeding part and the second feeding part are coupled to the ground end of the first radiator or are coupled to the open end of the first radiator, and both the first feeding part and the second feeding part are coupled to the open end of the second radiator or are coupled to the ground end of the second radiator. Alternatively, the first feeding part and the second feeding part are respectively coupled to the ground end of the first radiator and the open end of the first radiator, and the first feeding part and the second feeding part are respectively coupled to the open end of the second radiator and the ground end of the second radiator. In the foregoing several implementations, an arrangement manner of the antenna is more flexible, to satisfy different requirements in various scenarios. In an implementation, the antenna is configured to generate a first resonance when the first feeding part performs feeding, and the antenna is configured to generate a second resonance when the second feeding part performs feeding. The first resonance and the second resonance are at least partially located in a same frequency band, or the first resonance and the second resonance are at least partially located in two different frequency bands. In this manner, frequency bands supported by the antenna pair may be a same frequency band, different frequency bands, or adjacent frequency bands, to obtain an antenna with a wider application scope.

In an implementation, a ratio T1/T2 of the lengths of the first section and the second section of the first transmission line satisfies ¼≤T1/T2≤½λ.

In an implementation, a ratio T3/T4 of the lengths of the third section and the fourth section of the second transmission line satisfies ¼≤T3/T4≤½λ.

In an implementation, a difference (T6−T5) between a length T6 of the second transmission line and a length T5 of the first transmission line and a first dielectric wavelength λ1 of the first resonance or a second dielectric wavelength λ1 of the second resonance satisfy ¼λ1≤(T6−T5)≤¾λ1 or ¼λ2≤(T6−T5)≤¾λ2. For example, in some implementations, the difference between the lengths may be approximately ½ of a dielectric wavelength, to ensure that the excitation currents fed to the radiator pair through the first transmission line and the second transmission line have a phase difference of approximately 180°, thereby implementing a multi-mode broadband antenna and implementing an antenna pair with high isolation.

In an implementation, when the first resonance and the second resonance are in a low frequency band less than 1.2 GHz, the difference (T6−T5) between the lengths of the second transmission line and the first transmission line satisfies 50 mm≤(T6−T5)≤80 mm. Alternatively, when the first resonance and the second resonance are in a medium and high frequency band less than 3 GHz, the difference (T6−T5) between the lengths of the second transmission line and the first transmission line satisfies 25 mm≤(T6−T5)≤40 mm. In this manner, the difference between the lengths of the second transmission line and the first transmission line may be about ½ of a dielectric wavelength, thereby allowing the phase difference of the excitation currents to be within a range of 1° to 180°.

In an implementation, an equivalent length of the first transmission line or the second transmission line is determined in at least one of the following manners: a capacitor or an inductor disposed between a corresponding transmission line and a radiator pair, a phase shifter disposed on a corresponding transmission line, and a position at which a corresponding transmission line is coupled to the radiator pair. In this manner, different equivalent lengths may be set for electronic devices of different models, so that an electronic device having an antenna with improved performance can be obtained more pertinently.

In an implementation, the at least one transmission line may include any one of the following items: a microstrip, a coaxial line, a liquid crystal polymer material, a support antenna body, a glass antenna body, and any combination of the foregoing items. In this manner, the transmission line can be made of a proper material based on different requirements, so that antenna performance can be improved in a cost-effective manner.

According to a third aspect of embodiments of this application, an antenna is provided. The antenna includes a radiator pair, where a first radiator and a second radiator in the radiator pair each include a ground end and an open end; a first transmission line, coupled to the radiator pair, where the first transmission line includes two sections; and a first feeding part, separately coupled to a first feeding point of the first radiator and a second feeding point of the second radiator through the two sections of the first transmission line, and a phase difference that is of excitation currents provided by the first feeding part and that is between the first feeding point and the second feeding point is within a range of 90°±45°. In an embodiment, the phase difference that is of the excitation currents provided by the first feeding part and that is between the first feeding point and the second feeding point is within a range of 90°±30°. In this manner, the antenna may be used in any suitable manner to ensure that the phase difference that is of the excitation currents and that is between the first feeding point and the second feeding point satisfies the foregoing requirement, thereby improving manufacturing flexibility and improving performance of the antenna.

In an implementation, the antenna further includes a second transmission line and a second feeding part. The second transmission line includes two sections. The second feeding part is separately coupled to a third feeding point of the first radiator and a fourth feeding point of the second radiator through the two sections of the second transmission line. A phase difference that is of a current and that is between the first feeding point and the third feeding point is within a range of 180°±60°, and a phase difference that is of a current and that is between the second feeding point and the fourth feeding point is within a range of 180°±60°. In an embodiment, the phase difference that is of the current and that is between the first feeding point and the third feeding point is within a range of 180°±45°. In an embodiment, the phase difference that is of the current and that is between the second feeding point and the fourth feeding point is within a range of 180°±45°.

According to a fourth aspect of embodiments of this application, an electronic device is provided. The electronic device includes a housing, including a side frame; a circuit board, arranged in the housing and including a feeding unit; and an antenna according to the first, the second, or the third aspect. By using the antenna mentioned above, the electronic device can implement multi-mode broadband coverage, thereby improving performance of the electronic device.

In some implementations, a first radiator of the antenna includes a first continuous section of the side frame, and a second radiator includes a second continuous section of the side frame. This arrangement manner is more conducive to improving flexibility of arrangement of the antenna in the electronic device.

In an implementation, the first radiator and the second radiator are separated on the side frame; or the first radiator and the second radiator are continuous on the side frame.

In an implementation, the radiator pair is arranged on an inner side of the housing. The foregoing several implementations make arrangement of the antenna in the electronic device more flexible, thereby facilitating arrangement of a broadband multi-mode antenna and an antenna pair with high isolation in the electronic device. In an implementation, the antenna is arranged on the inner side of the housing. This arrangement manner further improves flexibility of arrangement of the antenna in the electronic device.

In an implementation, a ground end of the first radiator and a ground end of the second radiator are a common ground end.

In an implementation, an open end of the first radiator and an open end of the second radiator are disposed opposite to each other and form a slot, and a width of the slot is less than 3 mm.

### BRIEF DESCRIPTION OF DRAWINGS

The foregoing features, advantages and aspects and other features, advantages and aspects of embodiments of this application become clearer with reference to accompanying drawings and the following detailed descriptions. In the accompanying drawings, the same or similar reference signs of the accompanying drawings represent the same or similar elements.

FIG. 1 shows a schematic exploded view of an electronic device according to an embodiment of this application;

FIG. 2 shows a schematic cross-sectional view of a microstrip;

FIG. 3 shows a schematic diagram of a transmission line according to an embodiment of this application:

FIG. 4 shows a schematic diagram of a transmission line that is grounded at two ends according to an embodiment of this application, and diagrams of an S11 curve, an efficiency curve, current directions and electric field distribution of the transmission line existing when the transmission line is fed;

FIG. 5 shows a schematic diagram of a transmission line that is grounded at two ends and that exists after a regulation circuit is added to the transmission line according to an embodiment of this application, and a diagram comparing S11 curves of the transmission line existing before and after the regulation circuit is added:

FIG. 6 shows a schematic diagram of an antenna formed by coupling one end of a transmission line that is grounded at two ends to a radiator according to an embodiment of this application:

FIG. 7 shows schematic diagrams of S11 curves and efficiency curves of the transmission line and the antenna shown in FIG. 5 and FIG. 6:

FIG. 8 shows a schematic diagram of an antenna formed by coupling two end of a transmission line that is grounded at the two ends to a radiator according to an embodiment of this application;

FIG. 9 shows schematic diagrams of an S11 curve and an efficiency curve of the antenna shown in FIG. 8:

FIG. 10 shows diagrams of current directions, electric field distribution, and radiation patterns of the antenna shown in FIG. 8 at different resonance frequencies;

FIG. 11 shows a schematic diagram of a variant antenna formed by coupling two ends of a transmission line that is grounded at the two ends to a radiator according to an embodiment of this application;

FIG. 12 shows schematic diagrams of an S11 curve and an efficiency curve of the antenna shown in FIG. 11;

FIG. 13 shows diagrams of current distribution of the antenna shown in FIG. 11 at different resonance frequencies;

FIG. 14 shows schematic diagrams comparing S11 curves and efficiency curves of the antenna shown in FIG. 11 and a T antenna that is directly fed:

FIG. 15 shows a schematic diagram of an antenna formed by applying a transmission line that is grounded at two ends according to an embodiment of this application to two radiators of equivalent sizes:

FIG. 16 shows schematic diagrams of an S11 curve and an efficiency curve of the antenna shown in FIG. 15;

FIG. 17 shows diagrams of current distribution of the antenna shown in FIG. 15 at different resonance frequencies:

FIG. 18 shows schematic diagrams in which a transmission line in the antenna shown in FIG. 15 may reduce an occupied area by increasing a dielectric constant, and diagrams comparing corresponding S11 curves and efficiency curves:

FIG. 19 shows schematic diagrams in which an occupied area of a transmission line in the antenna shown in FIG. 15 may be reduced by using a curved structure of the transmission line, and diagrams comparing corresponding S11 curves and efficiency curves,

FIG. 20 shows a schematic diagram of an antenna formed after an impedance matching circuit is disposed between the transmission line and the radiators in the antenna shown in FIG. 15 and diagrams of a corresponding S11 curve and efficiency curve;

FIG. 21 shows diagrams of current directions of the antenna shown in FIG. 20 at different resonance frequencies:

FIG. 22 shows a schematic diagram of a T antenna that is directly fed and schematic diagrams of S11 curves and efficiency curves of the T antenna and the foregoing several antennas:

FIG. 23 shows diagrams of efficiency curves of the antenna shown in FIG. 22 and the foregoing several antennas in a left-hand mode and a right-hand mode;

FIG. 24 shows a schematic diagram of a transmission line that is open at two ends according to an embodiment of this application:

FIG. 25 shows schematic diagrams of an S11 curve and an efficiency curve of a transmission line that is open at two ends and that exists when the transmission line is fed according to an embodiment of this application;

FIG. 26 shows diagrams of current directions and electric field distribution of a transmission line that is open at two ends and that exists when the transmission line is fed according to an embodiment of this application;

FIG. 27 shows a schematic diagram of a transmission line that is open at two ends and that exists after a regulation circuit is added to the transmission line according to an embodiment of this application, and a diagram comparing S11 curves of the transmission line existing before and after the regulation circuit is added;

FIG. 28 shows a schematic diagram of an antenna formed by coupling one end of a transmission line that is open at two ends to a radiator according to an embodiment of this application:

FIG. 29 shows schematic diagrams of S11 curves and efficiency curves of the transmission line and the antenna shown in FIG. 27 and FIG. 28;

FIG. 30 shows a schematic diagram of an antenna formed by coupling two ends of a transmission line that is open at the two ends to a radiator according to an embodiment of this application;

FIG. 31 shows schematic diagrams of an S11 curve and an efficiency curve of the antenna shown in FIG. 30;

FIG. 32 shows diagrams of current directions, electric field distribution, and radiation patterns of the antenna shown in FIG. 30 at different resonance frequencies;

FIG. 33 shows a schematic diagram of an antenna formed by applying a transmission line that is open at two ends according to an embodiment of this application to two radiators of equivalent sizes:

FIG. 34 shows schematic diagrams of an S11 curve and an efficiency curve of the antenna shown in FIG. 33;

FIG. 35 shows schematic diagrams of current directions and electric field distribution of the antenna shown in FIG. 33 at different resonance frequencies:

FIG. 36 shows a schematic diagram of a slot antenna that is directly fed and schematic diagrams comparing S11 curves and efficiency curves of the slot antenna and the foregoing several antennas;

FIG. 37 shows diagrams of efficiency curves of the antenna shown in FIG. 36 and the foregoing several antennas in a left-hand mode and a right-hand mode;

FIG. 38 shows a schematic diagram of a transmission line that is open at one end and grounded at the other end according to an embodiment of this application;

FIG. 39 shows schematic diagrams of an S11 curve and an efficiency curve of a transmission line that is open at one end and grounded at the other end and that exists when the transmission line is fed according to an embodiment of this application;

FIG. 40 shows diagrams of current directions and electric field distribution of a transmission line that is open at one end and grounded at the other end and that exists when the transmission line is fed according to an embodiment of this application:

FIG. 41 shows a schematic diagram of an antenna formed by coupling one end of a transmission line that is open at one end and grounded at the other end to a radiator according to an embodiment of this application;

FIG. 42 shows schematic diagrams of S11 curves and efficiency curves of the transmission line and the antenna shown in FIG. 38 and FIG. 41;

FIG. 43 shows a schematic diagram of an antenna formed by coupling two ends of a transmission line that is open at one end and grounded at the other end to a radiator according to an embodiment of this application;

FIG. 44 shows schematic diagrams of an S11 curve and an efficiency curve of the antenna shown in FIG. 43;

FIG. 45 shows schematic diagrams of current directions of the antenna shown in FIG. 43 at different resonance frequencies:

FIG. 46 shows a schematic diagram of a structure of a transmission line that is grounded at two ends and that is disconnected in the middle to form two sections according to an embodiment of this application;

FIG. 47 shows diagrams of an S11 curve and an efficiency curve, and schematic diagrams of current distribution and electric field distribution of the structure of the transmission line shown in FIG. 46 existing when the structure of the transmission line is fed:

FIG. 48 shows a schematic diagram of a transmission line that uses a feeding manner different from that of the transmission line shown in FIG. 46, and a diagram of S11 curves of the two transmission lines;

FIG. 49 shows schematic diagrams of antennas formed by coupling one end of the transmission line shown in FIG. 48 to a radiator, and diagrams of a corresponding S11 curve and efficiency curve;

FIG. 50 shows a schematic diagram of an antenna formed by coupling two ends of the transmission line shown in FIG. 48 to a T radiator;

FIG. 51 shows schematic diagrams of an S11 curve and an efficiency curve, and schematic diagrams of current directions of the antenna shown in FIG. 50 at different resonance frequencies:

FIG. 52 shows a schematic diagram of an antenna in which a transmission line is changed from a microstrip to a support wiring, and schematic diagrams of S11 curves and efficiency curves of the antenna and an antenna in which a transmission line is a microstrip:

FIG. 53 shows a schematic diagram of an antenna formed by connecting to three radiators according to an embodiment of this application:

FIG. 54 shows a schematic diagram of a simplified structure of an antenna that uses one feeding part for feeding according to an embodiment of this application:

FIG. 55 shows schematic diagrams of current directions and a current phase of the antenna shown in FIG. 54 existing when the antenna operates,

FIG. 56 shows schematic diagrams of a simplified structure, current directions, and a current phase existing when a feeding part performs feeding through a longer transmission line according to an embodiment of this application:

FIG. 57 shows a schematic diagram of a simplified structure of a T antenna in which a matching circuit is disposed between a transmission line and a feeding unit according to an embodiment of this application;

FIG. 58 shows a schematic diagram of a simplified structure of a slot antenna in which a matching circuit is disposed between a transmission line and a feeding unit according to an embodiment of this application;

FIG. 59 shows a schematic diagram of a simplified structure of an antenna existing when the antenna uses two feeding parts and transmission lines of different equivalent lengths to feed a radiator pair according to an embodiment of this application:

FIG. 60 shows diagrams of current directions of the antenna structure shown in FIG. 59 in different operating modes,

FIG. 61 and FIG. 62 each show a schematic diagram of a simplified structure of an antenna that uses a T antenna structure according to an embodiment of this application;

FIG. 63 shows diagrams of current directions of the antenna shown in FIG. 62 in different operating modes;

FIG. 64 shows radiation patterns of the antenna shown in FIG. 62 in different operating modes;

FIG. 65 shows efficiency curves in a free space mode, a right-hand mode, and a left-hand mode and S11 curves of the antenna shown in FIG. 62:

FIG. 66 shows a schematic diagram of a simplified structure of an antenna that uses a deformed T antenna structure according to an embodiment of this application;

FIG. 67 and FIG. 68 each show a schematic diagram of a simplified structure of an antenna that uses another T antenna structure according to an embodiment of this application;
(a) in FIG. 69 shows a schematic diagram of a single distributed T antenna. (b) in FIG. 69 and (c) in FIG. 69 respectively show a diagram of S11 curves and a diagram of antenna efficiency in a free space mode of the antenna shown in FIG. 66 when the antenna operates in different modes and the single distributed T antenna, and (d) in FIG. 69 shows an S21 diagram between a second antenna and a third antenna;

FIG. 70 and FIG. 71 each show a schematic diagram of a simplified structure of an IFA antenna structure obtained by deformation of the antenna shown in each of FIG. 65 and FIG. 66 according to an embodiment of this application;

FIG. 72 shows diagrams of antenna efficiency in a free space mode and an S11 curve of the antenna shown in FIG. 71,

FIG. 73 shows a schematic diagram of a simplified structure of an antenna that is capable of operating in a MIMO mode and that is formed by further improving the antenna shown in FIG. 66;

FIG. 74 shows a schematic diagram of a simplified structure of an antenna that uses another IFA antenna structure according to an embodiment of this application;

FIG. 75 shows two different antennas that use a single end for feeding, and diagrams of S11 curves and antenna efficiency of the two antennas and the antenna shown in FIG. 72;

FIG. 76 shows diagrams of current directions and radiation patterns of the antenna shown in FIG. 74 existing when the antenna operates at different resonance frequencies;

FIG. 77 shows a schematic diagram of a simplified structure of an antenna that uses an IFA antenna structure and a longer transmission line according to an embodiment of this application;

FIG. 78 shows diagrams of an S11 curve and antenna efficiency of the antenna shown in FIG. 77:

FIG. 79 shows diagrams of current directions and radiation patterns of the antenna shown in FIG. 77 existing when the antenna operates at different resonance frequencies;

FIG. 80 shows a schematic diagram of a simplified structure of an antenna that uses an IFA antenna structure and different transmission lines for feeding according to an embodiment of this application;

FIG. 81 shows diagrams of S11 and S21 curves and antenna efficiency of the antenna shown in FIG. 80 when the antenna operates in different modes:

FIG. 82 shows diagrams of current directions and radiation patterns of the antenna shown in FIG. 80 existing when the antenna operates at different resonance frequencies;

FIG. 83 shows a schematic diagram of a simplified structure of an antenna that uses a deformed IFA antenna structure;

FIG. 84 shows diagrams of S11 and S21 curves of the antenna shown in FIG. 83 existing when the antenna operates in different modes.

FIG. 85 shows diagrams of antenna efficiency of the antenna shown in FIG. 83 in a free space mode, a right-hand mode, and a left-hand mode;

FIG. 86 shows schematic diagrams of simplified structures of antennas that are of several other deformed IFA antenna structures;

FIG. 87 shows diagrams of S11 and S21 curves and antenna efficiency of the antenna shown in FIG. 86 existing when the antenna operates in different modes;

FIG. 88 shows diagrams of S11 and S21 curves and efficiency of the antenna structure shown in FIG. 83 existing when the antenna structure operates in a frequency band of 2.5 GHz to 2.9 GHz:

FIG. 89 shows a schematic diagram of a simplified structure of a dual-antenna system formed when a shorter transmission line and a longer transmission line are respectively used for asymmetric feeding:

FIG. 90 shows, from top to bottom, diagrams of S11 and S21 curves and diagrams of antenna efficiency in a free space mode, a right-hand handheld mode, and a left-hand handheld mode of each antenna in FIG. 89:

FIG. 91 shows diagrams of current directions and radiation patterns of the antenna in FIG. 89 at different resonance frequencies;

FIG. 92 shows a schematic diagram of a simplified structure of an antenna in which a first radiator is disposed on a top side edge of a side frame of an electronic device and a second radiator is disposed on a right side edge;

FIG. 93 shows, from top to bottom, a diagram of an S11 curve, a Smith chart, and a diagram of an S21 curve of the antenna in FIG. 90:

FIG. 94 shows a schematic diagram of a simplified structure of a single distributed antenna based on a short transmission line:

FIG. 95 and FIG. 96 each show a schematic diagram of a simplified structure of an antenna that uses a slot antenna structure:

FIG. 97 shows, from top to bottom, diagrams of S11 and S21 curves and a diagram of antenna efficiency in a free space mode of the antenna in each of FIG. 95 and FIG. 96;

FIG. 98 shows diagrams of current directions and radiation patterns of the antenna in FIG. 96 at different resonance frequencies;
(a) in FIG. 99 shows a schematic diagram of a single distributed slot antenna, (b) in FIG. 99 and (c) in FIG. 99 respectively show a diagram of S11 curves and a diagram of antenna efficiency in a free space mode of the antenna shown in each of FIG. 93 and FIG. 94 existing when the antenna operates in different modes and the single distributed slot antenna:

FIG. 100 shows a schematic diagram of a simplified structure of an antenna that uses another deformed slot antenna structure:

FIG. 101 shows, from top to bottom, diagrams of S11 and S21 curves and a diagram of antenna efficiency in a free space mode of the antenna in FIG. 98;

FIG. 102 shows a schematic diagram of a simplified structure of an antenna in which a phase modulator is disposed on a transmission line according to an embodiment of this application;

FIG. 103 shows a schematic diagram of a simplified structure of an antenna that is fed near an open end according to an embodiment of this application:

FIG. 104 shows a schematic diagram of a simplified structure of an antenna that is formed by a combined structure of a slot antenna and an IFA antenna and in which both feeding points at which a transmission line and a radiator are connected are disposed close to a ground end according to an embodiment of this application:

FIG. 105 shows a schematic diagram of a simplified structure of an antenna in which at least a part of a first radiator and at least a part of a second radiator are located on different edges of a side frame according to an embodiment of this application:

FIG. 106 and FIG. 107 respectively show a schematic diagram of a simplified structure of an antenna in which two transmission lines are respectively coupled to an open end and a ground end of a radiator pair according to an embodiment of this application; and

FIG. 108 and FIG. 109 each show a schematic diagram of a simplified structure of an antenna in which a radiator pair extends from a right side edge to a bottom of a side frame through a corner part according to an embodiment of this application.

### DESCRIPTION OF EMBODIMENTS

The following describes embodiments of this application in more detail with reference to accompanying drawings. Although some embodiments of this application are shown in the accompanying drawings, it should be understood that this application may be implemented in various forms and should not be construed to be limited to embodiments described herein. Instead, these embodiments are provided to understand this application more thoroughly and completely. It should be understood that, the accompanying drawings and embodiments of this application are merely used as examples, but are not used to limit the protection scope of this application.

In descriptions of embodiments of this application, the term “including” and similar terms should be understood as non-exclusive inclusion, that is, “including but not limited to”. The term “based on” should be understood as “at least partially based on”. The term “an embodiment” or “this embodiment” should be understood as “at least one embodiment”. The terms “first”. “second”, and the like may refer to different objects or a same object. Other explicit and implied definitions may be further included below.

It should be understood that in this application, both “connection” and “interconnection” may refer to a mechanical connection relationship or a physical connection relationship. For example, a connection between A and B or an interconnection between A and B may refer to that a fastened component (such as a screw, a bolt, or a rivet) exists between A and B; or A and B are in contact with each other and are difficult to be separated.

It should be understood that in this application, “coupling” may be understood as direct coupling and/or indirect coupling. The direct coupling may also be referred to as “electrical connection”, which may be understood as physical contact and electrical conduction of components; or may be understood as a form in which different components in a line structure are connected by using a physical line that can transmit an electrical signal, such as a printed circuit board (printed circuit board, PCB), copper foil, or a conducting wire; and the “indirect coupling” may be understood as electrical conduction of two conductors in an air-space or non-contact manner. In an embodiment, the indirect coupling may also be referred to as capacitive coupling. For example, signal transmission is implemented by forming an equivalent capacitor through coupling a slot between two spaced conductive members.

Radiator: The radiator is an apparatus used to receive/transmit electromagnetic wave radiation in an antenna. In some cases, the “antenna” is the radiator in a narrow sense. The radiator converts guided wave energy from a transmitter into a radio wave, or converts a radio wave into guided wave energy to radiate and receive the radio wave. Modulated high-frequency current energy (or the guided wave energy) generated by the transmitter is transmitted to a transmit radiator through a feeder. The radiator converts the modulated high-frequency current energy into specific polarized electromagnetic wave energy and radiates the polarized electromagnetic wave energy in a required direction. A receive radiator converts specific polarized electromagnetic wave energy from a specific direction in space into modulated high-frequency current energy, and transmits the modulated high-frequency current energy to an input end of a receiver through a feeder.

The radiator may be a conductor having a specific shape and size, such as a linear antenna. The linear antenna is an antenna composed of one or more metal conductors whose diameter is far less than a wavelength and whose length can be compared with the wavelength. The linear antenna can be used as a transmit or receive antenna. Main forms of the linear antenna include a dipole antenna, a half-wave dipole antenna, a monopole antenna, a loop antenna, an inverted-F antenna (also called IFA, Inverted-F Antenna), a planar inverted-F antenna (also called PIFA, Planar Inverted-F Antenna), a slot antenna, an antenna array, and the like. For the dipole antenna, each dipole antenna usually includes two radiation stubs, and each radiation stub is fed by a feeding part from a feeding end of the radiation stub. For example, the inverted-F antenna (Inverted-F Antenna, IFA) may be considered as being obtained by adding a grounding path to the monopole antenna. The IFA antenna has a feeding point and a ground point. Both the feeding point and the ground point are disposed away from an open end. Because a side view of the IFA antenna is in a shape of an inverted F, the IFA antenna is referred to as the inverted-F antenna. For another example, a composite right/left-handed (composite right/left-handed, CRLH) antenna may be considered as a combination of a left-hand antenna and a monopole antenna. The composite right/left-handed antenna has a feeding point that connects to a capacitor in series and a ground point. The feeding point is disposed away from the ground point. Because the composite right/left-handed antenna has features of both a left-hand transmission line and a right-hand transmission line, the composite right/left-handed antenna is referred to as the composite right/left-handed antenna. For still another example, the slot antenna may include a single radiation stub, and two ends of the radiation stub are grounded to form a slot.

An “inverted-F radiator/IFA radiator” in this application may be understood as a radiator having one feeding point and one ground point. The ground point is located at one end of the radiator, and the other end of the radiator is an open end. The feeding point is disposed between the open end and the ground point. In an embodiment, the feeding point of the IFA radiator is disposed between a center point and the ground point of the radiator. In an embodiment, that the ground point is located at one end of the IFA radiator may be understood as that the ground point is within 5 mm away from an end part of the end, for example, within 2 mm. In an embodiment, the open end of the IFA radiator may be understood as that an end part of the end is not grounded within 5 mm. The IFA radiator is used to generate a resonance between the ground point and the open end. In an embodiment, an electrical length of the IFA radiator from the ground point to the open end is about ¼ of a wavelength corresponding to the resonance.

A “composite right/left-handed radiator/CRLH radiator” in this application may be understood as a radiator having one feeding point and one ground point. The ground point is located at one end of the radiator, and the other end of the radiator is an open end. The feeding point is disposed between the open end and the ground point, and a capacitor is connected in series between the feeding point and a feed source. In an embodiment, a capacitance value of the capacitor connected in series is less than or equal to 1 pF. In an embodiment, the feeding point of the composite right/left-handed radiator is disposed between a center point and the open end of the radiator. In an embodiment, that the ground point is located at one end of the composite right/left-handed radiator may be understood as that the ground point is within 5 mm away from an end part of the end, for example, within 2 mm. A part of the CRLH radiator from the ground point to the feeding point is used to generate a first resonance. In an embodiment, an electrical length of the CRLH radiator from the ground point to the feeding point is about ⅛ of a wavelength corresponding to the first resonance. For example, the electrical length is between ¼ wavelength and ⅛ wavelength or is less than ⅛ wavelength. In an embodiment, a part between the feeding point and the open end of the CRLH radiator is used to generate a second resonance. In an embodiment, an electrical length of the CRLH radiator from the feeding point to the open end is about ¼ of a wavelength corresponding to the second resonance. It should be understood that the capacitance value of the capacitor connected in series between the feeding point and the feed source may be understood as an equivalent capacitance value. For example, if two capacitors are connected in series, an equivalent capacitance value after the two capacitors are connected in series may be calculated.

The radiator may alternatively be a slot formed on a conductor. For example, an antenna formed by slotting on a surface of the conductor is also referred to as a slot antenna. In some embodiments, a shape of the slot is a long strip. In some embodiments, a length of the slot is approximately half a wavelength. In some embodiments, the slot may be fed through a transmission line that is connected to one side or two sides of the slot, or may be fed through a waveguide or a resonant cavity. In this case, a radio frequency electromagnetic field that radiates electromagnetic waves to space is excited above the slot.

Feeding unit. The feeding unit is a combination of all components of an antenna for receiving and transmitting radio frequency waves. In a case of a receive antenna, the feeding unit may be considered as an antenna part from a first amplifier to a front-end transmitter. In a transmit antenna, the feeding unit may be considered as a part after a last power amplifier. In some cases, the “feeding unit” is a radio frequency chip in a narrow sense, or includes a transmission path from a radio frequency chip to a radiator or a feeding point on a transmission line. The feeding unit has a function of converting a radio wave into an electrical signal and sending the electrical signal to a receiver component. Usually, the feeding unit is considered as a part of an antenna, used to convert the radio wave into the electrical signal, and vice versa. When designing an antenna, a possibility and efficiency of maximum power transmission should be considered. Therefore, input impedance of the antenna needs to match a load resistance. The feed impedance of the antenna is a combination of resistance, capacitance, and inductance. To ensure a condition of the maximum power transmission, the two impedances (load resistance and feed impedance) should match. The matching can be implemented by considering frequency requirements and design parameters (for example, gain, directivity, and radiation efficiency) of the antenna.

The input impedance includes two resistance elements, namely, a loss resistance and a radiation resistance. The loss resistance is a resistance provided by actual components of the antenna, and the feed impedance is a resistance provided by the antenna when the antenna inputs signals. Therefore, the loss resistance and the feed impedance need to operate together to obtain a proper operating antenna feed. The radiation resistance is a resistance provided by the antenna to a radiated power. In other words, it indicates a dissipated radiated power.

Transmission line: The transmission line, also referred to as a feed line, is a connection line between a transceiver and a radiator of an antenna. The transmission line can directly transmit current waves or electromagnetic waves depending on a frequency and a form. A junction that is on a radiator and that is connected to the transmission line is usually referred to as a feeding point. The transmission line includes a wire transmission line, a coaxial line transmission line, a waveguide, a microstrip, or the like. The transmission line may include a support antenna body, a glass antenna body, or the like based on different implementation forms. The transmission line may be implemented by an LCP (Liquid Crystal Polymer, liquid crystal polymer) material, an FPC (Flexible Printed Circuit, flexible printed circuit) board, a PCB (Printed Circuit Board, printed circuit board), or the like based on different carriers.

Ground/ground plate: The ground/ground plate may usually refer to at least a part of any ground layer, ground plate, or any ground metal layer in an electronic device, or refer to at least a part of any combination of the foregoing ground layer, ground plate, ground component, or the like. The “ground/ground plate” may be used for grounding a component in the electronic device. In an embodiment, the “ground/ground plate” may be a ground layer of a circuit board of an electronic device, or may be a ground plate formed by using a middle frame of the electronic device or a ground metal layer formed by using a metal thin film below a screen in the electronic device. In an embodiment, the circuit board may be a printed circuit board (printed circuit board, PCB), for example, an 8-layer, a 10-layer, or 12-layer to 14-layer board having 8, 10, 12, 13, or 14 layers of conductive material, or an element that is separated and electrically insulated by a dielectric layer or insulation layer such as glass fiber, polymer, or the like. In an embodiment, the circuit board includes a dielectric substrate, aground layer, and a wiring layer, and the wiring layer and the ground layer are electrically connected through a via. In an embodiment, components such as a display, a touchscreen, an input button, a transmitter, a processor, a memory, a battery, a charging circuit, and a system on chip (system on chip, SoC) structure may be installed on or connected to a circuit board, or electrically connected to a wiring layer and/or a ground layer in the circuit board. For example, a radio frequency source is disposed at the wiring layer.

Any of the foregoing ground layer, ground plate, or ground metal layer is made of conductive materials. In an embodiment, the conductive material may be any one of the following materials: copper, aluminum, stainless steel, brass and alloys thereof, copper foil on insulation laminates, aluminum foil on insulation laminates, gold foil on insulation laminates, silver-plated copper, silver-plated copper foil on insulation laminates, silver foil on insulation laminates and tin-plated copper, cloth impregnated with graphite powder, graphite-coated laminates, copper-plated laminates, brass-plated laminates and aluminum-plated laminates. A person skilled in the art may understand that the ground layer/ground plate/ground metal layer may alternatively be made of other conductive materials.

Resonance frequency: The resonance frequency is also called a resonant frequency. The resonance frequency may be a frequency at which an imaginary part of input impedance of an antenna is zero. The resonance frequency may have a frequency range, that is, a frequency range in which resonance occurs. A frequency corresponding to a strongest resonance point equals a center frequency minus a point frequency. A characteristic of a return loss of the center frequency may be less than −20 dB.

Resonant frequency band/communication frequency band/operating frequency band: Regardless of a type of an antenna, the antenna always operates in a specific frequency range (frequency band width). For example, an operating frequency band of an antenna that supports a B40 frequency band includes frequencies in a range of 2300 MHz to 2400 MHz, or in other words, the operating frequency band of the antenna includes the B40 frequency band. A frequency range that satisfies specification requirements may be considered as the operating frequency band of the antenna. A width of the operating frequency band is called an operating bandwidth. An operating bandwidth of an omnidirectional antenna may reach 3% to 5% of the center frequency. An operating bandwidth of a directional antenna may reach 5% to 10% of the center frequency. A bandwidth may be considered as a frequency range on each of two sides of the center frequency (for example, a resonance frequency of a dipole), where an antenna characteristic is within an acceptable value range of the center frequency.

Impedance and impedance matching: Impedance of an antenna usually refers to a ratio of a voltage to a current at an input end of the antenna. The impedance of the antenna is a measure of resistance to an electrical signal in the antenna. In general, input impedance of an antenna is a complex number, in which a real part is referred to as an input resistance, represented by Ri; and an imaginary part is referred to as input reactance, represented by Xi. An antenna whose electrical length is far less than an operating wavelength has high input reactance. For example, a short dipole antenna has high capacitive reactance, and an electrically small loop antenna has high inductive reactance. Input impedance of a half-wave dipole with a small diameter is approximately 73.1+j42.5 ohms. During actual application, for ease of matching, it is generally expected that input reactance of a symmetric oscillator is zero. In this case, a length of the oscillator is referred to as a resonance length. A length of a resonant half-wave dipole is slightly shorter than a half wavelength in free space, and in engineering, it is estimated that the length is 5% shorter than the half wavelength. The input impedance of the antenna is related to factors such as a geometric shape, a size, a position of a feeding point, an operating wavelength, and surrounding environment of the antenna. When a diameter of a linear antenna is large, input impedance changes smoothly with frequency, and an impedance bandwidth of the antenna is wide.

A main purpose of studying the impedance of the antenna is to realize matching between the antenna and a transmission line. To match a transmit antenna with a transmission line, input impedance of the antenna should be equal to characteristic impedance of the transmission line. To match a receive antenna with a receiver, input impedance of the antenna should be equal to a conjugate complex number of load impedance. The receiver usually has impedance of a real number. When the impedance of the antenna is a complex number, a matching circuit needs to be used to remove a reactance part of the antenna and make resistance parts of the antenna equal.

When the antenna matches the transmission line, power transmitted from the transmitter to the antenna or from the antenna to the receiver is the maximum. In this case, no reflected wave appears on the transmission line, a reflection coefficient S11 is 0, and a standing wave coefficient is 1. Quality of the matching between the antenna and the transmission line is measured by a reflection coefficient S11 or a standing wave ratio at an input end of the antenna. For the transmit antenna, in a case of poor matching, radiant power of the antenna decreases, a loss on the transmission line increases, and a power capacity of the transmission line decreases. In a serious case, transmitter frequency “pulling” occurs, that is, an oscillation frequency changes.

System efficiency: The system efficiency is a ratio of power radiated by an antenna to space (that is, power that is of a part of electromagnetic waves and that is effectively converted) to input power of the antenna. The system efficiency is actual efficiency obtained after antenna port matching is considered, that is, the system efficiency of the antenna is the actual efficiency (that is, efficiency) of the antenna.

Radiation efficiency: The radiation efficiency is a ratio of power radiated by an antenna (that is, power that is of a part of electromagnetic waves and that is effectively converted) to active power input to the antenna. The active power input to the antenna=Input power of the antenna-Loss power. The loss power mainly includes return loss power and ohmic loss power and/or dielectric loss power of metal. The radiation efficiency is a value used to measure a radiation capability of an antenna. Metal loss and dielectric loss are factors that affect the radiation efficiency.

A person skilled in the art may understand that efficiency is generally represented by a percentage, and there is a corresponding conversion relationship between the efficiency and dB. A closer efficiency to 0 dB indicates better efficiency of an antenna.

dB: dB means decibel, is a logarithmic concept with a base of ten. The decibel is only used to evaluate a proportional relationship between a physical quantity and another physical quantity. The decibel has no physical dimension. A difference between two quantities may be expressed as 10 decibels every 10-fold a ratio of the two quantities is increased. For example, if A=“100”, B=“10”, C=“5”, and D=“1”, then A/D=20 dB, B/D=10 dB, C/D=7 dB, and B/C=3 dB. That is, a difference of 10 decibels between two quantities means a 10-fold difference, a difference of 20 decibels means a 100-fold difference, and so on. A difference of 3 dB means a 2-fold difference between two quantities.

Return loss of an antenna: The return loss of the antenna may be understood as a ratio of power of a signal reflected back to an antenna port by an antenna circuit to transmit power of the antenna port. A smaller reflected signal indicates a larger signal radiated from the antenna to space, and higher radiation efficiency of the antenna. A larger reflected signal indicates a smaller signal radiated from the antenna to space, and lower radiation efficiency of the antenna.

The return loss of the antenna may be represented by an S11 parameter, and S11 is one of S parameters. S11 indicates a reflection coefficient. This parameter indicates transmit efficiency of the antenna. The S11 parameter is usually a negative number. A smaller S11 parameter indicates a smaller return loss of the antenna, smaller energy reflected by the antenna, that is, more energy actually enters the antenna, and higher system efficiency of the antenna. A larger S11 parameter indicates a larger return loss of the antenna, and lower system efficiency of the antenna.

It should be noted that, in engineering, an S11 value of −6 dB is generally used as a standard. When an S11 value of an antenna is less than −6 dB, it may be considered that the antenna can operate normally, or it may be considered that transmit efficiency of the antenna is good.

Isolation: The isolation means when an antenna transmits a signal, a ratio of a signal received through another antenna to the signal transmitted by the transmit antenna. The isolation is a physical quantity used to measure a degree of mutual coupling between antennas. If two antennas form a dual-port network, isolation between the two antennas is S21 and S12 between the antennas. The isolation of the antenna may be represented by parameters S21 and S12. The parameters S21 and S12 are usually negative numbers. Smaller parameters S21 and S12 indicate larger isolation between antennas, and a smaller degree of mutual coupling between the antennas. Larger parameters S21 and S12 indicate smaller isolation between antennas, and a larger degree of mutual coupling between the antennas. The isolation of the antenna depends on a radiation pattern of the antenna, a space distance of the antenna, a gain of the antenna, and the like.

Smith (Smith) chart: The Smith chart is a computational chart of a circle family with normalized input impedance (or admittance) equivalents on a discrete plane of a reflective system. The Smith chart is mainly used for impedance matching of transmission lines. In the chart, a circle line represents a real value of reactance, that is, a resistance value. A horizontal line in the middle and lines that are scattered upward and downward represent imaginary values of a resistance force, that is, resistance values generated by a capacitor or an inductor at a high frequency. An upward line is a positive number, and a downward line is a negative number. A point (1+j0) in the middle of the chart represents a resistance value that has matched impedance. In addition, a value of a reflection coefficient S11 is 0. An edge of the chart indicates that a length of the reflection coefficient S11 is 1, that is, 100% reflection. Numbers on the edge of the chart represent an angle (0 to 180 degrees) and a wavelength (from zero to a half wavelength) of the reflection coefficient S11.

Electrical length: The electrical length may be expressed by multiplying a physical length (that is, a mechanical length or a geometric length) by a ratio of a transmission time period of an electrical or electromagnetic signal in a medium to a time period needed by this signal to travel, in free space, for a distance that is the same as a physical length of the medium, and the electrical length may satisfy the following formula:

$$\overline{L} = L \times \frac{a}{b} .$$

L is the physical length, a is the transmission time period of the electrical or electromagnetic signal in the medium, and b is the transmission time period in the free space.

Alternatively, the electrical length may be a ratio of a physical length (that is, a mechanical length or a geometric length) to a wavelength of a transmitted electromagnetic wave. The electrical length may satisfy the following formula:

$$\overline{L} = \frac{L}{λ} .$$

L is the physical length, and k is the wavelength of the electromagnetic wave.

In an embodiment, a physical length of a radiator may be set to an electrical length of the radiator±10%, for example, ±5%.

A wavelength in this application may be a wavelength that is in a dielectric and that corresponds to a center frequency of resonance frequencies, or a wavelength that is in a dielectric and that corresponds to a center frequency of an operating frequency band supported by an antenna. For example, it is assumed that a center frequency of a B1 uplink frequency band (resonance frequencies range from 1920 MHz to 1980 MHz) is 1955 MHz. A wavelength may be a wavelength calculated by using the frequency 1955 MHz, or a calculated wavelength in a dielectric (referred to as a dielectric wavelength for short). Not limited to the center frequency, the “wavelength/dielectric wavelength” may also refer to a wavelength/dielectric wavelength corresponding to a resonance frequency, or a non-center frequency of an operating frequency band. For ease of understanding, the dielectric wavelength mentioned in embodiments of this application may be simply understood as a wavelength.

Codirectional/reverse distribution of currents mentioned in this application should be understood as that directions of main currents on conductors on a same side are codirectional/reverse. For example, when codirectionally distributed currents are excited on an annular conductor (for example, a current path is also annular), it should be understood that although main currents excited on conductors on two sides of the annular conductor (for example, on conductors around a slot, or on conductors on two sides of a slot) are in reverse directions, the main currents still meet a definition of the codirectionally distributed currents in this application.

Equivalent length: Due to factors such as a transmission distance, a disposed capacitance and/or inductance, and radiation impedance, a phase difference is caused when an electromagnetic wave is transmitted on a transmission dielectric. If the caused phase difference is the same as a phase difference caused when a guided wave is transmitted on a transmission line that has a predetermined length, a predetermined dielectric constant, and no radiation capability, an equivalent length of the transmission dielectric is equal to the predetermined length of the transmission line. The equivalent length may be affected by a physical length of a corresponding transmission line in the transmission dielectric, a capacitor and/or an inductor disposed in the transmission dielectric, a disposed phase shifter, a position at which the transmission line is coupled to a radiator, and the like. Specifically, by disposing the capacitor or the inductor, the physical length may be shortened when the equivalent length basically remains unchanged. For example, by disposing a component such as a capacitor or an inductor, a relationship between a physical length L and an equivalent length Le may satisfy (1−⅓)Le≤L≤(1+⅓)Le or (1−¼)Le≤L≤(1+¼)Le.

Specific absorption rate (Specific Absorption Rate, SAR): The SAR means electromagnetic radiation energy absorbed by a unit mass of substance per unit time. An SAR value is usually used internationally to measure thermal effect of terminal radiation. Radiation of a mobile phone is used as an example. The SAR may mean a ratio of radiation absorbed by a human body (for example, a head). A lower SAR value indicates a smaller amount of radiation absorbed by the human body.

Envelope correlation coefficient (Envelope Correlation Coefficient, ECC): The ECC indicates a degree of independence of radiation patterns of two antennas. If one antenna is completely horizontally polarized and the other is completely vertically polarized, correlation between the two antennas is basically 0. Similarly, if one antenna radiates energy only to the sky, and the other antenna radiates energy only to the ground, an ECC of these antennas is basically 0. Therefore, the envelope correlation coefficient takes into account a shape of the radiation pattern, polarization, and even a relative phase of a field between the two antennas. The ECC generally represents a relationship between two antennas. For a MIMO antenna system, a plurality groups of ECCs may represent independence between antennas. For example, a MIMO antenna with an ECC lower than 0.5 can operate well.

In this application, a “point” or an “end” in a “feeding end”, a “feeding point”. “ground end”, “open end”, and “one end” cannot be understood as a point in a narrow sense, and may alternatively be considered as a section of radiator that is on an antenna radiator and that includes a first endpoint, or may alternatively be considered as a section of radiator at a junction between a transmission line and a radiator. The first endpoint is an endpoint on a first end of the antenna radiator. For example, the first end of the antenna radiator is a feeding end, and the feeding end may be considered as a section of radiator that is within a range of ⅛ of a first wavelength away from the first endpoint. The first wavelength may be a wavelength corresponding to an operating frequency band of an antenna structure, or may be a wavelength corresponding to a center frequency of an operating frequency band, or a wavelength corresponding to a resonance point. For example, the first end of the antenna radiator is a feeding end, and the feeding end may alternatively be considered as a section of radiator within 5 mm away from the first endpoint, or a section of radiator within 3 mm away from the first endpoint. For example, the first end of the antenna radiator is a ground end, and the ground end may be considered as a section of radiator within 5 mm away from the first endpoint, or a section of radiator within 3 mm away from the first endpoint. For another example, the first end of the antenna radiator is an open end, and the open end should be understood in two ways. One is that for an IFA radiator, an “open end” of the IFA radiator may be considered as a section of radiator within 5 mm away from the first endpoint, or a section of radiator within 3 mm away from the first endpoint. The other is that for a CRLH radiator, an open end of the CRLH radiator may be considered as a section of radiator more than 5 mm away from an endpoint of a ground end of the CRLH radiator, or a section of radiator more than 10 mm away from an endpoint of a ground end of the CRLH radiator. In an embodiment, the open end of the CRLH radiator is a feeding end, and a monopole radiator is electrically connected to the feeding end in a direction away from the ground end. The monopole radiator may alternatively be considered as an open end of the CRLH radiator. It should be understood that the monopole radiator may be considered as a part of the CRLH radiator.

In this application, “coupled to a ground end” should be understood as being electrically connected to or indirectly coupled to the foregoing “ground end”, and an electrical connection point or an indirect coupling point should be located on the foregoing “ground end”.

In this application. “coupled to an open end” should be understood as being electrically connected to or indirectly coupled to the foregoing “open end”, and an electrical connection point or an indirect coupling point should be located on the foregoing “open end”.

In this application. “near”, “adjacent”, or “close to” means that a distance between two points or parts (for example, a feeding point and a ground end or an open end) having the foregoing relationship (that is, “near”, “adjacent”, or “close to”) does not exceed a specific distance value. The distance value may be constrained by using 1/16 of a dielectric wavelength, ⅛ of a dielectric wavelength, or another value. However, the two values are merely used as examples. In an embodiment, “near”, “adjacent”, or “close to” means that a distance between two points or parts (for example, a feeding point and a ground end or an open end) having the foregoing relationship (that is, “near”, “adjacent”, or “close to”) does not exceed 10 mm, for example, does not exceed 5 mm, or does not exceed 3 mm. In an embodiment. “near”, “adjacent”, or “close to” means that two points or parts (for example, a feeding point and a ground end or an open end) having the foregoing relationship (that is, “near”, “adjacent”, or “close to”) at least partially overlap, or a distance between the two points or parts is considered as 0 mm. The feeding point or feeding end mentioned in the foregoing content of this application may be any point in a connection region (which may also be referred to as a junction) of the transmission line and the radiator, for example, a center point. A distance from a point (such as a feeding point, a connection point, or a ground point) to a slot or from a slot to a point may mean a distance from the point to a midpoint of the slot, or may refer to a distance from the point to two ends of the slot.

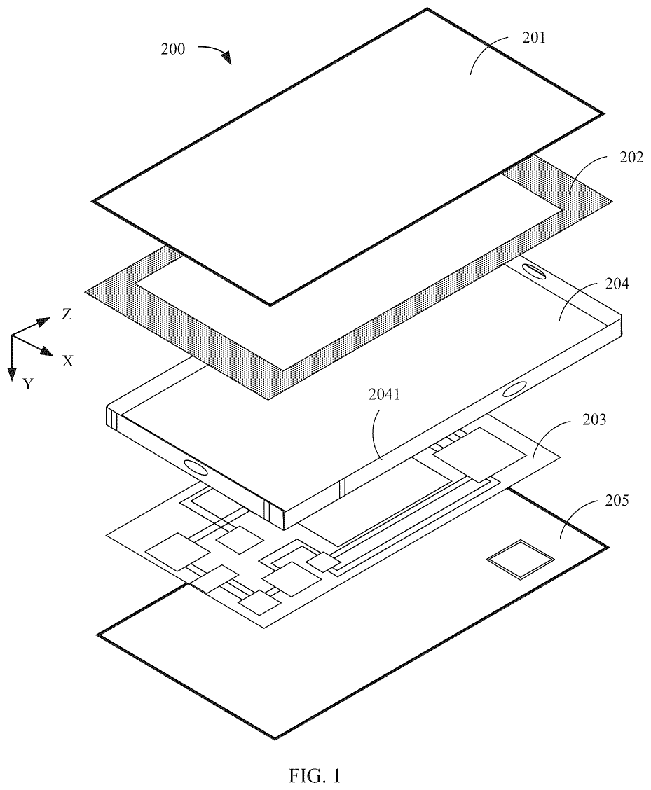

The technical solutions provided in this application are applicable to an electronic device that uses one or more of the following communication technologies: a Bluetooth (Bluetooth. BT) communication technology, a global positioning system (global positioning system, GPS) communication technology, a wireless fidelity (wireless fidelity, Wi-Fi) communication technology, a global system for mobile communication (global system for mobile communication, GSM) communication technology, a wideband code division multiple access (wideband code division multiple access, WCDMA) communication technology, a long term evolution (long term evolution, LTE) communication technology, a 5G communication technology, and other future communication technologies. An electronic device in embodiments of this application may be a mobile phone, a tablet computer, a notebook computer, a smart home, a smart band, a smartwatch, a smart helmet, smart glasses, or the like. Alternatively, the electronic device may be a handheld device that has a wireless communication function, a computing device, another processing device connected to a wireless modem, a vehicle-mounted device, an electronic device in a 5G network, an electronic device in a future evolved public land mobile network (public land mobile network. PLMN), or the like. This is not limited in embodiments of this application. FIG. 1 shows an example of an electronic device according to this application. An example in which the electronic device is a mobile phone is used for description.

As shown in FIG. 1, an electronic device 200 may include a cover (cover) 201, a display/display (display) module 202, a printed circuit board (printed circuit board, PCB) 203, a middle frame (middle frame) 204, and a rear cover (rear cover) 205. It should be understood that, in some embodiments, the cover 201 may be a cover glass (cover glass), or may be replaced with a cover made of another material, for example, a cover made of an ultra-thin glass material or a cover made of a PET (polyethylene terephthalate, polyethylene terephthalate) material.

The cover 201 may be tightly attached to the display module 202, and may be mainly used to protect the display module 202 and prevent the display module 202 against dust.

In an embodiment, the display module 202 may include a liquid crystal display (liquid crystal display, LCD) panel, a light emitting diode (light emitting diode, LED) display panel, an organic light-emitting diode (organic light-emitting diode, OLED) display panel, or the like. This is not limited in this application.

The middle frame 204 is mainly used to support the electronic device. As shown in FIG. 1, the PCB 203 is disposed between the middle frame 204 and the rear cover 205. It should be understood that, in an embodiment, the PCB 203 may alternatively be disposed between the middle frame 204 and the display module 202. This is not limited in this application. The printed circuit board PCB 203 may be a flame-resistant material (FR-4) dielectric board, or may be a Rogers (Rogers) dielectric board, or may be a hybrid dielectric board of Rogers and FR-4, or the like. Herein, FR-4 is a grade designation for a flame-resistant material, and the Rogers dielectric board is a high-frequency board. The PCB 203 carries an electronic element, for example, a feeding unit or the like. In an embodiment, a metal layer may be disposed on the printed circuit board PCB 203. The metal layer may be used for grounding the electronic element carried on the printed circuit board PCB 203, or may be used for grounding another element, for example, a support antenna, a side frame antenna, or the like. The metal layer may be referred to as a ground plane, a ground plate, or a ground layer. In an embodiment, the metal layer may be formed by etching metal on a surface of any dielectric board in the PCB 203. In an embodiment, the metal layer used for grounding may be disposed on a side that is of the printed circuit board PCB 203 and that is close to the middle frame 204. In an embodiment, an edge of the printed circuit board PCB 203 may be considered as an edge of a ground layer of the printed circuit board PCB 203. In an embodiment, the metal middle frame 204 may alternatively be used for grounding the foregoing elements. The electronic device 200 may further have another ground plane/ground plate/ground layer, as described above. Details are not described herein again.

The electronic device 200 may further include a battery (not shown in the figure). The battery may be disposed between the middle frame 204 and the rear cover 205, or may be disposed between the middle frame 204 and the display module 202. This is not limited in this application. In some embodiments, the PCB 203 is divided into a mainboard and a sub-board. The battery may be disposed between the mainboard and the sub-board. The mainboard may be disposed between the middle frame 204 and an upper edge of the battery, and the sub-board may be disposed between the middle frame 204 and a lower edge of the battery.

The electronic device 200 may further include a side frame 2041, and the side frame 2041 may be at least partially made of a conductive material like metal. The side frame 2041 may be disposed between the display module 202 and the rear cover 205, and extend around a periphery of the electronic device 200. The side frame 2041 may have four side edges surrounding the display module 202, to help fasten the display module 202. In an implementation, the side frame 2041 made of a metal material may be directly used as a metal side frame of the electronic device 200, to form an appearance of the metal side frame. This is applicable to a metal industrial design (industrial design. ID). In another implementation, an outer surface of the side frame 2041 may alternatively be made of a non-metal material, for example, a plastic side frame, to form an appearance of a non-metal side frame. This is applicable to a non-metal ID.

The middle frame 204 may include the side frame 2041, and the middle frame 204 including the side frame 2041 is used as an integrated component, and may support an electronic component in the electronic device. The cover 201 and the rear cover 205 are respectively covered along upper and lower edges of the side frame, to form a casing or a housing (housing) of the electronic device. In an embodiment, the cover 201, the rear cover 205, the side frame 2041, and/or the middle frame 204 may be collectively referred to as a casing or a housing of the electronic device 200. It should be understood that the “casing or housing” may mean a part or all of any one of the cover 201, the rear cover 205, the side frame 2041, or the middle frame 204, or mean a part or all of any combination of the cover 201, the rear cover 205, the side frame 2041, or the middle frame 204.

At least a part of the side frame 2041 on the middle frame 204 may be used as an antenna radiator to receive/transmit a radio frequency signal. There may be a slot between the part of the side frame that is used as the radiator and another part of the middle frame 204, to ensure that the antenna radiator has a good radiation environment. In an embodiment, the middle frame 204 may be provided with an aperture at the part of the side frame that is used as the radiator, to facilitate radiation of an antenna.

Alternatively, the side frame 2041 may not be considered as a part of the middle frame 204. In an embodiment, the side frame 2041 and the middle frame 204 may be connected and integrally formed. In another embodiment, the side frame 2041 may include a protruding part extending inwards to be connected to the middle frame 204, for example, through a spring, a screw, welding, or the like. The protruding part of the side frame 2041 may be further configured to receive a feed signal, so that at least a part of the side frame 2041 is used as a radiator of the antenna to receive/transmit a radio frequency signal. There may be a slot between the part of the side frame that is used as the radiator and the middle frame 204, to ensure that the antenna radiator has a good radiation environment, and the antenna has a good signal transmission function. In the following, embodiments of this application are described mainly by using a side edge that is of the side frame 2041 and that is used as a part of the radiator. It should be understood that other cases are similar, and details are not separately described below.

The rear cover 205 may be a rear cover made of a metal material, or may be a rear cover made of a non-conductive material, for example, a glass rear cover, a plastic rear cover, or another non-metal rear cover, or may be a rear cover made of both a conductive material and a non-conductive material.

The antenna of the electronic device 200 may alternatively be disposed on an inner side of the housing, and more specifically, disposed on an inner side of the side frame 2041. When the side frame 2041 of the electronic device 200 is made of a non-conductive material, the antenna radiator may be located in the electronic device 200 and disposed along the side frame 2041. For example, the antenna radiator is disposed in a manner of abutting the side frame 2041, so that a volume occupied by the antenna radiator is minimized, and the antenna radiator is closer to the outside of the electronic device 200, thereby achieving better signal transmission effect. It should be noted that disposing the antenna radiator in the manner of abutting the side frame 2041 means that the antenna radiator may be disposed immediately against the side frame 2041, or may be disposed close to the side frame 2041. For example, there can be a specific small slot between the antenna radiator and the side frame 2041.

The antenna of the electronic device 200 may alternatively be disposed at any other proper position in the housing, for example, at a support antenna, a millimeter-wave module, or the like. Clearance of the antenna disposed in the housing may be obtained through a slit/hole on any one of the middle frame 204, the side frame 2041, the rear cover 205, and/or the display 202, or may be obtained through a non-conductive slot/aperture formed between any several thereof. The clearance of the antenna may ensure radiation performance of the antenna. It should be understood that the clearance of the antenna may be a non-conductive region formed by any conductive component in the electronic device 200, and the antenna radiates a signal to external space through the non-conductive region. In an embodiment, the antenna may be in a form based on a flexible printed circuit (Flexible Printed Circuit, FPC), a form based on laser direct structuring (laser direct structuring, LDS), or a form like a microstrip antenna (Microstrip Disk Antenna, MDA). In an embodiment, the antenna may alternatively use a transparent structure embedded in a screen of the electronic device 200, so that the antenna is a transparent antenna element embedded in the screen of the electronic device 200.

Certainly, it should be understood that a structure and an arrangement of the electronic device shown in FIG. 1 are merely examples, and are not intended to limit the protection scope of this application. Another electronic device of any appropriate structure or arrangement is also possible as long as applicable. In the following, the structure shown in FIG. 1 is used as an example to describe the electronic device 200 according to this embodiment of this application. It should be understood that another electronic device 200 is similar. Details are not separately described below.

Under the influence of general trends such as lightness and thinness as well as an ultimate screen-to-body ratio for electronic devices, it is increasingly challenging to design an antenna for the electronic device 200 to satisfy, a requirement of a broadband antenna. The broadband antenna on the electronic device 200 may use distributed feeding for better hand-held performance. For example, two monopole antennas located above a mobile phone are connected through distributed feeding, and signals/guided waves with a phase difference of approximately 90° are introduced to the two antennas, to present effect of dual-resonance broadband matching. Distributed feeding may alternatively be implemented on the two monopole antennas located above the mobile phone and a third monopole antenna located at a lower right corner, and phase differences of approximately 60° and approximately 120° are introduced to the three antennas in sequence, to present effect of three-resonance broadband matching. Therefore, bandwidth expansion of a single antenna may be implemented by increasing a quantity of radiators.

In an embodiment, a distributed antenna design may be used, for example, symmetric feeding and anti-symmetrical feeding are used to excite radiators of a symmetric structure, to implement a MIMO antenna pair in an orthogonal mode. In this embodiment, the radiators are symmetrically designed on two sides of the mobile phone, and a low-frequency dual-mode antenna pair is implemented through symmetric and anti-symmetrical feeding connections with a broadband matching circuit. In addition, both the two antennas have specific bandwidths and high isolation.

An embodiment of this application further provides an antenna. The antenna feeds a radiator through a transmission line 104 having a predetermined length. When performing feeding on the radiator, a feeding unit 103 can also stimulate a transmission line mode on the transmission line 104 to form resonance while exciting a radiator mode to form a resonance. The transmission line mode can be superimposed with the radiator mode, so that efficiency and bandwidth of the antenna can be effectively improved. The following describes example embodiments of this antenna with reference to the accompanying drawings.

The transmission line 104 mentioned in this application may include but is not limited to a microstrip, a strip line, a coaxial line, another linear conductor, or any combination of the foregoing items. The linear conductor may be one or a combination of the following: a linear conductive material that forms an LCP, an FPC, and/or a PCB; or a linear conductor (for example, an LDS antenna body or a glass/ceramic antenna body) that is formed on an insulation dielectric. In an embodiment, the linear conductor may be understood as a strip-shaped or curved conductor whose length is greater than 2-fold of a width. Because the transmission line can be made of various appropriate materials or wires, a degree of freedom of design and structure is high, and the transmission line can be designed at any appropriate position of an electronic device, thereby facilitating design flexibility of the antenna and the electronic device. In the following, an invention concept according to embodiments of the present disclosure is described mainly by using an example in which a commonly used microstrip is used as the transmission line 104. It should be understood that a case in which the transmission line 104 is formed in another manner is similar, and details are not separately described below.

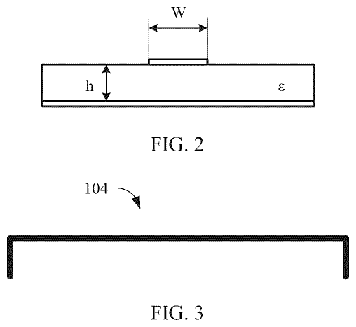

The microstrip is a transmission line 104 formed by a single conductor strip supported on a dielectric substrate. The microstrip is formed by the dielectric substrate, a conductor strip on the dielectric substrate, and metal ground at the bottom of a dielectric. FIG. 2 shows an example cross-sectional view of a 50 ohm microstrip cut in an extension direction perpendicular to the conductor strip. As shown in FIG. 2, a width W of the conductor strip ranges approximately from 1 mm to 1.4 mm, for example, approximately 1.2 mm, and a height h of the dielectric substrate is between 0.6 mm and 0.8 mm, for example, approximately 0.7 mm. A dielectric constant ε of the dielectric substrate is approximately 4.4. When the transmission line 104 is used in the antenna, a length T of the transmission line 104 is set to satisfy T≈¼λ or T≈½λ, where λ is a dielectric wavelength corresponding to one of resonances generated by the antenna when the antenna is fed. The following separately provides descriptions with reference to different implementations.

FIG. 3 shows an example structure of the transmission line 104. As shown in FIG. 3, the transmission line 104 includes two ends, that is, a first end and a second end. The two ends of the transmission line 104 according to embodiments of the present disclosure may be grounded or open. In some embodiments, one end or the two ends of the transmission line 104 may be directly grounded, and the end or each of the two ends may be referred to as a ground end. In some embodiments, the ground end may alternatively be grounded by coupling close to a ground end of the radiator of the antenna. In some embodiments, the transmission line 104 is directly grounded or grounded through coupling within 5 mm away from an end part of one end, for example, approximately 2 mm away from the end part. In some embodiments, one end or the two ends of the transmission line 104 may be open by not being grounded, and the end or each of the two ends may be referred to as an open end. In some embodiments, the end may alternatively be open by coupling close to an open end of the radiator of the antenna. In some embodiments, the transmission line 104 is not grounded within 5 mm away from an end part of one end, for example, within 2 mm away from the end part.

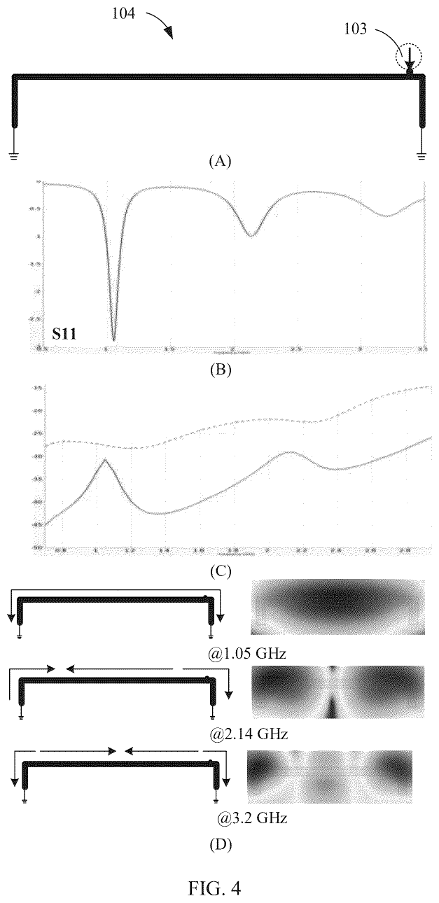

In the following, a concept according to the present disclosure is described with reference to different cases of whether the transmission line 104 is grounded. (A) in FIG. 4 shows a case in which both the two ends of the transmission line 104 are grounded. In this case, the transmission line 104 forms a transmission line 104 of a type of a loop radiator, and the length T of the transmission line 104 is approximately ½λ, where λ is a dielectric wavelength corresponding to a lowest resonance of resonances generated by the antenna when the antenna is fed. In this application, “the length T is approximately ½λ” may be understood as that the length T of the transmission line satisfies ½λ1≤T≤½λ2, where λ1 and λ2 are respectively a minimum dielectric wavelength and a maximum dielectric wavelength of an operating frequency band corresponding to a lowest resonance generated by the antenna when the feeding unit performs feeding. It should be understood that the dielectric wavelength mentioned in the present disclosure is a wavelength range. The transmission line 104 is used as a conductor structure. When the feeding unit 103 is coupled to a coupling point (or a feeding point) of the transmission line 104 to perform excitation, resonances can also be separately generated at a natural multiple of ½ of a dielectric wavelength, like ½, 1-fold, and 3/2-fold, to excite transmission line modes. (B) in FIG. 4 and (C) in FIG. 4 respectively show schematic diagrams of S11 parameters and efficiency of the transmission line 104 existing when the transmission line 104 is excited. Because the transmission line 104 is in a closed environment, radiation efficiency of the transmission line 104 is very low, and can be basically negligible. (D) in FIG. 4 shows schematic diagrams of current and electric field distribution of the transmission line 104 existing when the transmission line 104 is excited. With reference to (B) in FIG. 4 to (D) in FIG. 4, it can be learned that three transmission line modes may be excited when the transmission line 104 shown in (A) in FIG. 4 is fed. (D) in FIG. 4 shows that resonance frequencies of the three transmission line modes may be respectively corresponding to 1.05 GHz, 2.14 GHz, and 3.2 GHz.

In embodiments of this application, when the feeding unit feeds the transmission line, and then feeds a first radiator and a second radiator by coupling the transmission line, the first radiator is configured to generate a first resonance, and the transmission line is configured to generate a resonance adjacent to the first resonance, and the second radiator is configured to generate a second resonance, and the transmission line is further configured to generate a resonance adjacent to the second resonance. In an embodiment, “an adjacent resonance” should be understood as that, both of the two resonances include frequencies of a same operating frequency band; the two resonances respectively include frequencies of adjacent operating frequency bands; or the two resonances are adjacent resonances in an S11 curve diagram of an antenna structure and have an overlapping region in a range below −2 dB.

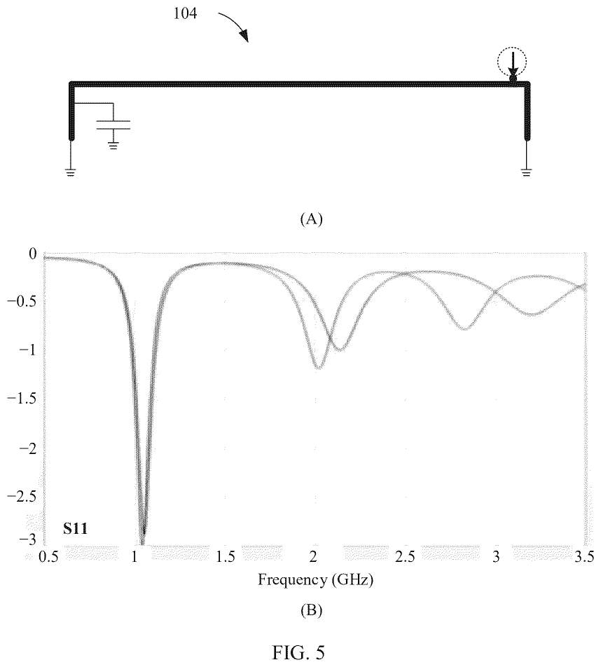

Similar to a design of the loop radiator, if a ground regulation circuit is disposed at a predetermined position of the transmission line 104, a resonance frequency of the transmission line mode can be adjusted. The regulation circuit may include a capacitor and/or an inductor. Specifically, if a grounded capacitor can be disposed at a current strength point in a half-wavelength mode and an electric field strength point in a 1-fold wavelength mode or a 1.5-fold wavelength mode, a resonance frequency in a medium and high frequency band can be shifted downwards. If an inductor can be disposed at the foregoing position, a resonance frequency in a medium and high frequency band can be shifted upwards. For example, in some embodiments, if a capacitor is loaded at a current strength region in a ½ wavelength mode (corresponding to 1.05 GHz in (D) in FIG. 4) and an electric field strength region in a 1-fold wavelength mode (corresponding to 2.14 GHz in (D) in FIG. 4) and a 3/2 wavelength mode (corresponding to 3.2 GHz in (D) in FIG. 4), as shown in (A) in FIG. 5, a low frequency mode (such as the ½ wavelength mode) can be basically unchanged, and a medium frequency mode (such as the 1-fold wavelength mode) and a high frequency mode (such as the 1.5-fold wavelength mode) are shifted downwards, as shown in (B) in FIG. 5. In this way, the low frequency mode, the medium frequency mode, and the high frequency mode can be adjusted to be close to a needed design frequency band, thereby further improving performance of the antenna.

As mentioned above, an electrical length of the transmission line 104 corresponds to approximately ½ or approximately ¼ of a dielectric wavelength corresponding to a resonance frequency (for example, a lowest resonance frequency). In an embodiment, the electrical length of the transmission line 104 corresponds to approximately ½ of a dielectric wavelength corresponding to a resonance frequency (for example, the lowest resonance frequency), where the length T of the transmission line satisfies ½λ1≤T≤½λ2, and λ1 and λ2 are respectively a minimum dielectric wavelength and a maximum dielectric wavelength of an operating frequency band corresponding to a lowest resonance generated by the antenna when the feeding unit performs feeding. In an embodiment, the electrical length of the transmission line 104 corresponds to approximately ¼ of a dielectric wavelength corresponding to a resonance frequency (for example, the lowest resonance frequency), where the length T of the transmission line satisfies ¼λ1≤T≤¼λ2, and λ1 and λ2 are respectively a minimum dielectric wavelength and a maximum dielectric wavelength of an operating frequency band corresponding to a lowest resonance generated by the antenna when the feeding unit performs feeding. Unlike the radiator, the transmission line 104 may be designed without space dependence, and therefore a structure of the transmission line 104 may be sufficiently miniaturized. In some embodiments, the electrical length of the transmission line 104 may be shortened in a manner such as increasing a dielectric coefficient of a dielectric. In this manner, a physical length is shortened accordingly. For example, when a dielectric constant is 4.4, a physical length corresponding to ½ of a dielectric wavelength corresponding to the lowest resonance frequency is approximately 75 mm. When a dielectric constant is 16, a physical length corresponding to ½ of a dielectric wavelength corresponding to the lowest resonance frequency is approximately 32 mm. When a dielectric constant is 33, a physical length corresponding to ½ of a dielectric wavelength corresponding to the lowest resonance frequency is approximately 22 mm. In this manner, the length of the transmission line 104 may be reduced by using a dielectric with a high dielectric constant, thereby reducing an area occupied by the transmission line 104, and facilitating miniaturization of an antenna and an electronic device.

In some embodiments, the transmission line 104 may alternatively use a curved structure to reduce the occupied area, thereby facilitating miniaturization of an antenna and an electronic device.

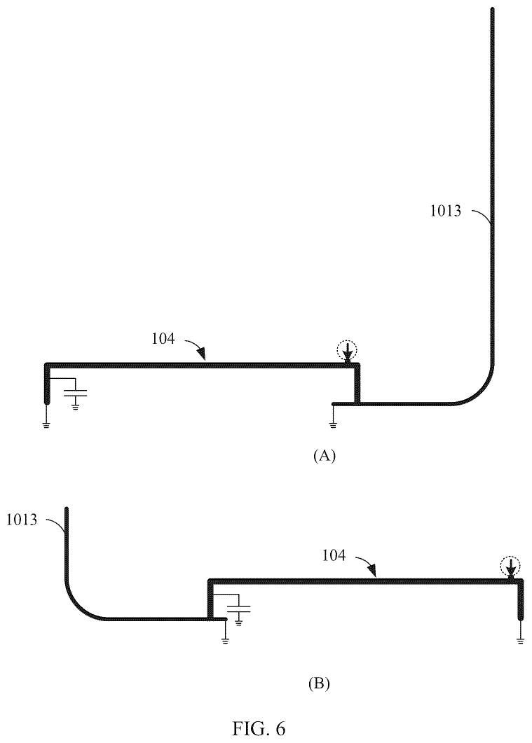

Based on the foregoing structure of the transmission line 104, one end of the transmission line 104 is connected close to a ground end of an IFA radiator, and the other end is directly grounded (as shown in (A) in FIG. 6). In this case, a length of the radiator is approximately ¼ of a dielectric wavelength corresponding to a resonance frequency of the antenna. In the embodiment shown in (A) in FIG. 6, the IFA radiator forms a low frequency antenna, and a resonance generated by the IFA radiator may cover a low frequency band. In some alternative embodiments, one end of the transmission line 104 is connected close to a ground end of an IFA radiator, and the other end is directly grounded (as shown in (B) in FIG. 6). In this case, a length of the radiator is approximately ¼ of a dielectric wavelength corresponding to a resonance frequency of the antenna. In the embodiment shown in (B) in FIG. 6, the IFA radiator forms a medium frequency antenna, and a resonance generated by the IFA radiator may cover a medium frequency band. Because the connection points between the transmission line 104 and the radiators are close to the ground points of the radiators, the transmission line 104 in this case is similar to a transmission line 104 that is grounded at two ends. In the embodiment shown in FIG. 6, the radiator uses a metal side frame, and is disposed at a corner at any position of a side frame of the electronic device.

Based on the foregoing analysis, when feeding is performed, the transmission line 104 (whose length is approximately ½ of a dielectric wavelength corresponding to a resonance frequency of the antenna) can separately generate three resonances at a low frequency, a medium frequency, and a high frequency, to form transmission line modes. When feeding is performed on the transmission line 104 in the antenna structure shown in each of (A) in FIG. 6 and (B) in FIG. 6, the radiator separately generates resonances at a low frequency, a medium frequency, and a high frequency, to form radiator modes. The length of the transmission line 104 is set to approximately ½ of a dielectric wavelength corresponding to a low frequency resonance frequency, so that the transmission line mode and the radiator mode are superimposed in corresponding frequency bands, thereby effectively improving efficiency and a bandwidth. In an embodiment, the transmission line 104 is connected close to the ground end of the radiator, and may satisfy a boundary condition of the transmission line mode.

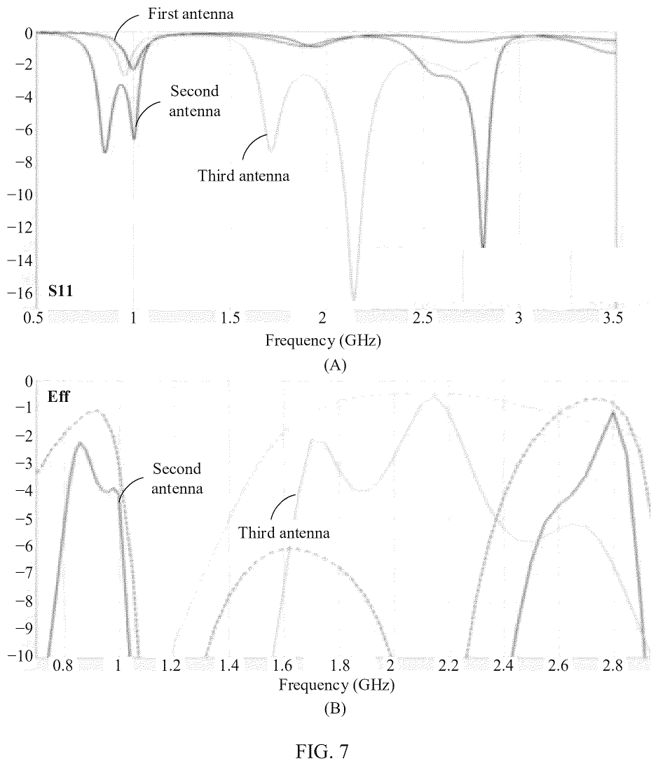

By using the structure shown in (A) in FIG. 5 as a first antenna, the structure shown in (A) in FIG. 6 as a second antenna, and the structure shown in (B) in FIG. 6 as a third antenna, (A) in FIG. 7 and (B) in FIG. 7 respectively show diagrams of S11 curves and efficiency of the three types of antennas. It may be found that the structure of the transmission line 104 implements mode extension for both a low frequency band and a high frequency band of the second antenna, and also implements mode extension for a low frequency band of the third antenna, thereby greatly improving an efficiency bandwidth.

(A) in FIG. 6 and (B) in FIG. 6 respectively show a case in which one end of the transmission line 104 is connected to one end of the radiator In some embodiments, two ends of the transmission line 104 may be respectively connected to radiators operating in a same frequency band or different frequency bands. In some embodiments, the radiators respectively connected to the two ends of the transmission line 104 may include a continuous section of a side frame. This may include two cases. One case is that the first radiator and the second radiator that are connected to the transmission line are connected to each other and include the continuous section of the side frame. The other case is that the first radiator and the second radiator each include a continuous section of the side frame, but the sections in which the first radiator and the second radiator are located are separated. The separation herein may mean that two conductive sections are isolated by using a non-conductive material or mean that two conductive sections are connected by using another part of the side frame, and therefore, ground ends of the two conductive sections are separated; or mean that two conductive sections of the first radiator and the second radiator include both a non-conductive material and another part of the side frame. These cases will be further described below.

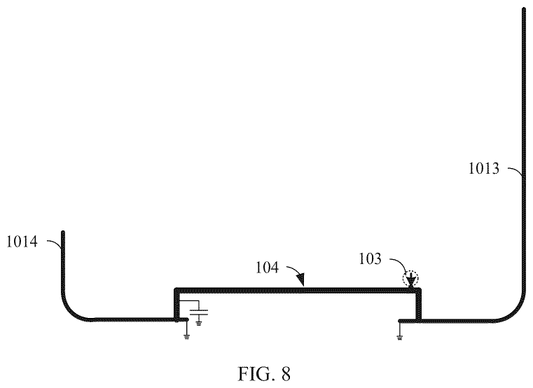

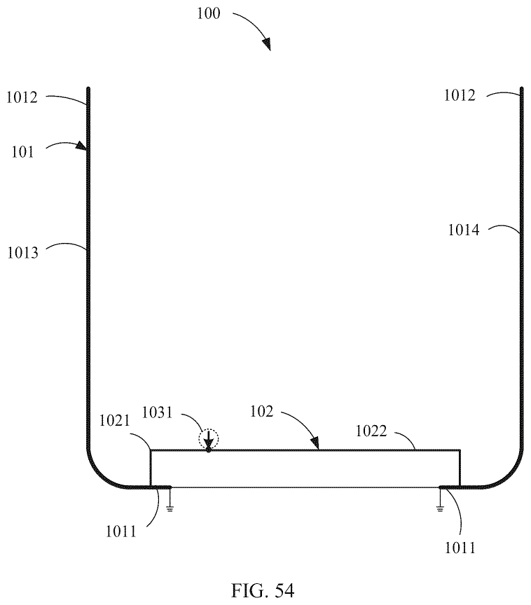

The two ends of the transmission line 104 are respectively connected to the radiators operating in the same frequency band or different frequency bands. For example, FIG. 8 below shows that one end of the transmission line 104 is connected to a first radiator 1013, and the other end is connected to a second radiator 1014. The first radiator 1013 and the second radiator 1014 operate in different frequency bands, for example, operate respectively in a low frequency band and a medium frequency band. For another example, an example structure of an antenna 100 is shown below in FIG. 54. The antenna 100 shown in FIG. 54 includes a radiator pair 101 (including the first radiator 1013 and the second radiator 1014) operating in a same frequency band, a transmission line 102, and a feeding unit 1031. In embodiments shown in FIG. 8 and FIG. 54, the transmission line is separately connected close to a ground end of the first radiator 1013 and a ground end of the second radiator 1014. It should be understood that the transmission line may be separately connected close to an open end of the first radiator 1013 and an open end of the second radiator 1014; or one end of the transmission line is connected to the ground end of one of the radiators, and the other end is connected to the open end of the other radiator.

Transmission lines connected to radiators operating in a same frequency band or different frequency bands each include two sections of unequal equivalent lengths, for example, two sections of unequal physical lengths. In the following, an inventive concept according to the present disclosure is described mainly by using a physical length of a transmission line as an example. It should be understood that, there may be one or more transmission lines connected to the radiators operating in the same frequency band or different frequency bands, for example, two transmission lines. Two ends of each transmission line are respectively connected to the radiators operating in the same frequency band or different frequency bands, and each transmission line includes two sections of unequal equivalent lengths, for example, two sections of unequal physical lengths.

In addition to the physical length, the equivalent length may be further determined by using at least one of the following: a capacitor or an inductor disposed between a corresponding transmission line and a radiator pair, a phase shifter disposed on a corresponding transmission line, and a position at which a corresponding transmission line is coupled to the radiator pair. This will be further described below. The “length” mentioned in this specification usually means the physical length. The feeding unit is coupled to the first radiator 1013 and the second radiator 1014 respectively through the two sections, as shown in FIG. 8 or FIG. 54. The equivalent lengths of the two sections are different, and therefore excitation currents provided by the feeding unit have a phase difference when the excitation currents are transmitted to the first radiator 1013 and the second radiator 1014. In some embodiments, a difference between the lengths of the two sections may be between ⅛ and ⅜ of a dielectric wavelength, for example, approximately ¼ of a dielectric wavelength. For example, for a frequency band whose resonance frequency ranges from 1920 MHz to 1980 MHz, a dielectric wavelength corresponding to a center frequency 1955 MHz of the frequency band is 15 cm. Therefore, it is obtained through calculation that in some embodiments, the difference between the lengths of the two sections may be between 1 cm and 7 cm. In some alternative embodiments, a difference between lengths of two sections of a transmission line may be less than ⅛ or less. These cases will be further described below. In addition, it should be further noted that a range mentioned in this specification includes values of endpoints. For example, that a difference D between lengths may be between 1 cm and 7 cm indicates that 1 cm≤D≤7 cm. Other ranges of proportions and/or angles are similar. Based on an asymmetrically fed radiator pair 101 (for example, including the first radiator 1013 and the second radiator 1014), the excitation currents respectively reach a feeding point A and a feeding point B (for example, an electrical connection point between the transmission line and the two radiators) through the two sections of the transmission line, and have a phase difference Φ. The phase difference is within a range of 90°±45°. For example, in some embodiments, the phase difference of the excitation currents obtained when the excitation currents respectively reach the feeding point A and the feeding point B through the two sections is within a range of 90°±30°.

In an embodiment, the length of the transmission line is an odd multiple of ½ of a dielectric wavelength, for example, ½ of a dielectric wavelength. A difference between equivalent lengths of the two sections of the transmission line is ¼ of a dielectric wavelength. In an embodiment, a feeding part can implement equal-amplitude codirectional currents at the point A and the point B. In an embodiment, currents excited by the feeding part on the radiator pair 101 are codirectional.

In an embodiment, that the length of the transmission line is an odd multiple of ½ of a dielectric wavelength may be understood as that the length of the transmission line is within a range of [the odd multiple of ½ of a dielectric wavelength×(1±20%)]. In an embodiment, that the difference between the lengths of the two sections of the transmission line is ¼ of a dielectric wavelength may be understood as that the difference between the lengths is within a range of [¼ of a dielectric wavelength×(1±10%)]. For the equivalent length, considering a capacitor, an inductor, or the like that is disposed on the transmission line, as mentioned above, a relationship between a physical length L and an equivalent length Le may satisfy (1−⅓)Le≤L≤(1+⅓)Le or (1−¼)Le≤L≤(1+¼)Le.

In an embodiment, the length of the transmission line is an even multiple of ½ of a dielectric wavelength, for example, 1-fold of a dielectric wavelength. The difference between the two sections of the transmission line is ¼ of a dielectric wavelength. In an embodiment, the feeding part can implement equal-amplitude reverse currents at the point A and the point B. In an embodiment, currents excited by the feeding part on the radiator pair 101 are reverse.

In an embodiment, that the length of the transmission line is an even multiple of ½ of a dielectric wavelength may be understood as that the length of the transmission line is within a range of (the even multiple of ½ of a dielectric wavelength×(1±20%)). In an embodiment, that the difference between the lengths of the two sections of the transmission line is ¼ of a dielectric wavelength may be understood as that the difference between the lengths is within a range of (¼ of a dielectric wavelength×(1±10%)). For the equivalent length, considering a capacitor, an inductor, or the like that is disposed on the transmission line, as mentioned above, a relationship between a physical length L and an equivalent length Le may satisfy (1−⅓)Le≤L≤(1+⅓)Le or (1−¼)Le≤L≤(1+¼)Le.

In embodiments of this application, the lengths of the two sections of the transmission line are unequal, for example, based on a phase difference needed on the radiator pair 101, the difference between the lengths of the two sections may be set to another range from between ⅛ and ⅜ of a dielectric wavelength. In this manner, the antenna 100 can also separately control phase differences of currents on the radiator pair 101, thereby helping improve various types of performance of the antenna 100.

In some alternative embodiments, in addition to unequal physical lengths, equivalent lengths of the sections or the transmission line may be ensured to be unequal in another appropriate manner, to implement the phase difference between the feeding points. In such an embodiment, the antenna also includes a radiator pair, at least one transmission line, and a feeding unit. The at least one transmission line includes two sections. The feeding unit is separately coupled to a first feeding point of a first radiator and a second feeding point of a second radiator through the two sections. Equivalent lengths of the two sections are unequal, so that a phase difference that is of excitation currents provided by the feeding unit and that is between the first feeding point and the second feeding point is within a range of 90°±45°. For example, in some embodiments, the phase difference is within a range of 90°±30°. In some embodiments, in addition to physical lengths of the two sections, the equivalent lengths of the two sections may be determined by using at least one of the following: a capacitor or an inductor disposed between a corresponding section and a radiator pair, a phase shifter disposed on a corresponding section, and a position at which a corresponding section is coupled to the radiator pair.

FIG. 8 shows a schematic diagram in which one end of the transmission line 104 is connected to a first radiator 1013 and is connected close to a ground end of the first radiator 1013, and the other end of the transmission line 104 is connected to a second radiator 1014 and is connected close to a ground end of the second radiator 1014. In an embodiment, the first radiator 1013 may be a radiator operating in a low frequency band. In an embodiment, the second radiator 1014 may be a radiator operating in a medium frequency band. In the example shown in FIG. 8, an electrical length of the first radiator 1013 is approximately between ⅛ and ⅜ of a dielectric wavelength corresponding to a first resonance frequency (for example, a low frequency) of the antenna. In an embodiment, a physical length of a low frequency radiator may be between 45 mm and 70 mm, for example, 58.5 mm. An electrical length of the second radiator 1014 is between ⅛ and ⅜ of a dielectric wavelength corresponding to a second resonance frequency (for example, a medium frequency) of the antenna. In an embodiment, a physical length of a medium frequency radiator may be between 22 mm and 35 mm, for example, 27.5 mm. The transmission line 104 uses a microstrip structure, and an electrical length of the transmission line 104 corresponds to approximately ½ of a wavelength of a resonance frequency (for example, a low frequency) of a first transmission line. In an embodiment, a physical length of a low frequency transmission line is approximately between 65 mm and 75 mm, for example, 70 mm. A slot may be disposed between each of the first radiator 1013 and the second radiator 1014 and another part of the side frame, and a width of the slot may be within 3 mm. For example, in some embodiments, the width may be within 2 mm, for example, approximately 1 mm. The slot may be filled with a non-conductive material.

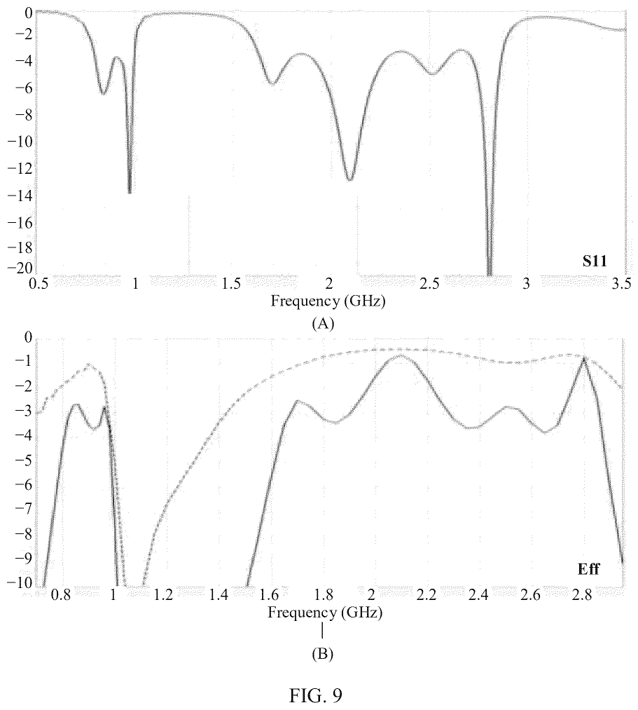

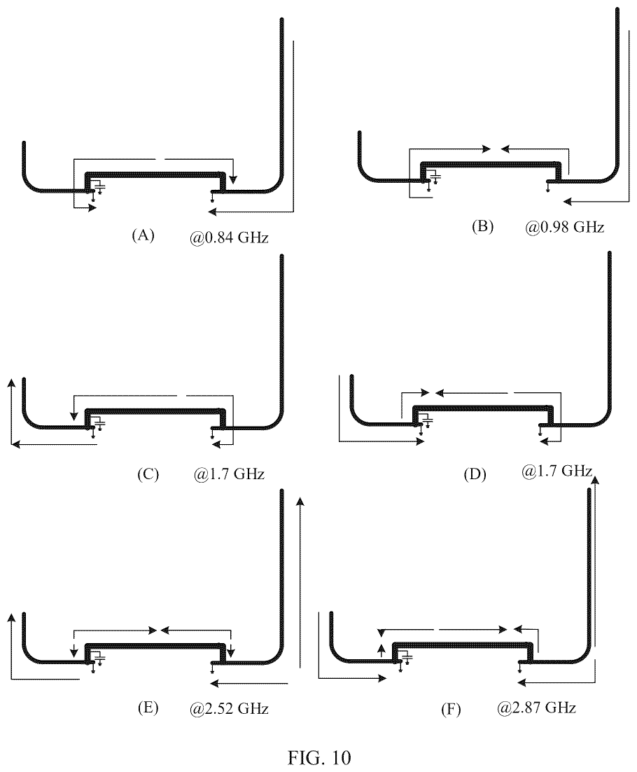

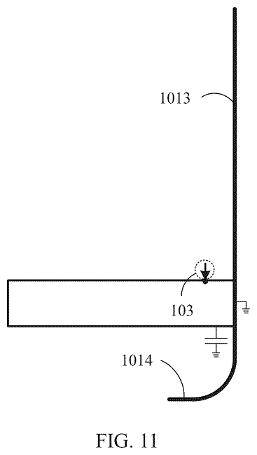

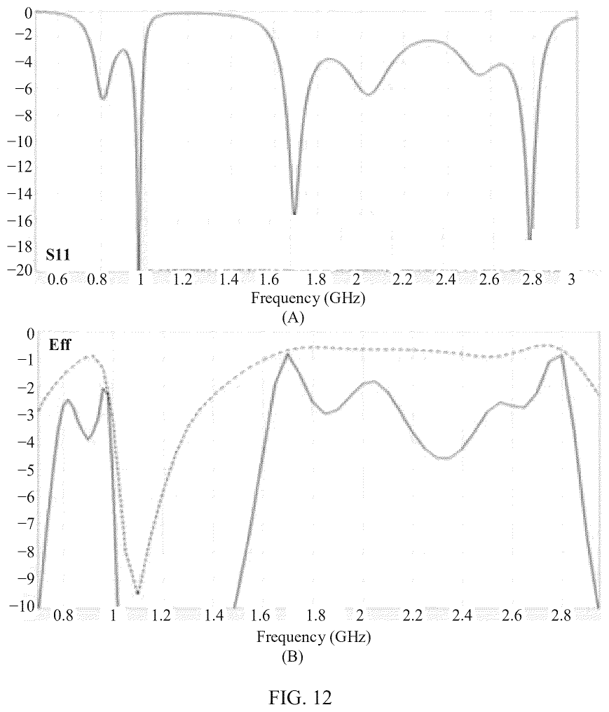

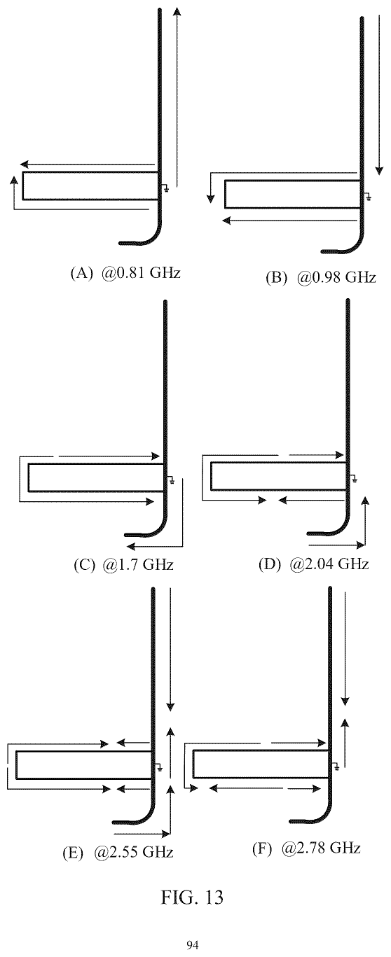

In this case, based on the foregoing analysis, the antenna m this arrangement can separately excite two modes at a low frequency, a medium frequency, and a high frequency to implement coverage of six resonance frequencies in a full frequency band. A reflection coefficient S11 and an efficiency curve are shown in (A) in FIG. 9 and (B) in FIG. 9, and current distribution in each mode is shown in FIG. 10. As shown in FIG. 9 and (A and B) in FIG. 10, two resonance frequencies of a low frequency band of the antenna are mainly implemented by a low frequency resonance frequency of the first radiator 1013 and a low frequency resonance frequency (corresponding to a ½ dielectric wavelength mode) of the transmission line 104. As shown in FIG. 9 and (C and D) in FIG. 10, two resonance frequencies of a medium frequency band are mainly implemented by a low frequency resonance frequency of the second radiator 1014 and a medium frequency resonance frequency (corresponding to a 1-fold dielectric wavelength mode) of the transmission line 104. As shown in FIG. 9 and (E and F) in FIG. 10, two resonance frequencies of a high frequency band are mainly implemented by a high frequency resonance frequency of the first radiator 1013 and a high frequency resonance frequency (corresponding to a 1.5-fold dielectric wavelength mode) of the transmission line 104. Compared with a case of a single radiator, efficiency and a bandwidth of the antenna structure shown in FIG. 8 are significantly increased. In some embodiments, the radiators shown in FIG. 8 may alternatively be obtained by combining the two IFA radiators into a T radiator structure. It may be considered that the first radiator 1013 and the second radiator 1014 share a ground end, and a similar transmission line 104 is also used for connection and feeding, as shown in FIG. 11. In the example shown in FIG. 11, an electrical length of the first radiator 1013 is approximately between ⅛ and ⅜ of a dielectric wavelength corresponding to a first resonance frequency (for example, a low frequency) of the antenna. In an embodiment, a physical length of a low frequency radiator may be between 45 mm and 70 mm, for example, 50 mm. An electrical length of the second radiator 1014 is between ⅛ and ⅜ of a dielectric wavelength corresponding to a second resonance frequency (for example, a medium frequency) of the antenna. In an embodiment, a physical length of a medium frequency radiator may be between 22 mm and 35 mm, for example, 30 mm. The transmission line 104 uses a microstrip structure, and an electrical length of the transmission line 104 corresponds to approximately ½ of a wavelength of a resonance frequency (for example, a low frequency) of a first transmission line. In an embodiment, a physical length of a low frequency transmission line is approximately between 65 mm and 75 mm, for example, 70 mm. An antenna of this structure may also be extended at a low frequency, a medium frequency, and a high frequency, and a reflection coefficient S11 and an efficiency curve of the antenna are shown in (A) in FIG. 12 and (B) in FIG. 12. Current distribution of the six modes is shown in (A) in FIG. 13 to (F) in FIG. 13 respectively.

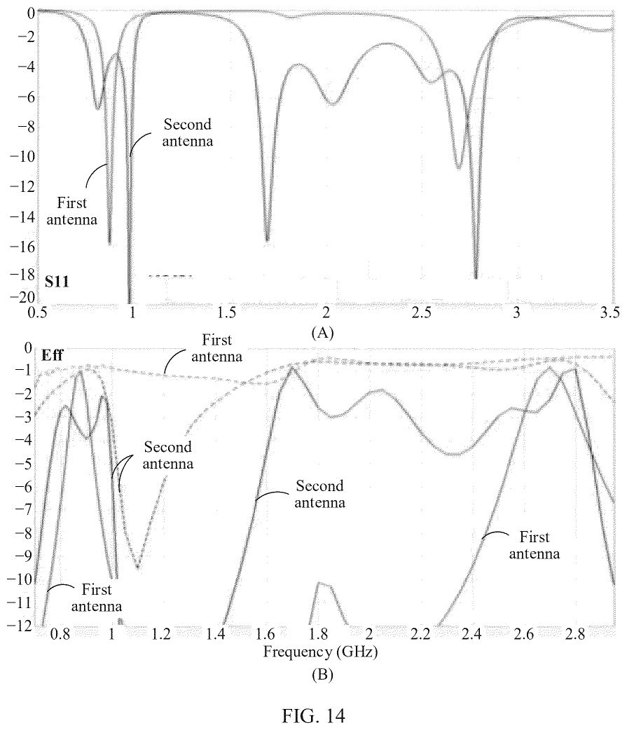

By using a T antenna that is directly fed as a first antenna, and the antenna shown in FIG. 11 as a second antenna, (A) in FIG. 14 and (B) in FIG. 14 respectively show S11 curves and efficiency curves of the two types of antennas. Only one feeding point is disposed on a T-type radiator of the first antenna, and a specific position of the feeding point is not limited. It can be found from FIG. 14 that the first antenna can excite a maximum of three modes of the radiator. Consequently, the mode excitation is insufficient, and an efficiency bandwidth is insufficient. When the transmission line 104 that is approximately ½ of a dielectric wavelength is coupled to the ground end of the radiator for feeding to form the second antenna, both efficiency and a bandwidth of the second antenna can be significantly improved.

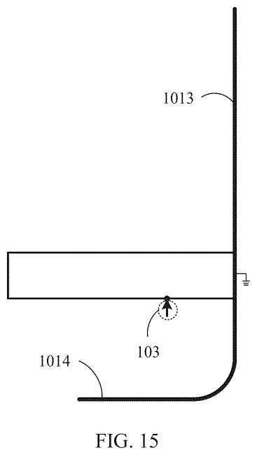

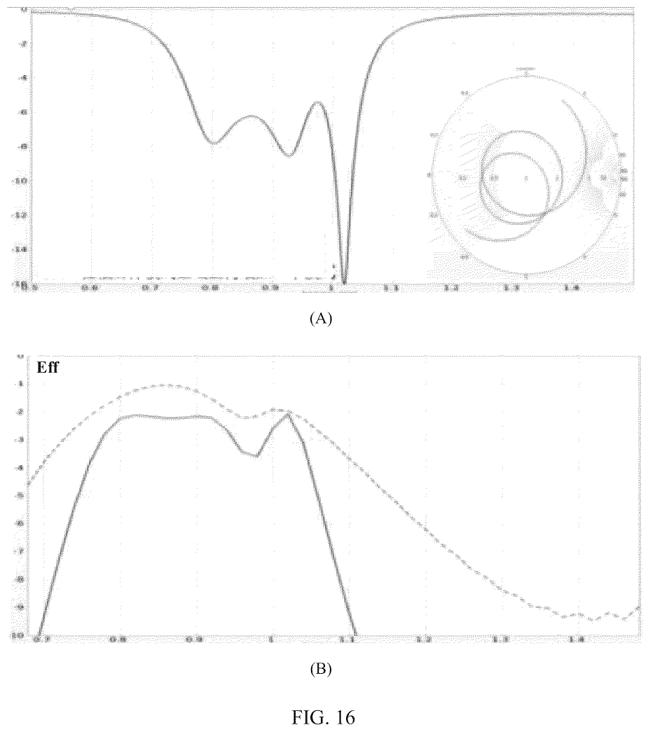

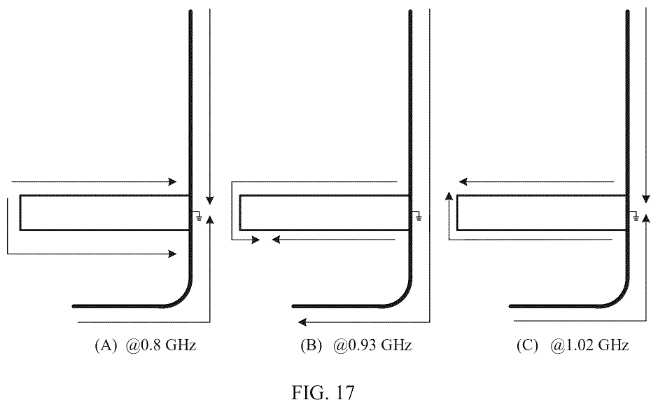

In some embodiments, the structure of the transmission line 104 in this application may alternatively be applied to two radiators operating in a same frequency band. In some embodiments, the structure of the transmission line 104 in this application may alternatively be applied to two radiators of equivalent sizes. As shown in FIG. 15, a structure of the T antenna obtained by combining structures of the two IFA radiators is connected close to the ground end for feeding by using the transmission line 104 mentioned above, as shown in FIG. 15. In the example shown in FIG. 15, electrical lengths of the first radiator 1013 and the second radiator 1014 are approximately between ⅛ and ⅜ of a dielectric wavelength corresponding to a first resonance frequency (for example, a low frequency) of the antenna. In an embodiment, a physical length of a low frequency radiator may be between 45 mm and 70 mm, for example, 52.5 mm. The transmission line 104 uses a microstrip structure, and an electrical length of the transmission line 104 corresponds to approximately ½ of a wavelength of a resonance frequency (for example, a low frequency) of a first transmission line. In an embodiment, a physical length of a low frequency transmission line is approximately between 65 mm and 75 mm, for example, 74 mm. (A) in FIG. 16 shows a diagram of an S11 curve and an impedance chart of this antenna. (B) in FIG. 16 shows a diagram of an efficiency curve of this antenna. It can be learned from the figures that in this antenna structure, three modes may be excited at a low frequency band, including two modes (which will be further described below) that are of the antenna and that are generated by the radiators and a mode of the resonance frequency of the first transmission line of the transmission line 104. (A) in FIG. 17 to (C) in FIG. 17 show current distribution for these three modes.

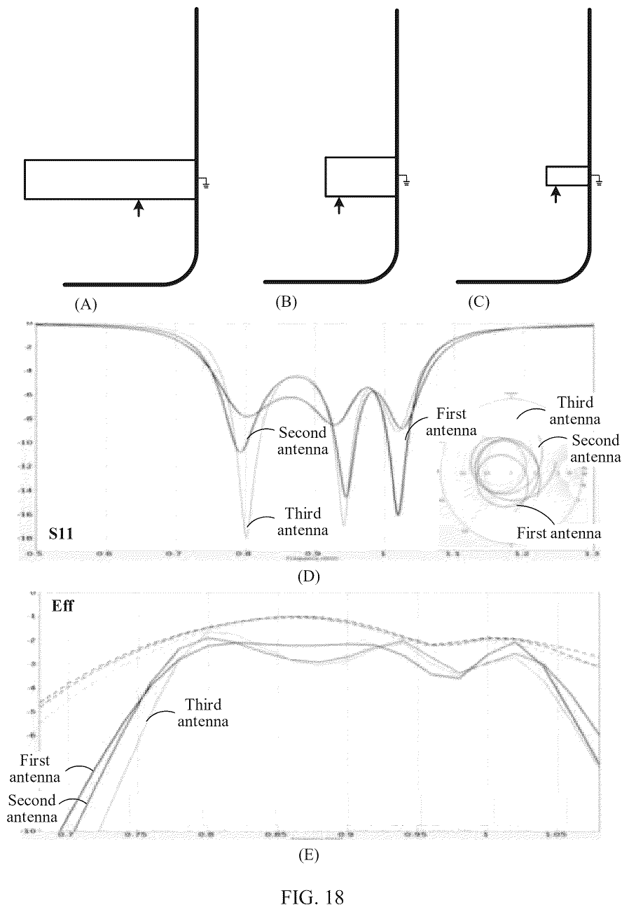

As mentioned above, the miniaturization of the transmission line 104 may be implemented by increasing a dielectric constant of a dielectric. FIG. 18 shows designs of transmission lines 104 loaded with different dielectrics in the embodiment shown in FIG. 15. (A) in FIG. 18 shows a first antenna, where a physical length of a transmission line 104 corresponding to ½ of a dielectric wavelength corresponding to a lowest resonance frequency is approximately 75 mm when a dielectric constant is 4.4. (B) in FIG. 18 shows a second antenna, where a physical length of a transmission line 104 corresponding to ½ of a dielectric wavelength corresponding to a lowest resonance frequency is approximately 32 mm when a dielectric constant is 16. (C) in FIG. 18 shows a third antenna, where a physical length of a transmission line 104 corresponding to ½ of a dielectric wavelength corresponding to a lowest resonance frequency is approximately 22 mm when the dielectric constant is 33. FIG. (D) in 18 shows a diagram of S11 curves and an impedance chart of these antennas. (E) in FIG. 18 shows a diagram of efficiency curves of these antennas. It can be learned that the length of the transmission line 104 decreases by more than ⅔ as the dielectric constant increases, but still satisfies a requirement of an electrical length of ½ of a dielectric wavelength. Therefore, the antenna modes and the efficiency bandwidth mentioned above can be maintained.

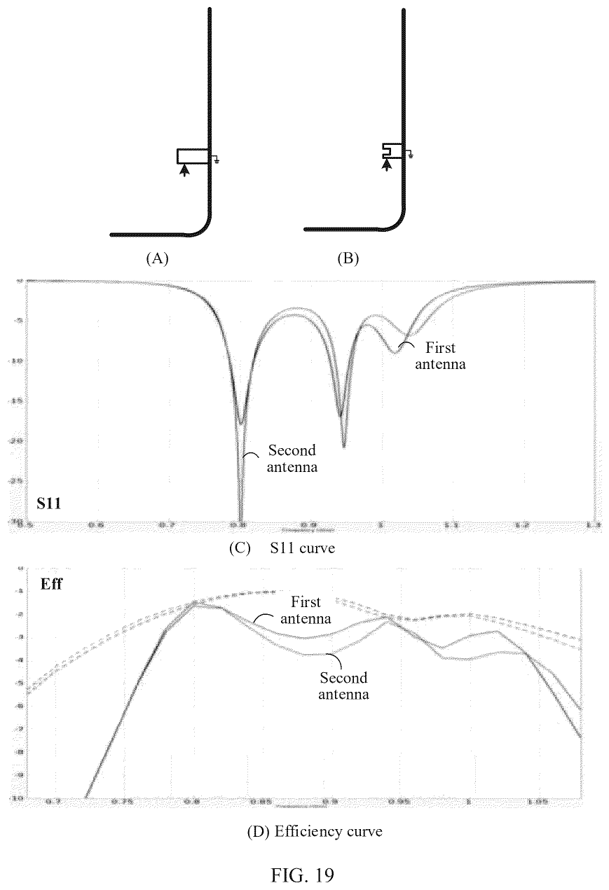

In some embodiments, alternatively or additionally, the transmission line 104 may be in a form of a plurality of bends and windings. (A) in FIG. 19 shows a transmission line 104 (as a transmission line of a first antenna) with a minimum quantity of curved structures when a corresponding dielectric constant is 33. (B) in FIG. 19 shows a transmission line 104 (as a transmission line of a second antenna) with a plurality of curved structures in the same case. (C) in FIG. 19 and (D) in FIG. 19 respectively show a diagram of S11 curves and a diagram of efficiency curves of the two antenna structures. It can be learned that the transmission line 104 with the plurality of curved structures has little impact on the antenna modes and the efficiency bandwidth, so that the antenna and the electronic device are further miniaturized while a high bandwidth and efficiency are maintained.

Certainly, it should be understood that the embodiment in which the transmission line 104 is miniaturized by using different dielectric constants or a plurality of curved structures is merely an example, and is not intended to limit the protection scope of the present disclosure. This manner of miniaturizing the transmission line 104 may be applied to any appropriate embodiment, including but not limited to the embodiment shown in FIG. 6, the embodiment shown in FIG. 8, the embodiment shown in FIG. 11, and various embodiments to be mentioned below. Details are not separately described below.

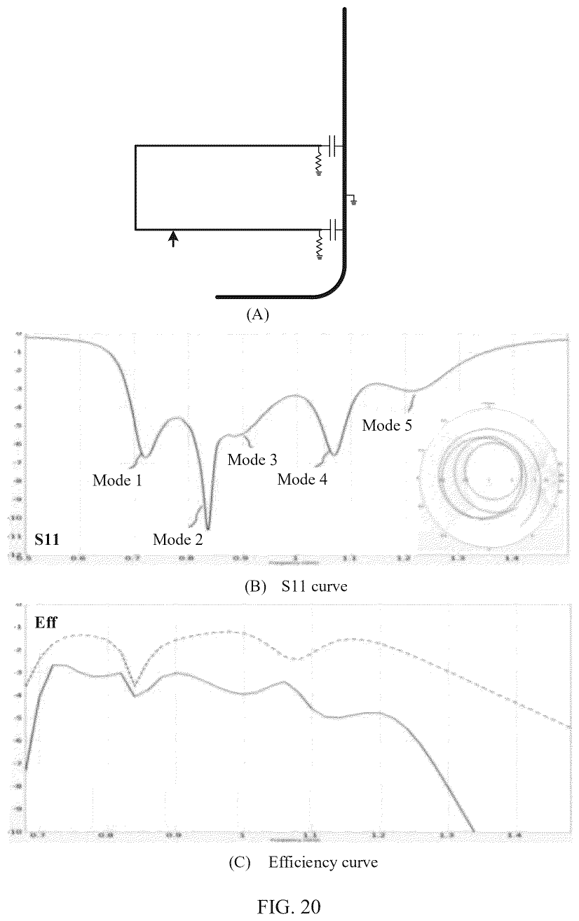

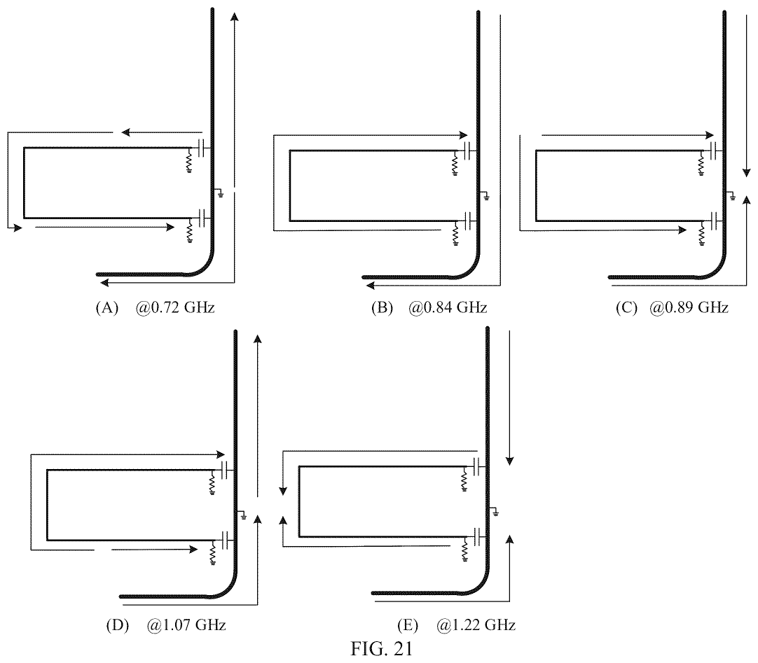

In some embodiments, the structure of the transmission line 104 may be further combined with an impedance matching circuit at a radiator end, to further increase a quantity of resonance frequencies, thereby increasing a bandwidth. A structure of the embodiment shown in (A) in FIG. 20 is similar to that of FIG. 15, and a difference lies in that an impedance matching circuit in which a capacitor is connected in series and an inductor is connected in parallel is added to a connection point between a transmission line 104 and a radiator in the embodiment shown in (A) in FIG. 20. (B) in FIG. 20 and (C) in FIG. 20 respectively show a diagram of an S11 curve and a diagram of an efficiency curve of the antenna structure. In an embodiment, in the embodiment shown in (A) in FIG. 20, five modes may be excited in a target frequency band (for example, a low frequency band), for example, mode 1 to mode 5 shown in (B) in FIG. 20, and current distribution thereof are shown in (A) to (E) in FIG. 21.

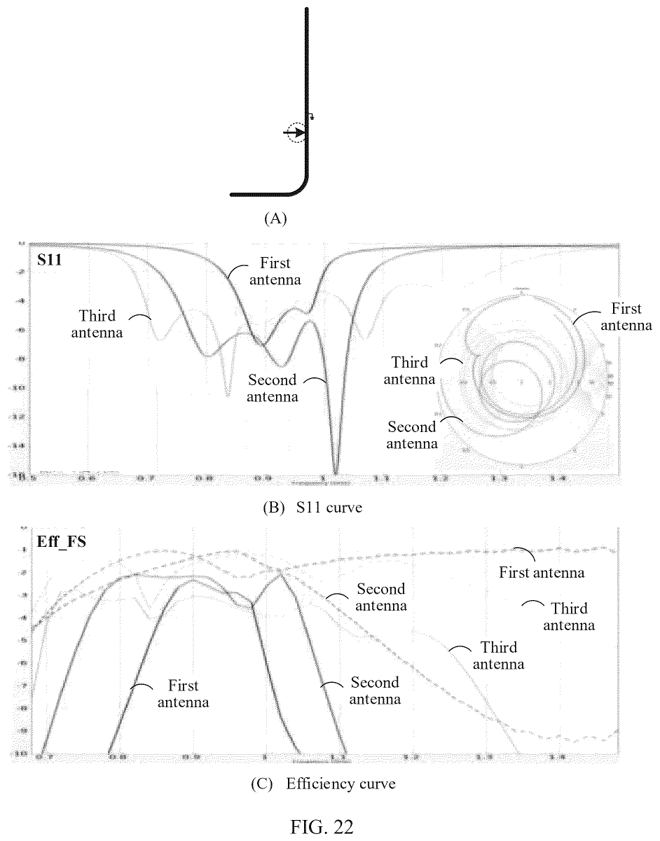

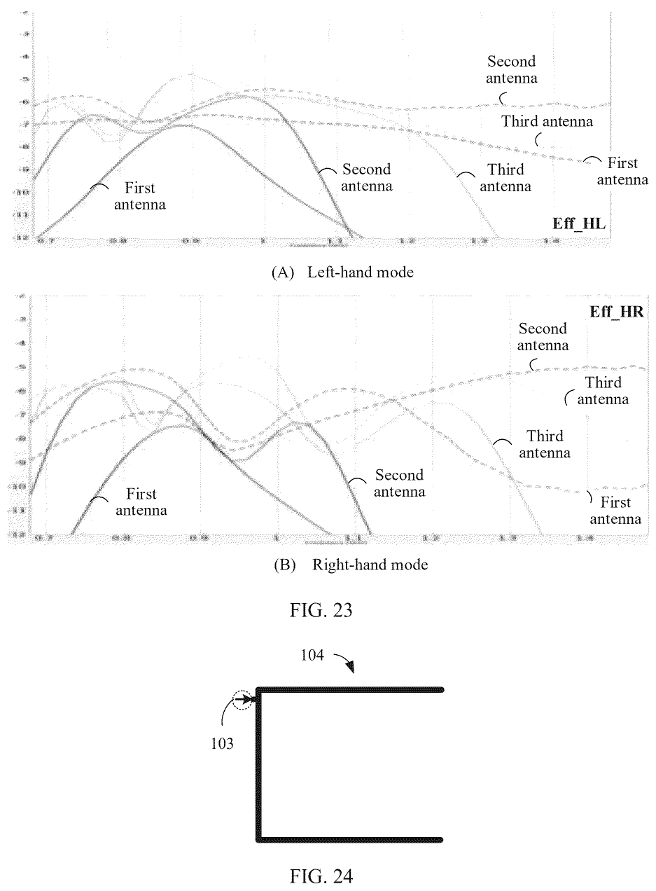

By using the antenna shown in (A) in FIG. 22 as a first antenna, the antenna shown in FIG. 15 as a second antenna, and the antenna shown in FIG. 20 as a third antenna, (B) in FIG. 22 and (C) in FIG. 22 respectively show diagrams of S11 curves and efficiency curves of the three types of antennas, and (A) in FIG. 23 and (B) in FIG. 23 respectively show diagrams of efficiency of the three types of antennas in a left-hand mode and a right-hand mode. As shown in FIG. 22 and FIG. 23, in free space, compared with the antenna structure (the first antenna) shown in (A) in FIG. 22, a −4 dB efficiency bandwidth of the antenna structure (the second antenna) shown in FIG. 15 increases by approximately 1-fold, and a −4 dB efficiency bandwidth of the antenna structure (the third antenna) shown in (A) in FIG. 20 increases by more than 2-fold. In a handheld scenario, both left-hand holding efficiency and right-hand holding efficiency of the antenna structure shown in (A) in FIG. 20 reach more than −8.5 dB in an entire low frequency band (700-1200 MHz).

It should be understood that the impedance matching circuit is used between the transmission line 104 and the low frequency radiator to increase bandwidths of high and low frequency bands. The foregoing embodiment is merely an example, and is not intended to limit the protection scope of the present disclosure. The impedance matching circuit may be used between the transmission line 104 and a radiator of any proper frequency band, to increase a bandwidth of a corresponding radiation frequency band. Details are not separately described below.

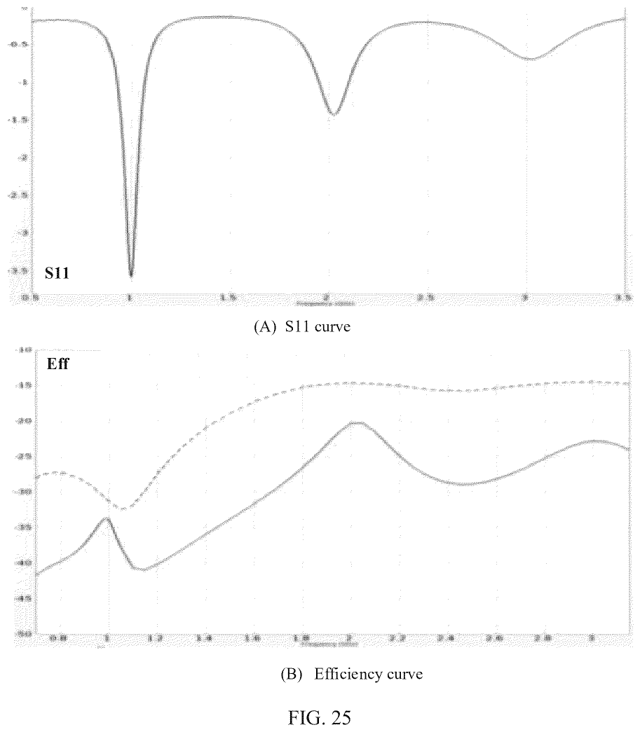

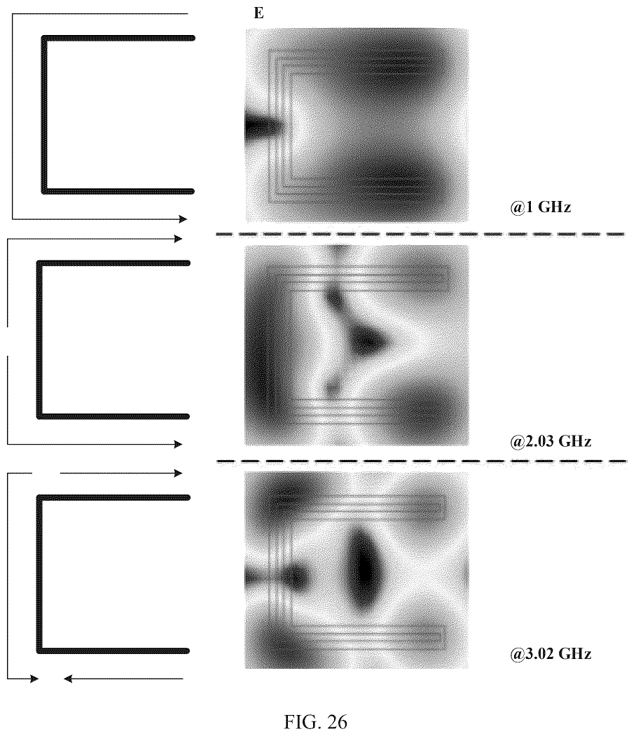

With reference to the accompanying drawings, the foregoing describes a case in which both the two ends of the transmission line 104 are grounded (directly grounded or connected to the ground end of the radiator). In some embodiments, the two ends of the transmission line 104 may alternatively be in an open state, that is, are open ends. FIG. 24 shows a case in which both the two ends of the transmission line 104 are open. In this case, a length T of the transmission line 104 is set to approximately ½λ, where λ is a dielectric wavelength corresponding to a lowest resonance of resonances generated by the antenna when the antenna is fed. In this case, when feeding is performed far away from an open end (for example, at a current strength point or a current strength region), resonances can also be separately generated at a natural multiple of ½ of a dielectric wavelength, like ½, 1-fold, and 3/2-fold, to excite transmission line modes. (A) in FIG. 25 and (B) in FIG. 25 respectively show schematic diagrams of S11 parameters and efficiency of the transmission line 104 when the transmission line 104 is excited. Similarly, because the transmission line 104 is in a closed environment, radiation efficiency of the transmission line 104 is very low, and can be basically negligible. FIG. 26 shows schematic diagrams of current and electric field distribution of the transmission line 104 when the transmission line 104 is excited. With reference to FIG. 25 and FIG. 26, it can be learned that, when the transmission line 104 shown in FIG. 24 is fed, transmission line modes whose resonance frequencies are respectively corresponding to 1 GHz, 2.03 GHz, and 3.02 GHz may be excited.

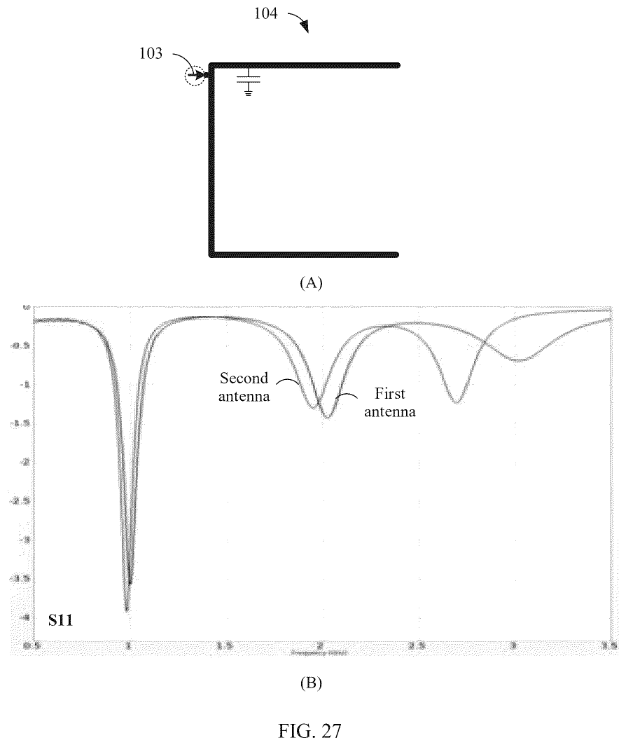

In this case, if a ground regulation circuit is disposed at a predetermined position of the transmission line 104, a resonance frequency of the transmission line mode can be adjusted. The regulation circuit may include a capacitor and/or an inductor. Specifically, if a grounded capacitor can be disposed at a current strength point in a half-wavelength mode and an electric field strength point in a 1-fold wavelength mode or a 1.5-fold wavelength mode, a resonance frequency in a medium and high frequency band can be shifted downwards. If an inductor can be disposed at the foregoing position, a resonance frequency in a medium and high frequency band can be shifted upwards. In some embodiments, if a capacitor (as a second antenna) is loaded at a current strength region in a ½ wavelength mode (corresponding to 1 GHz in FIG. 26) and an electric field strength region in a 1-fold wavelength mode (corresponding to 2.03 GHz in FIG. 26) or a 3/2 wavelength mode (corresponding to 3.02 GHz in FIG. 26), as shown in (A) in FIG. 27, compared with the case of the transmission line 104 shown in FIG. 24 (as a first antenna), a low frequency mode can be basically unchanged, and a medium frequency mode and a high frequency mode are shifted downwards, as shown in (B) in FIG. 27. In this way, the low frequency mode, the medium frequency mode, and the high frequency mode can be adjusted to be close to a needed design frequency band, thereby further improving performance of the antenna.

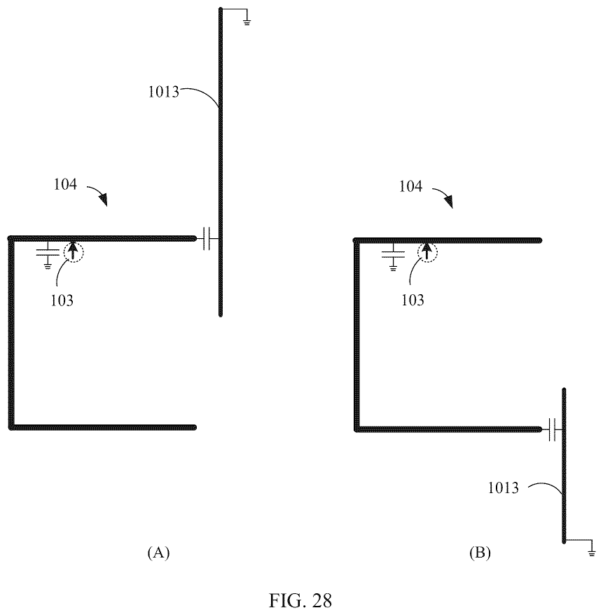

Based on the foregoing structure of the transmission line 104, one end of the transmission line 104 is connected close to an open end of a first composite right/left-handed radiator, and the other end is in an open state (as shown in (A) in FIG. 28). In an embodiment, a connection point between the structure of the transmission line 104 and the composite right/left-handed radiator is between a center point and the open end of the radiator. In this case, a length of the radiator is set to ¼ of a dielectric wavelength corresponding to a first resonance frequency of the antenna. In some alternative embodiments, one end of the transmission line 104 is connected close to an open end of a second composite right/left-handed radiator, and the other end is in an open state (as shown in (B) in FIG. 28). In this case, a length of the radiator is ¼ of a dielectric wavelength corresponding to a second resonance frequency of the antenna. Because the connection points between the transmission line 104 and the radiators are close to the open ends of the radiators, the transmission line 104 in this case is similar to a transmission line 104 that is open at two ends. In the embodiment shown in FIG. 28, the first composite right/left-handed radiator may be a low frequency radiator, and an operating frequency band of the first composite right/left-handed radiator is a low frequency band. In an embodiment, the second composite right/left-handed radiator may be a medium frequency radiator, and an operating frequency band of the second composite right/left-handed radiator is a medium frequency band. In an embodiment, a radiator 1013 shown in FIG. 28 uses a metal side frame and is designed at any position of a side frame of an electronic device.

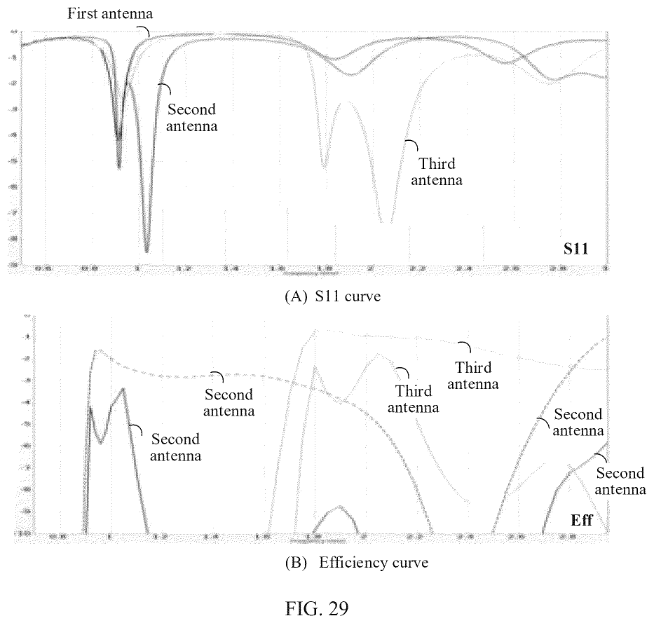

Based on the foregoing analysis, when feeding is performed, the transmission line 104 (whose length is approximately ¼ of a dielectric wavelength corresponding to a low frequency resonance frequency of the antenna) can separately generate three resonances at a low frequency, a medium frequency, and a high frequency, to form transmission line modes. When the antenna structure shown in each of (A) in FIG. 28 and (B) in FIG. 28 is fed, the radiator separately generates resonances at a low frequency, a medium frequency, and a high frequency, to form radiator modes. The length of the transmission line 104 is set to approximately ½ of a dielectric wavelength corresponding to a low frequency resonance frequency, so that the transmission line mode and the radiator mode can be superimposed in respective frequency bands, thereby effectively improving efficiency and a bandwidth. In an embodiment, the transmission line 104 is connected close to the open end of the radiator, and may satisfy a boundary condition of the transmission line mode. By using the structure shown in FIG. 27 as a first antenna, the structure shown in (A) in FIG. 28 as a second antenna, and the structure shown in (B) in FIG. 28 as a third antenna, (A) in FIG. 29 and (B) in FIG. 29 respectively show diagrams of S11 curves and efficiency of the three types of antennas. It may be found that the structure of the transmission line 104 implements mode extension for both a low frequency band and a high frequency band of the low frequency radiator (the second antenna), and also implements mode extension for a low frequency band of the medium frequency radiator (the third antenna), thereby greatly improving an efficiency bandwidth. In addition, in this manner of bandwidth extension, a size of the radiator does not need to be increased, thereby facilitating miniaturization of an antenna and an electronic device.

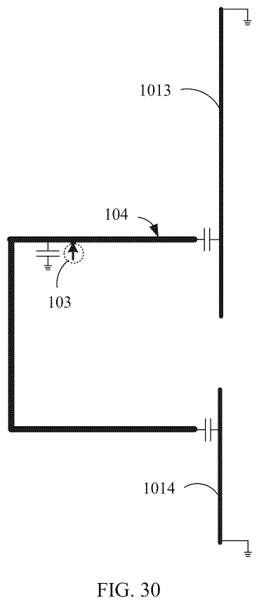

(A) in FIG. 28 and (B) in FIG. 28 respectively show two cases in which one end of the transmission line 104 is connected to the radiator 1013, and the other end is open. In some embodiments, two ends of the transmission line 104 may be respectively connected to radiators operating in a same frequency band or different frequency bands. FIG. 30 shows a schematic diagram in which one end of the transmission line 104 is connected to a first radiator 1013 and is connected close to an open end of the first radiator 1013 by using a capacitor, and the other end of the transmission line 104 is connected to a second radiator 1014 and is connected close to an open end of the second radiator 1014 by using a capacitor. In an embodiment, the first radiator 1013 may be a low frequency radiator, and an operating frequency band of the first radiator 1013 is a low frequency band. The second radiator 1014 may be a medium frequency radiator, and an operating frequency band of the second radiator 1014 is a medium frequency band. In the example shown in FIG. 30, an electrical length of the first radiator 1013 is approximately between ⅛ and ⅜ of a dielectric wavelength corresponding to a first resonance frequency (for example, a low frequency resonance frequency) of the antenna. In an embodiment, a physical length of a low frequency radiator may be between 38 mm and 60 mm, for example, 41 mm. An electrical length of the second radiator 1014 is between ⅛ and ⅜ of a dielectric wavelength corresponding to a second resonance frequency (for example, a medium frequency resonance frequency) of the antenna. In an embodiment, a physical length of a medium frequency radiator may be between 12 mm and 35 mm, for example, 16 mm. The transmission line 104 uses a microstrip structure, and an electrical length of the transmission line 104 corresponds to approximately ½ of a wavelength of a low frequency resonance frequency. In an embodiment, a physical length of a low frequency transmission line is approximately between 70 mm and 90 mm, for example, 80 mm. In an embodiment, there is a slot between open ends that are of the first radiator 1013 and the second radiator 1014 and that are close to each other, and a width of the slot is within 3 mm. For example, in some embodiments, the width may be within 2 mm, for example, approximately 1 mm. In this embodiment, the first radiator 1013 and the second radiator 1014 form a slot antenna structure. A slot of the slot antenna structure may be filled with a non-conductive material.

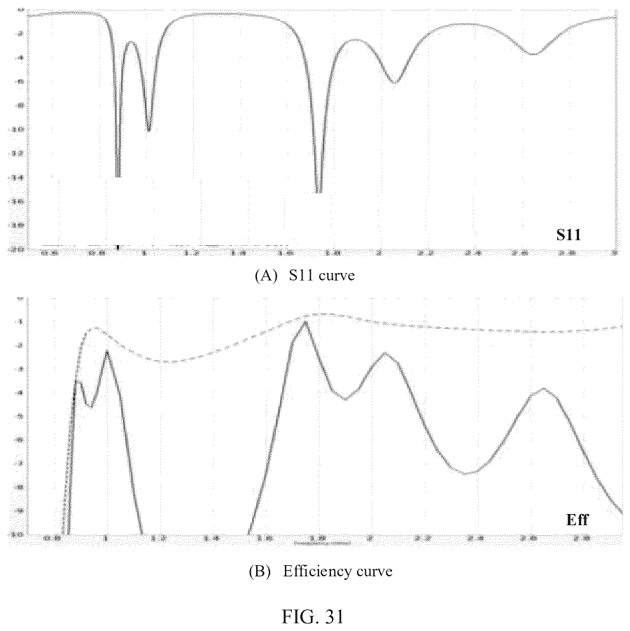

In this case, based on the foregoing analysis, the antenna in this arrangement can implement coverage of five resonance frequencies in a full frequency band, and a reflection coefficient S11 and an efficiency curve are shown in (A) in FIG. 31 and (B) in FIG. 31. (A) in FIG. 32 to (E) in FIG. 32 show diagrams of current distribution of five modes. As shown in FIG. 31, the two resonance frequencies in a low frequency band of the antenna are mainly implemented by a low frequency resonance frequency of the first radiator 1013 and a low frequency resonance frequency (corresponding to ½ of a dielectric wavelength) of the transmission line 104, and the three resonance frequencies in a medium and high frequency band are mainly implemented by medium and high frequency resonance frequencies (corresponding to 1-fold and 1.5-fold of a dielectric wavelength) of the second radiator 1014 and the transmission line 104. Compared with a case of a single radiator, efficiency and a bandwidth of the antenna structure shown in FIG. 30 are multiplied.

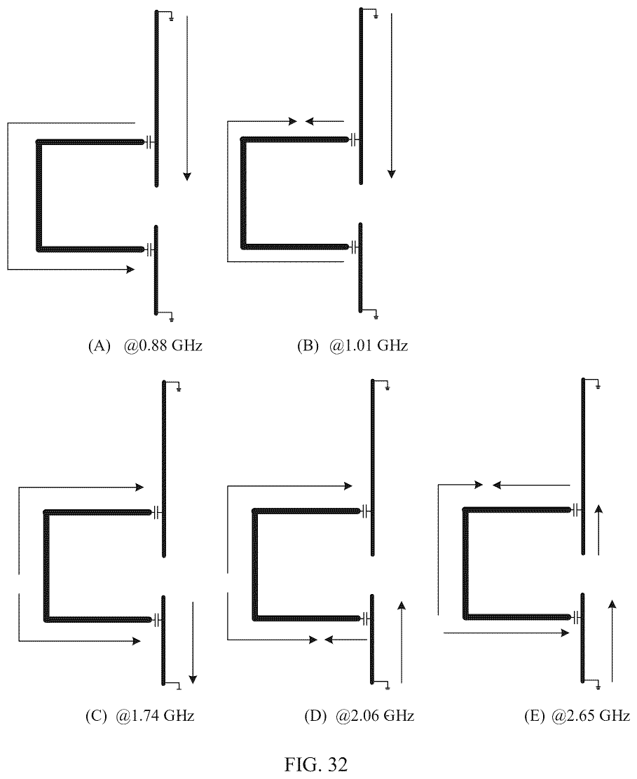

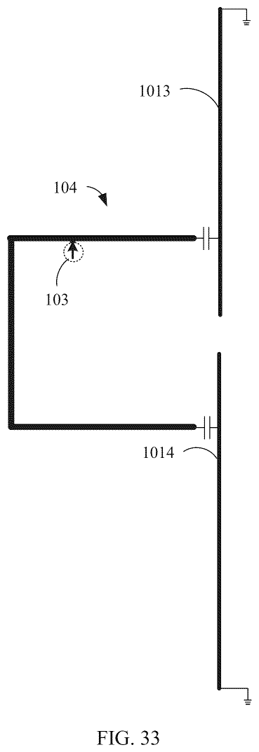

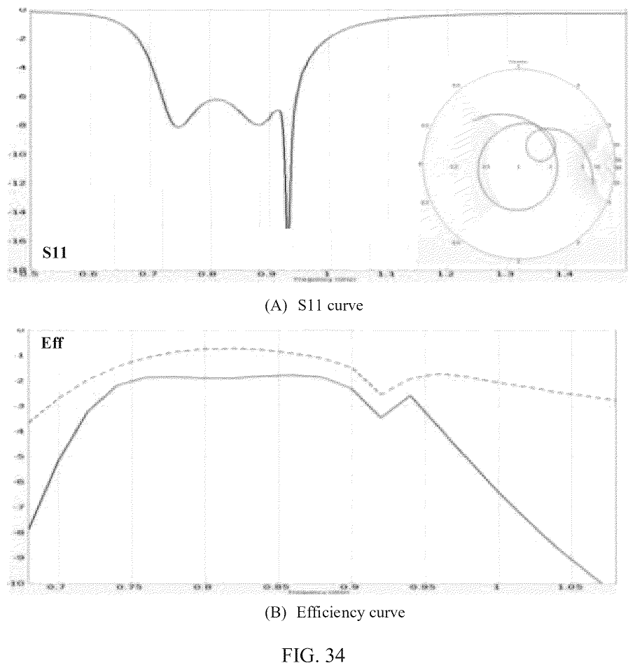

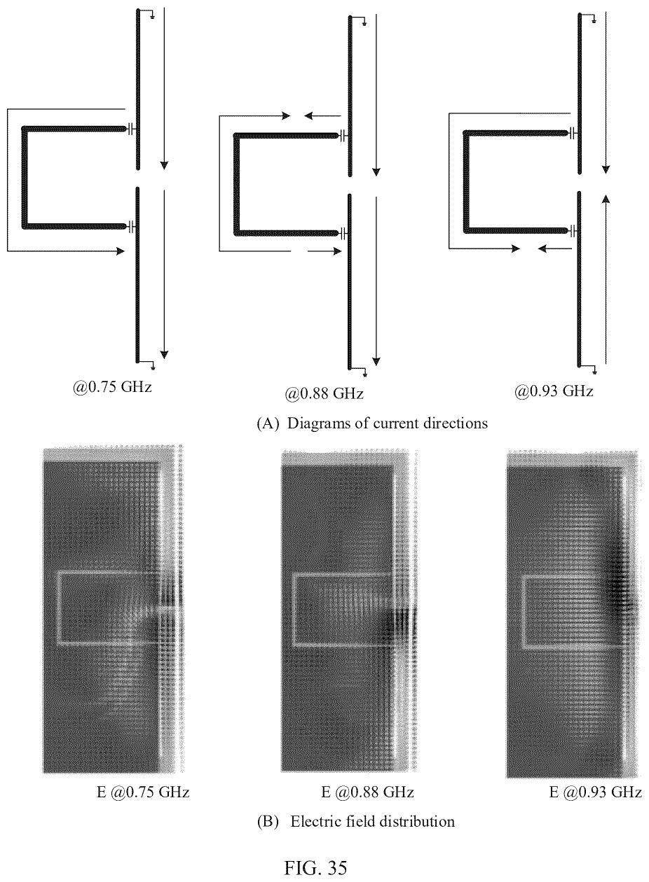

In some embodiments, this structure of the transmission line 104 may alternatively be applied to two radiators having a same operating frequency band. In some embodiments, this structure of the transmission line 104 may alternatively be applied to two radiators of equivalent size. As shown in FIG. 33, structures of two CRLH radiators form a slot antenna structure. The transmission line 104 mentioned above is used to connect close to open ends of the two CRLH radiators for feeding, as shown in FIG. 33. In an embodiment, the two CRLH radiators may both operate in a low frequency band. In the example shown in FIG. 33, electrical lengths of the first radiator 1013 and the second radiator 1014 are approximately between ⅛ and ⅜ of a dielectric wavelength corresponding to a low frequency resonance frequency of the antenna. For example, physical lengths of the first radiator 1013 and the second radiator 1014 may be between 38 mm and 60 mm, for example, 41 mm. The transmission line 104 uses a microstrip structure, and an electrical length of the transmission line 104 corresponds to approximately ½ of a wavelength of a low frequency resonance frequency, and a physical length of the transmission line 104 is approximately between 70 mm and 90 mm, for example, 80 mm. (A) in FIG. 34 shows a diagram of an S11 curve and an impedance chart of this antenna. (B) in FIG. 34 shows a diagram of an efficiency curve of this antenna. It can be learned from the figures that in this antenna structure, three modes may be excited in a low frequency band, including two modes (which will be further described below) that are of the antenna and that are generated by the radiators and a mode of a low frequency resonance frequency of the transmission line 104. (A) in FIG. 35 and (B) in FIG. 35 respectively show current distribution and electric field distribution of the three modes.

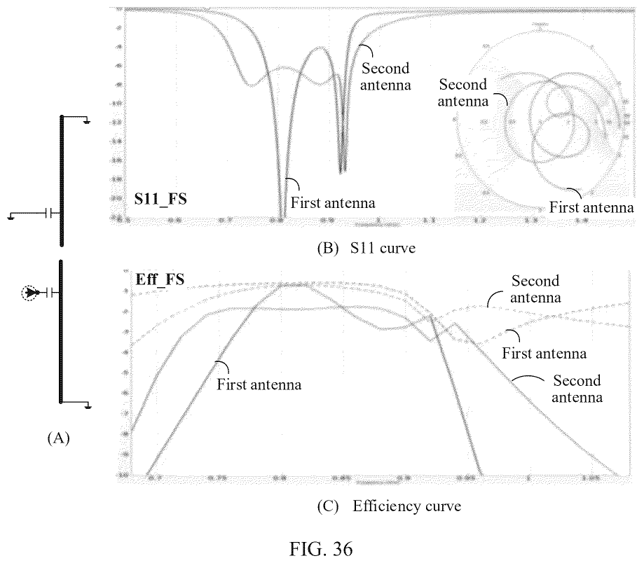

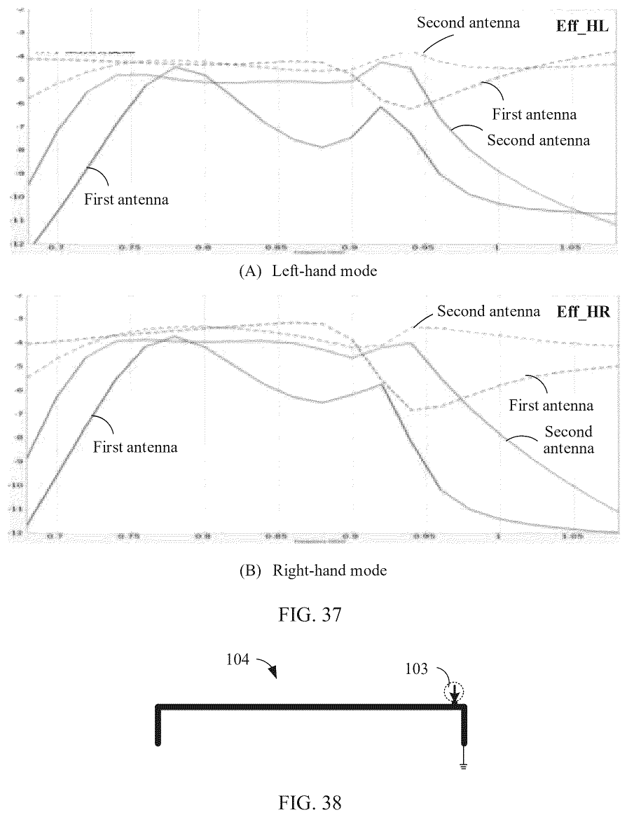

By using the antenna shown in (A) in FIG. 36 as a first antenna, and the antenna shown in FIG. 33 as a second antenna, (B) in FIG. 36 shows a diagram of S11 curves and an impedance chart of the two types of antennas, (C) in FIG. 36 shows a diagram of efficiency curves of the two types of antennas, and (A) in FIG. 37 and (B) in FIG. 37 respectively show diagrams of efficiency of the two types of antennas in a left-hand mode and a right-hand mode. As shown in FIG. 36 and FIG. 37, in free space, the second antenna can excite one more resonance, thereby significantly improving efficiency and a bandwidth of an antenna. In a handheld scenario, efficiency and a bandwidth of the second antenna are improved more significantly. In other words, the antenna according to embodiments of the present disclosure can improve performance of a hand mode and a head-hand mode.

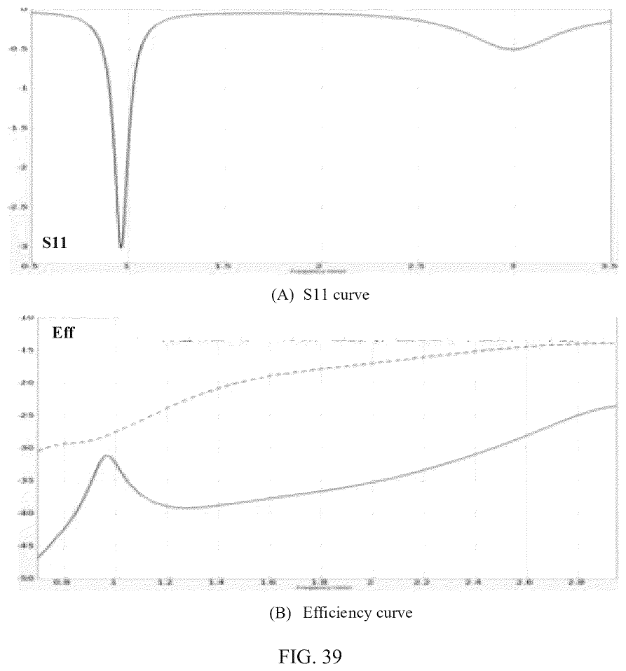

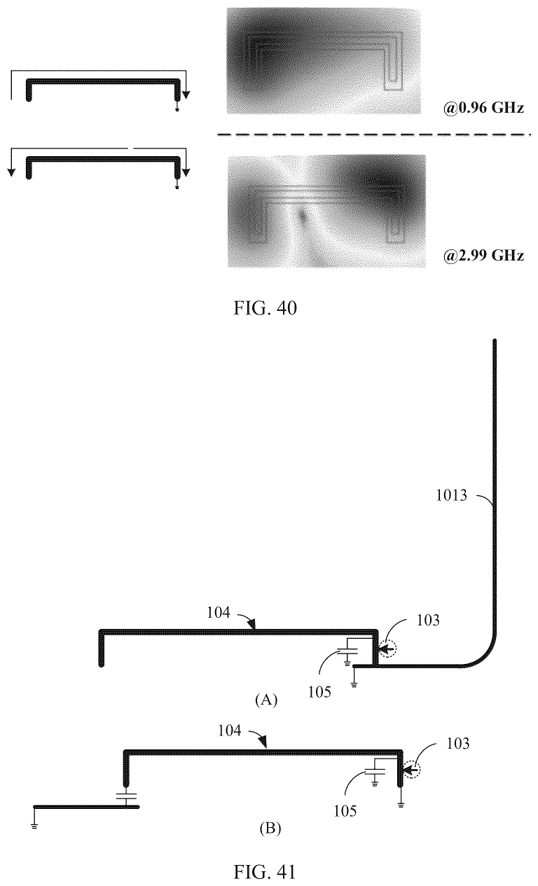

With reference to the accompanying drawings, the foregoing descriptions describe a case in which both the two ends of the transmission line 104 are grounded (directly grounded or connected to the ground end of the radiator) or both the two ends are open. In some embodiments, one of the two ends of the transmission line 104 may be grounded, and the other end is open. FIG. 38 shows a case in which one of two ends of the transmission line 104 is grounded and the other end is open. In this case, a length T of the transmission line 104 is set to approximately ¼λ, where λ is a dielectric wavelength corresponding to a lowest resonance of resonances generated by the antenna when the antenna is fed. In this case, when feeding is performed close to a ground end (for example, in a current strength region), resonances can also be separately generated at a natural multiple of ¼ of a dielectric wavelength, like ¼ and ¾, to excite transmission line modes. (A) in FIG. 39 and (B) in FIG. 39 respectively show schematic diagrams of S11 parameters and efficiency of the transmission line 104 when the transmission line 104 is excited. Similar to the foregoing embodiment, because the transmission line 104 is in a closed environment, radiation efficiency of the transmission line 104 is very low, and can be basically negligible. FIG. 40 shows schematic diagrams of current and electric field distribution of the transmission line 104 when the transmission line 104 is excited.

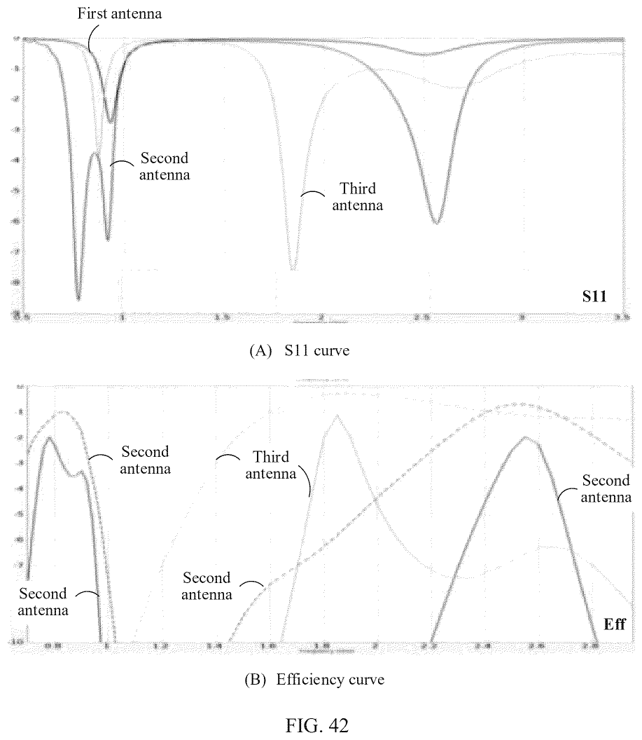

Based on the foregoing structure of the transmission line 104, one end of the transmission line 104 is connected close to a ground end of a first IFA radiator, and the other end is in an open state (as shown in (A) in FIG. 41). In this case, a length of the first IFA radiator is approximately ¼ of a dielectric wavelength corresponding to a first resonance frequency of the antenna. In some embodiments, the first IFA radiator operates in a low frequency band. In some embodiments, one end of the transmission line 104 is connected close to an open end of a second CRLH radiator, and the other end is directly grounded (as shown in (B) in FIG. 41). In this case, a length of the second CRLH radiator is approximately ¼ of a dielectric wavelength corresponding to a second resonance frequency of the antenna. In some embodiments, the second CRLH radiator operates in a medium frequency band. By using the structure shown in FIG. 38 as a first antenna, the structure shown in (A) in FIG. 41 as a second antenna, and the structure shown in (B) in FIG. 41 as a third antenna, (A) in FIG. 42 and (B) in FIG. 42 respectively show diagrams of S11 curves and efficiency of the three types of antennas. It can be found that the structure of the transmission line 104 can implement mode extension for an IFA radiator and a CRLH radiator, thereby greatly improving an efficiency bandwidth.

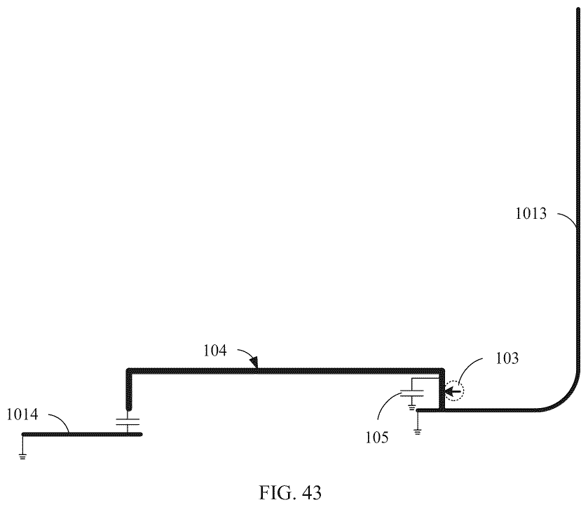

FIG. 43 shows a schematic diagram in which one end of the transmission line 104 is connected to a first radiator 1013 and is connected close to a ground end of the first radiator 1013, and the other end of the transmission line 104 is connected to a second radiator 1014 and is connected close to an open end of the second radiator 1014 by using a capacitor. In an embodiment, the first radiator 1013 may be an IFA radiator, and the second radiator 1014 may be a CRLH radiator. In the example shown in FIG. 43, an electrical length of the first radiator 1013 is approximately between ⅛ and ⅜ of a dielectric wavelength corresponding to a first resonance frequency of an antenna. In an embodiment, the first resonance frequency is a frequency in a low frequency band, and a physical length of the first radiator 1013 may be between 50 mm and 75 mm, for example, 63 mm. An electrical length of the second radiator 1014 is between ⅛ and ⅜ of a dielectric wavelength corresponding to a second resonance frequency of an antenna. In an embodiment, the second resonance frequency is a frequency in a medium frequency band, and a physical length of the second radiator 1014 may be between 12 mm and 35 mm, for example, 14.56 mm. The transmission line 104 uses a microstrip structure, and an electrical length of the transmission line 104 corresponds to approximately ¼ of a wavelength of a third resonance frequency. In an embodiment, the third resonance frequency is a frequency in a low frequency band, and a physical length of the transmission line is approximately between 30 mm and 50 mm, for example, 38 mm. In an embodiment, there is a slot between two ends that are of the first radiator 1013 and the second radiator 1014 and that are close to each other, and a width of the slot may be within 3 mm. For example, in some embodiments, the width may be within 2 mm, for example, approximately 1 mm. The slot may be filled with a non-conductive material. In an embodiment, the two ends that are of the first radiator 1013 and the second radiator 1014 and that are close to each other may be a ground end of the first radiator 1013 and a ground end or an open end of the second radiator 1014, or may be an open end of the first radiator 1013 and aground end or an open end of the second radiator 1014.

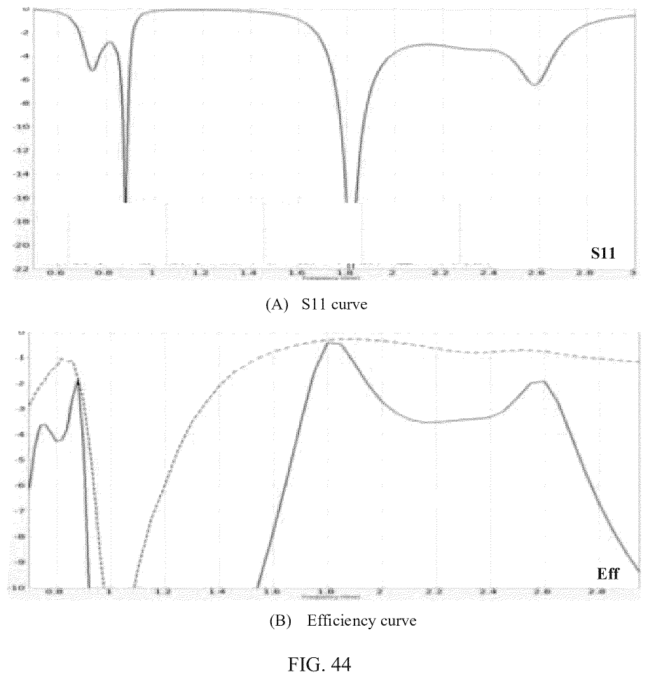

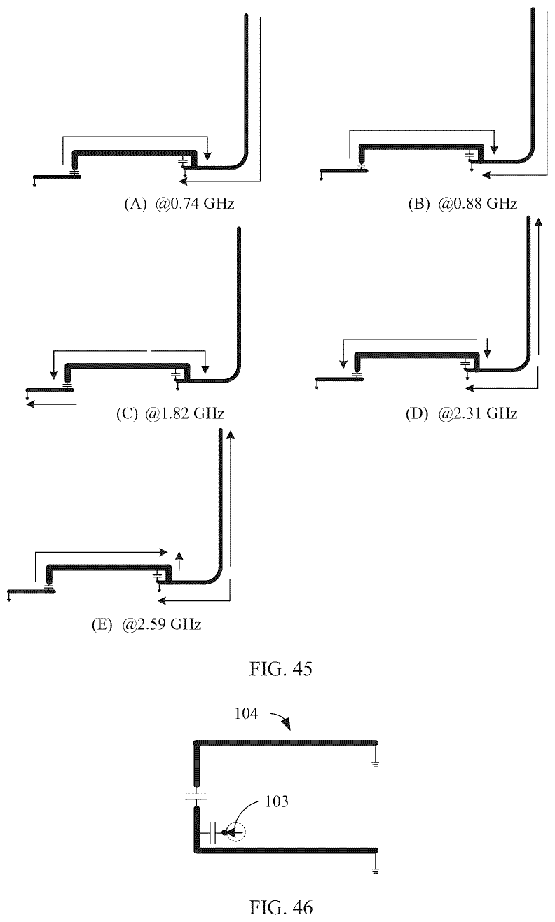

The antenna shown in FIG. 43 can implement coverage of five resonance frequencies in a full frequency band. A reflection coefficient S11 and an efficiency curve are shown in (A) in FIG. 44 and (B) in FIG. 44, and a diagram of current direction of each mode is shown in (A) in FIG. 45 to (E) in FIG. 45. As shown in FIG. 44, the two resonance frequencies in a low frequency band of the antenna are mainly implemented by a low frequency resonance frequency of the first radiator 1013 and a low frequency resonance frequency (corresponding to ¼ of a dielectric wavelength) of the transmission line 104, and the three resonance frequencies in a medium and high frequency band are mainly implemented by high frequency resonance frequencies of the second radiator 1014 and the first radiator 1013, and a high frequency resonance frequency (corresponding to ¾ of a dielectric wavelength) of the transmission line 104. Compared with a case of a single radiator, efficiency and a bandwidth of the antenna structure shown in FIG. 43 are multiplied.

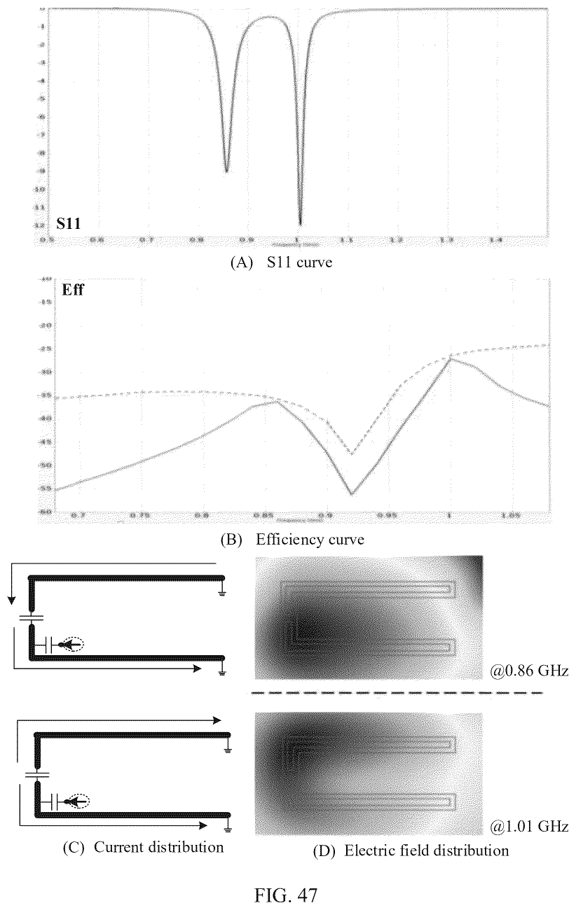

With reference to the accompanying drawings, the foregoing describes different embodiments in which the transmission line 104 is implemented by using a continuous microstrip. For an embodiment in which both two ends of the transmission line 104 are grounded, the transmission line 104 may use a structure in which a slot is disposed in the middle. That is, the transmission line 104 includes two separate sections, and a capacitor is disposed between the two separate sections, as shown in FIG. 46. A microstrip is designed on upper and lower surfaces of a PCB, and design parameters of the microstrip are similar to the design parameters of the microstrip mentioned above. Similar to a feeding manner of a slot antenna, feeding is performed near the slot, and two modes of the transmission line 104 may be excited. In an embodiment, a capacitor is connected in series for feeding near the slot, and operating frequency bands of the two modes that are of the transmission line 104 and that are excited are low frequency bands. A reflection coefficient S11, efficiency, and current and electric field distribution of the embodiment shown in FIG. 46 are respectively shown in (A) in FIG. 47 to (D) in FIG. 47. Because the transmission line 104 is in a closed environment, radiation efficiency of the transmission line 104 is very low.

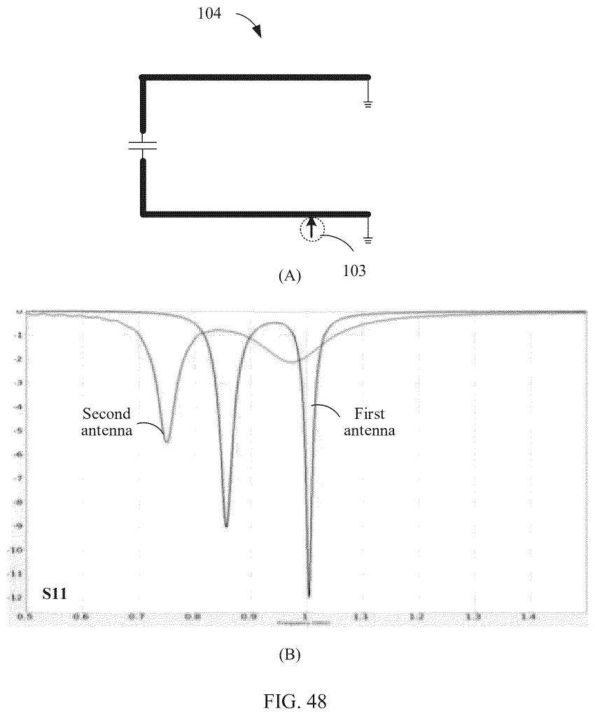

By using the antenna shown in FIG. 46 as a first antenna, the antenna shown in (A) in FIG. 48 as a second antenna, (B) in FIG. 48 shows changes in S11 curves of the two types of antennas. It can be learned that, similar to a design of the slot antenna, a capacitor is connected in series at an open end of the transmission line 104, and a feed point is moved to a position close to a ground point (for example, a current strength region) for direct feeding, so that the two resonance frequencies excited can be reduced.

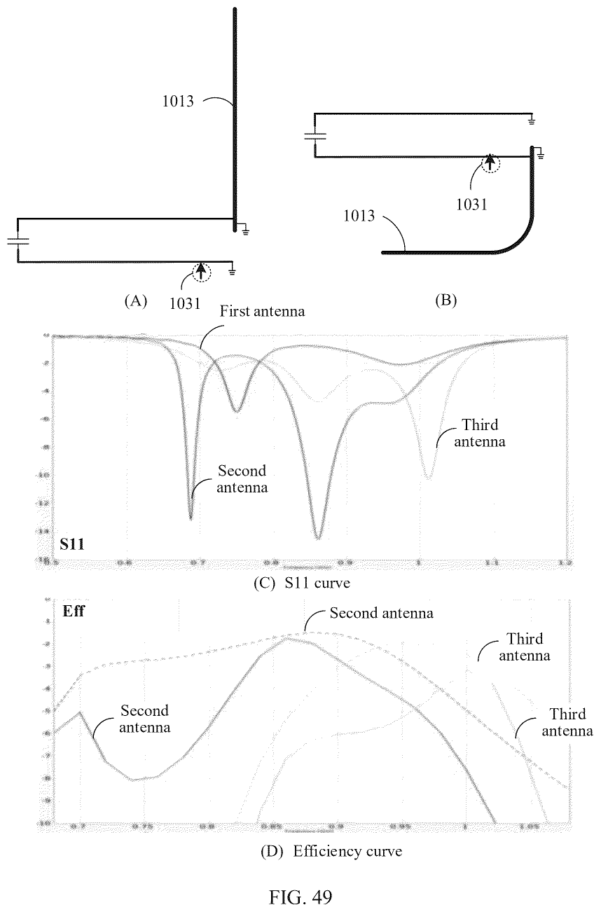

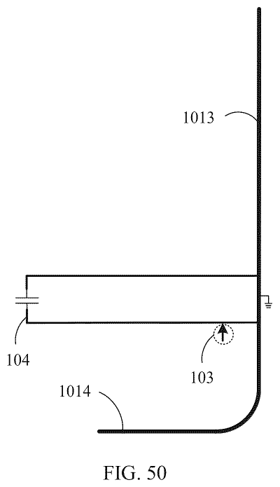

Based on a structure of the transmission line 104 shown in (A) in FIG. 48, one end of the transmission line 104 is connected close to a ground end of a low frequency IFA radiator, and the other end is directly grounded (as shown in (A) in FIG. 49). In this case, a length of the radiator is ¼ of a dielectric wavelength corresponding to a resonance frequency of the antenna. In some alternative embodiments, one end of the transmission line 104 is connected close to a ground end of a low frequency IFA radiator, and the other end is directly grounded (as shown in (B) in FIG. 49). In this case, a length of the radiator is ¼ of a dielectric wavelength corresponding to a resonance frequency of the antenna. By using the structure shown in (A) in FIG. 48 as a first antenna, the structure shown in (A) in FIG. 49 as a second antenna, and the structure shown in (B) in FIG. 49 as a third antenna, (C) in FIG. 49 and (D) in FIG. 49 respectively show diagrams of S11 curves and efficiency of the three types of antennas. It can be found that an efficiency bandwidth of the radiator is greatly improved by using the structure of the transmission line 104 shown in (A) in FIG. 48.

FIG. 50 shows a schematic diagram in which two ends of the transmission line 104 are respectively connected to two low frequency radiators (referred to as a first radiator 1013 and a second radiator 1014 below), and are connected close to ground ends of the first radiator 1013 and the second radiator 1014, where the two radiators form a T antenna structure. In the example shown in FIG. 50, electrical lengths of the first radiator 1013 and the second radiator 1014 are approximately between ⅛ and ⅜ of a dielectric wavelength corresponding to a low frequency resonance frequency of an antenna. For example, physical lengths of the first radiator 1013 and the second radiator 1014 may be between 45 mm and 70 mm, for example, 54 mm. The transmission line 104 uses a microstrip structure, and a total electrical length of two sections of the transmission line 104 corresponds to approximately ½ of a wavelength of a low frequency resonance frequency, and a physical length of the two sections is approximately between 65 mm and 85 mm, for example, 75 mm. A slot may be disposed between each of the first radiator 1013 and the second radiator 1014 and another part of the side frame, and a width of the slot may be within 3 mm. For example, in some embodiments, the width may be within 2 mm, for example, approximately 1 mm. The slot may be filled with a non-conductive material.

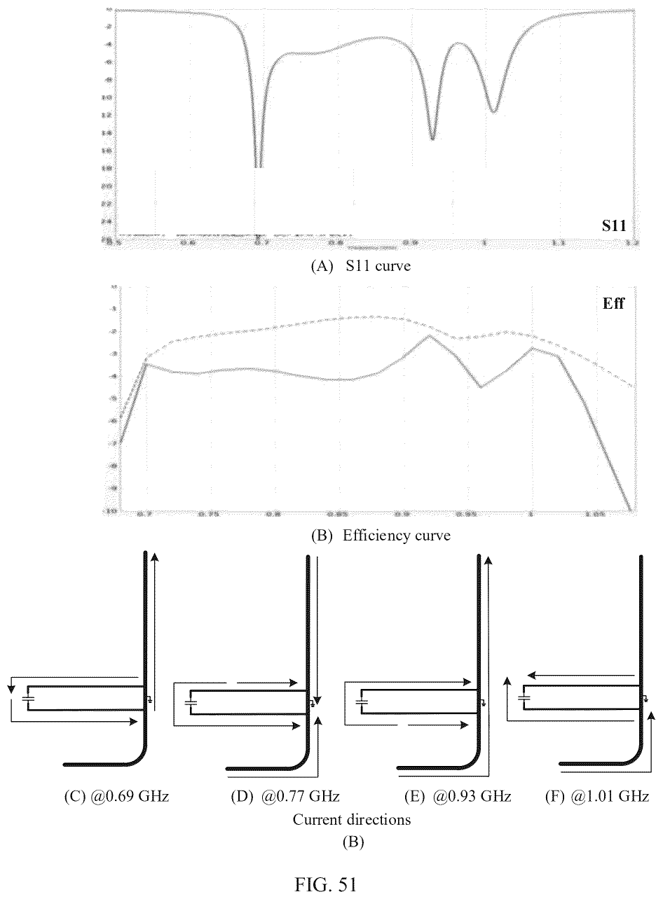

In this case, based on the foregoing analysis, the antenna in this arrangement can excite four modes in a low frequency band, to improve a bandwidth of the low frequency band. A reflection coefficient S11 and an efficiency curve of the antenna are respectively shown in (A) in FIG. 51 and (B) in FIG. 51, and a diagram of current direction of each mode is shown in (C) in FIG. 51 to (F) in FIG. 51. As shown in FIG. 51, four resonance frequencies in a low frequency band of the antenna are mainly implemented by two modes of the radiators and two modes of the transmission line 104. Compared with a single radiator, an efficiency bandwidth is significantly increased.

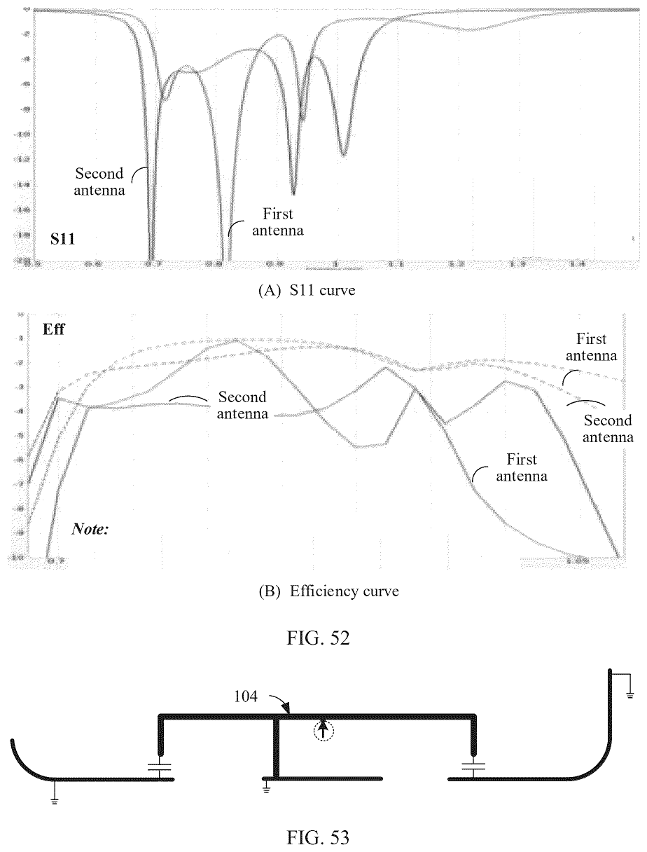

In some embodiments, the transmission line 104 may alternatively be in another form. In an embodiment, the transmission line 104 may be changed from a microstrip form to a support wiring. In the antenna shown in FIG. 50, by using an antenna formed by the transmission line 104 as a support wiring as a first antenna, and an antenna formed by the transmission line 104 as a microstrip as a second antenna, (A) in FIG. 52 and (B) in FIG. 52 show S11 curves and efficiency curves of the two types of antennas. It can be learned from (A) in FIG. 52 and (B) in FIG. 52 that when the transmission line 104 is the support wiring, a height of the transmission line 104 increases, and radiation efficiency is improved. After the transmission line 104 is connected to a radiator, radiation efficiency of an antenna can be further improved.

Certainly, it should be understood that the transmission line and the radiator mentioned in the foregoing embodiments may be made of any proper conductive material. In some embodiments, the transmission line and the radiator may alternatively be integrated. For example, the transmission line and the radiator may be designed by using a laser-direct-structuring (laser-direct-structuring, LDS) technology and directly disposed on a side frame or a support of an electronic device, thereby further improving integration. The foregoing mainly describes a case in which the transmission line is coupled to two radiators to improve antenna performance. It should be understood that this is merely an example, and is not intended to limit the protection scope of the present disclosure. In some alternative embodiments, the transmission line may be further coupled to more radiators, to further improve a bandwidth and efficiency of the antenna. For example, FIG. 53 shows an embodiment in which the transmission line is coupled to three radiators to extend a bandwidth and efficiency of the antenna.

It can be learned that the transmission line is disposed, so that a transmission line mode and a radiator mode can be superimposed, thereby improving efficiency and a bandwidth of the antenna. The foregoing embodiments may be considered as embodiments of a single antenna. A single feeding point disposed in a structure of a transmission line feeds two or more radiators that are spaced or electrically connected, to implement a distributed feeding antenna structure. The distributed feed antenna structure has characteristics of multi-mode and a wide band. In an embodiment, a coupling point (or a feeding point) at which a feeding unit of an antenna structure is coupled to a transmission line deviates from a midpoint of the transmission line, that is, an asymmetric feeding design is used. In an embodiment, the first end of the transmission line is coupled to the ground end of the first radiator, and the second end is grounded or coupled to the ground end of the second radiator. The coupling point (or the feeding point) at which the feeding unit is coupled to the transmission line is located close to the first end or the second end. In an embodiment, the first end of the transmission line is coupled to the open end of the first radiator, and the second end is open or coupled to the open end of the second radiator. The coupling point (or the feeding point) at which the feeding unit is coupled to the transmission line is located close to the midpoint of the transmission line. In an embodiment, the first end of the transmission line is coupled to the ground end of the first radiator, and the second end is open or coupled to the open end of the second radiator. The coupling point (or the feeding point) at which the feeding unit is coupled to the transmission line is located close to the first end. In embodiments of this application, that the coupling point (or the feeding point) between the feeding unit and the transmission line is “located close to a midpoint of the first end/second end/transmission line” should be understood as a distance within 5 mm or a distance within 3 mm away from the coupling point to the midpoint of the first end/second end/transmission line.

Based on the foregoing content, an embodiment of this application further provides an antenna. The antenna is based on an asymmetric feeding design, to implement a multi-mode broadband antenna, and can implement an antenna pair with high isolation. It should be understood that any one of the foregoing embodiments of a single antenna may be applied to one antenna structure in an antenna pair, and a single antenna split from any one of the following embodiments of an antenna pair may also be considered as an embodiment of a single antenna.

The following describes an example embodiment of an antenna 100 in this application with reference to the accompanying drawings. FIG. 54 shows an example structure of the antenna 100. As shown in FIG. 54, generally, the antenna 100 according to this embodiment of this application includes a radiator pair 101, at least one transmission line, and a feeding unit. The radiator pair 101 includes two radiators, that is, a first radiator 1013 and a second radiator 1014. Each radiator includes aground end 1011 and an open end 1012. Each radiator in the radiator pair 101 is grounded at the ground end 1011, and the radiator is not electrically connected to another radiator at the open end 1012. In some embodiments, corresponding to the foregoing described case in which the side frame of the electronic device is at least partially made of a conductive material, each radiator in the radiator pair 101 may include a continuous section of the side frame. This may include two cases. One case is that the first radiator 1013 and the second radiator 1014 in the radiator pair 101 are connected to each other and include a continuous section of the side frame. The other case is that the first radiator 1013 and the second radiator 1014 in the radiator pair 101 each include a continuous section of the side frame, but the sections in which the first radiator 1013 and the second radiator 1014 are located are separated. The separation herein may mean that two conductive sections are isolated by using a non-conductive material or mean that two conductive sections are connected by using another part of the side frame, and therefore, ground ends 1011 of the two conductive sections are separated; or mean that two conductive sections of the first radiator 1013 and the second radiator 1014 include both a non-conductive material and another part of the side frame. These cases will be further described below.

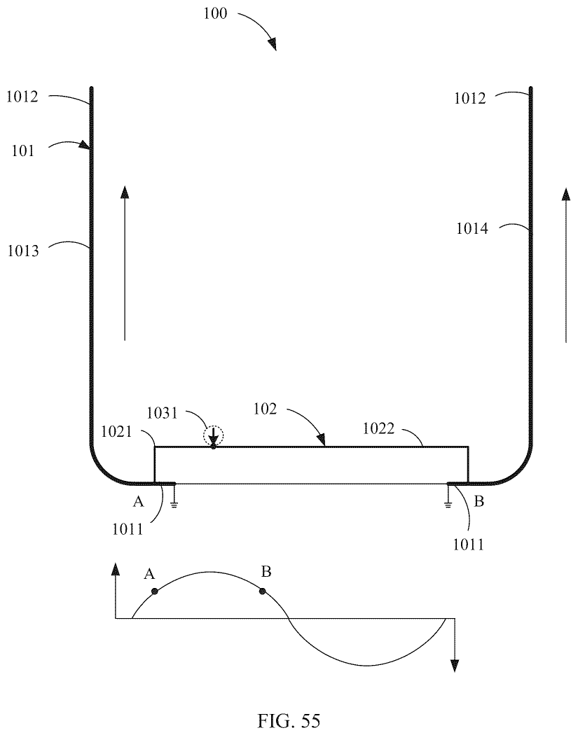

The feeding unit is coupled to the radiator pair 101 through the at least one transmission line. Specifically, each transmission line includes two sections of unequal equivalent lengths, for example, two sections of unequal physical lengths. In the following, an inventive concept according to the present disclosure is described mainly by using a physical length of each transmission line as an example. In addition to the physical length, the equivalent length may be further determined by using at least one of the following, a capacitor or an inductor disposed between a corresponding transmission line and a radiator pair, a phase shifter disposed on a corresponding transmission line, and a position at which a corresponding transmission line is coupled to the radiator pair. This will be further described below. The “length” mentioned in this specification usually means the physical length. The feeding unit is coupled to the first radiator 1013 and the second radiator 1014 respectively through the two sections, as shown in FIG. 54. In the following, the two sections will be respectively referred to as a first section 1021 and a second section 1022. Lengths of the first section 1021 and the second section 1022 are different, and therefore excitation currents provided by the feeding unit have a phase difference when the excitation currents are transmitted to the first radiator 1013 and the second radiator 1014. In some embodiments, a difference between the lengths of the two sections may be between ⅛ and ⅜ of a dielectric wavelength, for example, approximately ¼ of a dielectric wavelength. For example, for a frequency band whose resonance frequency ranges from 1920 MHz to 1980 MHz, a dielectric wavelength corresponding to a center frequency 1955 MHz of the frequency band is 15 cm. Therefore, it is obtained through calculation that in some embodiments, the difference between the lengths of the two sections may be between 1 cm and 7 cm. In some alternative embodiments, a difference between lengths of two sections of a transmission line may be less than ⅛ or less. These cases will be further described below. In addition, it should be further noted that a range mentioned in this specification includes values of endpoints. For example, that a difference D between lengths may be between 1 cm and 7 cm indicates that 1 cm≤D≤7 cm. Other ranges of proportions and/or angles are similar. Based on an asymmetrically fed radiator pair 101, the excitation currents respectively reach a feeding point A and a feeding point B through the first section 1021 and the second section 1022 and have a phase difference Φ. The phase difference is within a range of 90°±45°. For example, in some embodiments, the phase difference of the excitation currents obtained when the excitation currents respectively reach the feeding point A and the feeding point B through the first section 1021 and the second section 1022 is within a range of 90°±30°. FIG. 55 shows that a feeding part is separately coupled to the radiator pair 101 through a first section 1021 and a second section 1022 of a transmission line. A length of the transmission line is an odd multiple of ½ of a dielectric wavelength, for example, ½ of a dielectric wavelength. A difference between equivalent lengths of the first section 1021 and the second section 1022 is ¼ of a dielectric wavelength. In the case shown in FIG. 55, the feeding part can implement equal-amplitude codirectional currents at the point A and the point B. In an embodiment, currents excited by the feeding part on the radiator pair 101 are codirectional.

In an embodiment, that the length of the transmission line is an odd multiple of ½ of a dielectric wavelength may be understood as that the length of the transmission line is within a range of [the odd multiple of ½ of a dielectric wavelength×(1±20%)]. In an embodiment, that the difference between the lengths of the first section 1021 and the second section 1022 is ¼ of a dielectric wavelength may be understood as that the difference between the lengths of the first section 1021 and the second section 1022 is within a range of [¼ of a dielectric wavelength×(1±10%)]. For the equivalent length, considering a capacitor, an inductor, or the like that is disposed on the transmission line, as mentioned above, a relationship between a physical length L and an equivalent length Le may satisfy (1−⅓)Le≤L≤(1+⅓)Le or (1−¼)Le≤L≤(1+¼)Le.

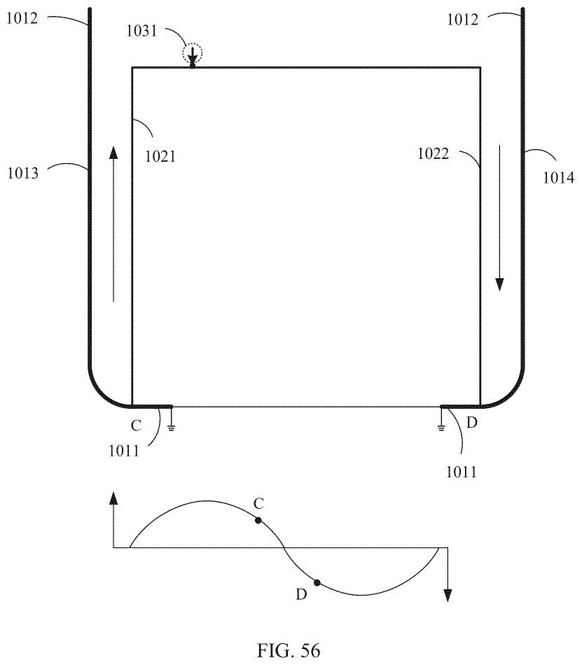

Similarly, FIG. 56 shows that a feeding part of the feeding unit is separately coupled, through a first section 1021 and a second section 1022 of a longer transmission line, to the radiator pair 101 through a feeding point C and a feeding point D. Based on the asymmetrically fed radiator pair 101, excitation currents respectively reach the feeding point C and the feeding point D through the first section 1021 and the second section 1022, and have a phase difference Φ. The phase difference is within a range of 90°±45°. For example, in some embodiments, the phase difference of the excitation currents obtained when the excitation currents respectively reach the feeding point C and the point D through the first section 1021 and the second section 1022 is within a range of 90°±30°. A length of the transmission line is an even multiple of ½ of a dielectric wavelength, for example, 1-fold of a dielectric wavelength. A difference between lengths of the first section 1021 and the second section 1022 is ¼ of a dielectric wavelength. In the case shown in FIG. 56, the feeding part can implement equal-amplitude reverse current strength at the point C and the point D. In an embodiment, currents excited by the feeding part on the radiator pair 101 are reverse.

In an embodiment, that the length of the transmission line is an even multiple of ½ of a dielectric wavelength may be understood as that the length of the transmission line is within a range of (the even multiple of ½ of a dielectric wavelength×(1±20%)). In an embodiment, that the difference between the lengths of the first section 1021 and the second section 1022 is ¼ of a dielectric wavelength may be understood as that the difference between the lengths of the first section 1021 and the second section 1022 is within a range of (¼ of a dielectric wavelength×(1±10%)). For the equivalent length, considering a capacitor, an inductor, or the like that is disposed on the transmission line, as mentioned above, a relationship between a physical length L and an equivalent length Le may satisfy (1−⅓)Le≤L≤(1+⅓)Le or (1−¼)Le≤L≤(1+¼)Le.

FIG. 55 and FIG. 56 respectively show a case in which the feeding unit includes one feeding part and asymmetrically feeds the radiator pair 101 through one transmission line. The lengths of the first section 1021 and the second section 1022 are unequal, for example, based on a phase difference needed on the radiator pair 101, the difference between the lengths of the first section 1021 and the second section 1022 may be set to another range from between ⅛ and ⅜ of a dielectric wavelength. In this manner, the antenna 100 can also separately control phase differences of currents on the radiator pair 101, thereby helping improve various types of performance of the antenna 100.

In the foregoing embodiment, with reference to FIG. 54 to FIG. 56, it is illustrated that by introducing a transmission lines having two sections of unequal physical lengths, a phase difference may be introduced at the feeding points at which the transmission line and the radiator pair are coupled, and therefore various types of performance of the antenna 100 may be improved. In some alternative embodiments, in addition to unequal physical lengths, equivalent lengths of the sections or the transmission line may be ensured to be unequal in another appropriate manner, to implement the phase difference between the feeding points. In such an embodiment, the antenna also includes a radiator pair, at least one transmission line, and a feeding unit. The at least one transmission line includes two sections. The feeding unit is separately coupled to a first feeding point of a first radiator and a second feeding point of a second radiator through the two sections. Equivalent lengths of the two sections are not equal, so that a phase difference that is of excitation currents provided by the feeding unit and that is between the first feeding point and the second feeding point is within a range of 90°±45°. For example, in some embodiments, the phase difference is within a range of 90°±30°. In some embodiments, in addition to physical lengths of the two sections, the equivalent lengths of the two sections may be determined by using at least one of the following: a capacitor or an inductor disposed between a corresponding section and a radiator pair, a phase shifter disposed on a corresponding section, and a position at which a corresponding section is coupled to the radiator pair.

In some embodiments, when the at least one transmission line includes a first transmission line and a second transmission line, two sections of each transmission line can ensure that a phase difference that is of excitation currents provided by the feeding unit and that is between feeding points is within a range of 90°±45°. When there are two transmission lines, a first feeding part performs feeding at a first feeding point and a second feeding point through the first transmission line, and a second feeding part performs feeding at a third feeding point and a fourth feeding point through the second transmission line. On a same radiator, a phase difference that is of a current and that is between the first feeding point and the adjacent third feeding point may be within a range of 180°±60°, for example, 180°±45°. Similarly, on the other radiator, a phase difference that is of a current and that is between the second feeding point and the adjacent fourth feeding point may be within a range of 180°±60°, for example, 180°±45°. This may be implemented by making equivalent lengths of the first transmission line and the second transmission line unequal. Similarly, in addition to the physical length of the transmission line, the equivalent length of the transmission line may be determined by using at least one of the following: a capacitor or an inductor disposed between a corresponding transmission line and a radiator pair, a phase shifter disposed on a corresponding transmission line, and a position at which a corresponding transmission line is coupled to the radiator pair. This will be further discussed below.

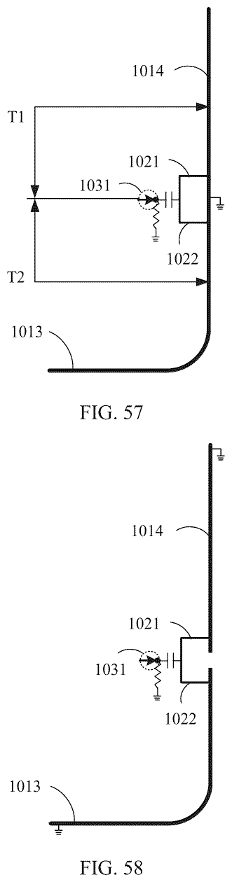

In the foregoing embodiments, the phase difference is introduced to the excitation currents at the feeding points to improve antenna performance. In some alternative embodiments, antenna performance may be improved by using a similar principle in some antenna structures in a manner of a matching circuit. As shown in FIG. 57, in some embodiments, the antenna may further include a matching circuit in addition to a radiator pair, a transmission line, and a feeding unit. In addition, a difference from the embodiment in FIG. 54 is that a first feeding part of the feeding unit is coupled to a roughly middle position of the transmission line. In other words, the transmission line includes two sections with a basically same length. In some embodiments, a total length of the transmission line may be less than or equal to 1/10 of a wavelength corresponding to a frequency band in which the antenna operates. In some embodiments, a difference (T2−T1) between the lengths of the two sections of the first transmission line satisfies 0 mm≤(T2−T1)≤8 mm, or a ratio T1/T2 of the lengths of the two sections of the first transmission line satisfies ½≤T1/T2≤2.

It can be learned that, in this embodiment, the transmission line has a shorter length, and the lengths of the two sections of the transmission line may be equal or have a specific deviation. In an embodiment in which a radiator pair includes a part of a side frame of an electronic device, such transmission line may be conformal to a radiator. Conformal indicates that the transmission line may be a part integrally formed with a conductor forming the radiator pair. For example, in some embodiments, a middle frame of the electronic device includes a side frame and a mechanical part extending from the side frame to the inside. The mechanical part may be integrally formed on the side frame, or integrally formed on another part of the middle frame, to extend to the inside of the electronic device. In this case, the transmission line may be implemented by a protruding part. In this manner, an existing structure in the side frame can be effectively used to improve an integration level of the electronic device. Certainly, it should be understood that this embodiment is merely an example, and is not intended to limit the protection scope of this application. The transmission line may alternatively be coupled to the radiator pair in any other suitable form, for example, implemented by a conductive member on a support.

The matching circuit is coupled between the feeding unit and the transmission line, and includes at least one capacitor and one inductor. In an embodiment, the capacitor and the inductor in the matching circuit form an LC resonant circuit. For example, FIG. 57 shows that the matching circuit may include a capacitor connected in series and an inductor connected in parallel between the feeding unit and the transmission line. In this manner, when no excitation current with a phase difference is introduced to the radiator pair, codirectional and/or reverse induced currents on the radiator pair may be implemented, to implement a plurality of operating modes of the antenna.

FIG. 57 shows a case in which the antenna including the matching circuit uses a T antenna structure, and two ground ends of the radiator pair of the antenna are shared. Certainly, it should be understood that, the ground ends of the T antenna structure of the antenna that uses the matching circuit may alternatively be separated by a specific distance. That is, a conductor is disposed between the two ground ends of the radiator pair. In some embodiments, the conductor disposed between the ground ends may be a part of the side frame of the electronic device or any other proper conductor. In some alternative embodiments, the antenna including the matching circuit may alternatively use a slot antenna structure, as shown in FIG. 58. In this case, an open end of a first radiator and an open end of a second radiator of the antenna are disposed opposite to each other and form a slot. In addition, in some embodiments, in addition to a first transmission line, the antenna including the matching circuit may further include a second transmission line and a second feeding part. The second transmission line may include two sections, and the second feeding part is coupled to the first radiator and the second radiator respectively through the two sections. This will be further described below.

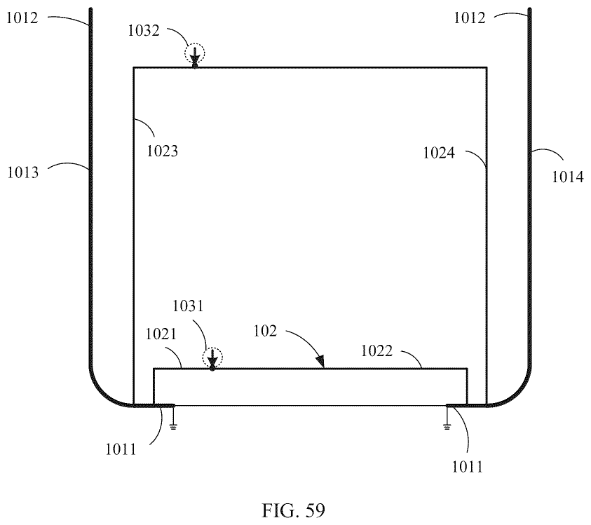

With reference to FIG. 54 to FIG. 58, the foregoing describes a case in which the feeding unit includes one feeding part (that is, the first feeding part). Certainly, it should be understood that the feeding unit in embodiments of this application may include more than one feeding part, as shown in FIG. 59. FIG. 59 shows a case in which two manners in FIG. 55 and FIG. 56 are combined. As shown in FIG. 59, in some embodiments, the feeding unit may include two feeding parts, that is, a first feeding part 1031 and a second feeding part 1032. Correspondingly, at least one transmission line includes two transmission lines, that is, a first transmission line and a second transmission line. The first feeding part 1031 is separately coupled to a first radiator 1013 and a second radiator 1014 through a first section 1021 and a second section 1022 of the first transmission line. The second feeding part 1032 is coupled to the first radiator 1013 and the second radiator 1014 respectively through a third section 1023 and a fourth section 1024 of the second transmission line.

In some embodiments, similar to the foregoing cases shown in FIG. 55 and FIG. 56, the two transmission lines have different equivalent lengths. For example, the equivalent length of the first transmission line may be an odd multiple of ½ of a first dielectric wavelength of a first frequency band in which the antenna 100 can generate a resonance, and the equivalent length of the second transmission line may be an even multiple of ½ of a second dielectric wavelength of a second frequency band in which the antenna 100 can generate a resonance. In this case, the antenna 100 forms an antenna pair including a first antenna fed by the first feeding part 1031 and a second antenna fed by the second feeding part 1032. The first frequency band and the second frequency band may be frequency bands that at least partially overlap. For example, in some embodiments, the first frequency band and the second frequency band may be a same frequency band, that is, the first frequency band and the second frequency band completely overlap. In some alternative embodiments, the first frequency band and the second frequency band may partially overlap. For example, the first frequency band and the second frequency band are adjacent frequency bands, to implement wider coverage of a radiation frequency band. In some alternative embodiments, the first frequency band and the second frequency band may alternatively be two frequency bands that not overlap but are close to each other.

Similar to the cases analyzed in FIG. 55 and FIG. 56, when the first feeding part 1031 performs feeding, codirectional excitation currents can be excited on the radiator pair 101. When the second feeding part 1032 performs feeding, reverse excitation currents can be excited on the radiator pair 101. Different directions of currents on a radiator pair cause different radiation patterns. In this manner, high isolation of the antenna pair formed by the first antenna and the second antenna is implemented, and therefore, a frequency band range of the antenna 100 is extended and performance of the antenna 100 is improved.

When the first frequency band and the second frequency band are a same frequency band, the equivalent length of the first transmission line may be an odd multiple of ½ of a dielectric wavelength, and the equivalent length of the second transmission line may be an even multiple of ½ of a dielectric wavelength. This also means that a difference between the equivalent lengths of the two transmission lines is N-fold of ½ of a dielectric wavelength, where N is an integer greater than 0. However, it should be understood that, based on factors such as different frequency bands, the difference between the equivalent lengths of the two transmission lines is between ¼ and ¾ of a dielectric wavelength, or between (¼ to ¾)*N-fold of a dielectric wavelength, so that high isolation of the antenna pair can be implemented, and performance of the antenna 100 is improved.

In some embodiments, a length of the first transmission line may be an odd multiple of ½ of a first dielectric wavelength corresponding to a first resonance generated by the antenna. Certainly, considering factors such as a manufacturing process and impedance matching, an actual length of the first transmission line may be within a range of ±20% of an odd multiple of ½ of the first dielectric wavelength (an odd multiple of ½ of a dielectric wavelength×(1±20%)). Similarly, a length of the second transmission line may be an even multiple of ½ of a second dielectric wavelength corresponding to a second resonance generated by the antenna. Certainly, considering factors such as a manufacturing process and impedance matching, an actual length of the second transmission line may be within a range of ±20% of an even multiple of ½ of the second dielectric wavelength (an even multiple of ½ of a dielectric wavelength×(1±20%)). Certainly, in some embodiments, the first resonance and the second resonance may partially overlap or may completely not overlap.

In some embodiments, the lengths of the first transmission line and the second transmission line may also be determined by using a method different from the foregoing method. Specifically, in some embodiments, the resonance generated by the antenna may include at least a first resonance and a second resonance. An average value of a center frequency of the first resonance and a center frequency of the second resonance is determined as a first frequency. The length of the first transmission line may be an odd multiple of ½ of a dielectric wavelength corresponding to the first frequency, and the length of the second transmission line may be an even multiple of ½ of a dielectric wavelength corresponding to the first frequency. Certainly, considering factors such as a manufacturing process and impedance matching, the length of the first transmission line may be within a range of ±20% of the odd multiple of ½ of a dielectric wavelength corresponding to the first frequency (the odd multiple of ½ of a dielectric wavelength×(1±20%)), and the length of the second transmission line may be within a range of ±20% of the even multiple of ½ of a dielectric wavelength corresponding to the first frequency (the even multiple of ½ of a dielectric wavelength×(1±20%)).

The first resonance is in the first frequency band, and the second resonance is in the second frequency band. The first frequency band and the second frequency band may be a same operating frequency band or different operating frequency bands.

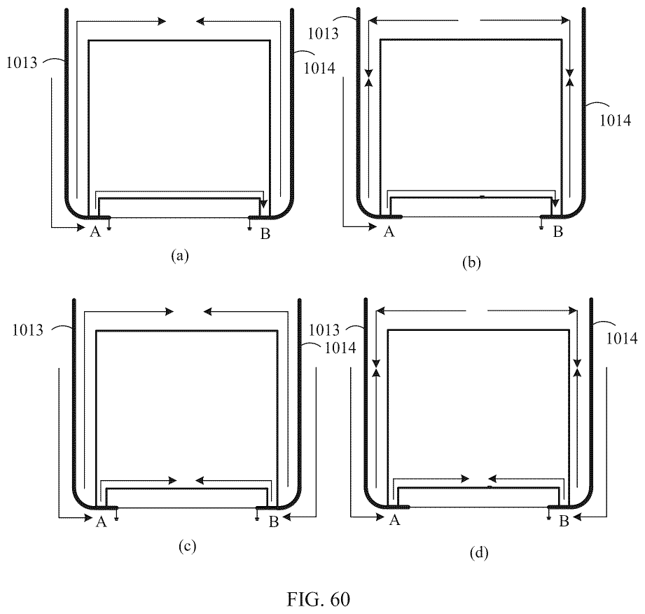

In an embodiment, in this design of asymmetrically fed antenna pair, a longer transmission line further has mode suppression effect on a shorter transmission line. As shown in (a) in FIG. 60 and (b) in FIG. 60, if a codirectional current is formed on the shorter transmission line, because a total length of the longer transmission line is increased by approximately ½ of a wavelength, regardless of a current path formed on the longer transmission line, the current path and the current that reaches a point B through the shorter transmission line are equal-amplitude reverse to each other and offset each other. Consequently, a current cannot be excited on the second radiator 1014, thereby suppressing an antenna mode when the codirectional current is formed on the shorter transmission line. Therefore, in an embodiment of this application, a reverse current is formed on the shorter transmission line. As shown in (c) in FIG. 60 and (d) in FIG. 60, regardless of a current path formed on the longer transmission line, the current path and the current that reaches a point B through the shorter transmission line are equal-amplitude codirectional to each other and superimposed, so that a current can be excited on the second radiator 1014.

FIG. 55 to FIG. 57, FIG. 59, and FIG. 60 respectively show cases in which both the first transmission line and/or the second transmission line are coupled close to the ground end 1011 of the radiator pair 101. For example, both the first transmission line and the second transmission line are coupled to a position that is not greater than 5 mm or not greater than 3 mm away from the ground end 1011. In some alternative embodiments, both the first transmission line and the second transmission line may be coupled close to the open end 1012 of the radiator pair 101, as shown in FIG. 58. For example, both the first transmission line and the second transmission line are coupled to a position that is not greater than 5 mm or not greater than 3 mm away from the open end 1012. In some embodiments, one end of each of the first transmission line and the second transmission line is coupled close to the open end 1012 of the first radiator 1013 in the radiator pair 101, and the other end is coupled close to the ground end 1011 of the second radiator 1014. These will be further described below.

Many variations may be made to the antenna described in the foregoing embodiments shown with reference to FIG. 55 to FIG. 59.

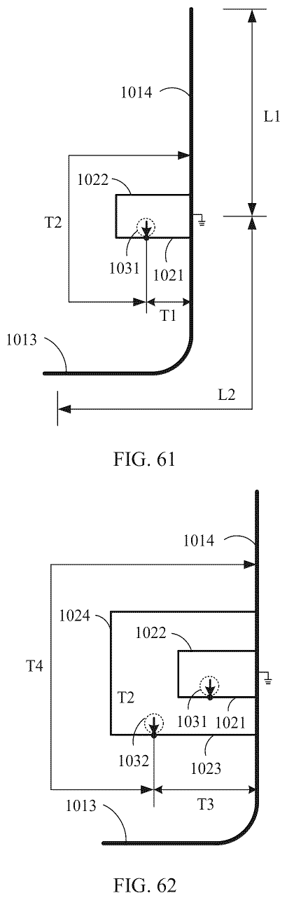

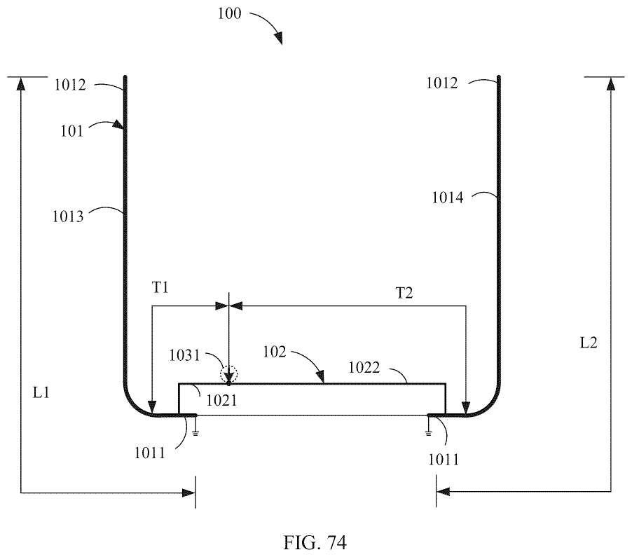

In some embodiments, a form of a radiator may be adjusted. The radiator pair shown in FIG. 61 to FIG. 73 may be in a form of a T antenna. A radiator pair in a T antenna form usually includes a continuous conductor, a ground end is disposed in a middle part of the conductor, and an open end is located at two ends of the conductor. The ground end may be shared by the radiator pair, or may be separated from each other (as shown in FIG. 71). FIG. 74 to FIG. 94 each show a form in which each radiator in the radiator pair may use the form of the IFA antenna mentioned above. FIG. 95 to FIG. 101 each show a form in which the radiator pair may use a slot antenna structure.

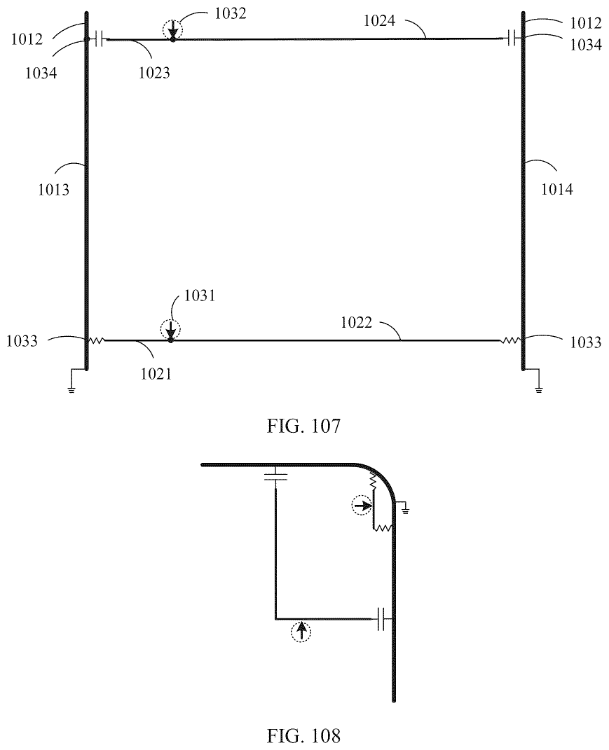

In some embodiments, a connection position between a transmission line and a radiator may have a plurality of variations. For example, FIG. 59 to FIG. 94 show that a coupling point (or a feeding point) between the transmission line and the radiator is located close to a ground end. For example, both the first transmission line and the second transmission line are coupled to a position that is not greater than 5 mm or not greater than 3 mm away from the ground end 1011. FIG. 95 to FIG. 101 show that a coupling point (or a feeding point) between the transmission line and the radiator may be close to an open end. For example, both the first transmission line and the second transmission line are coupled to a position that is not greater than 5 mm or not greater than 3 mm away from the open end 1012. In an embodiment, that the coupling point (or the feeding point) between the transmission line and the radiator is close to the open end may also be understood as a distance of greater than 5 mm or greater than 10 mm from the ground end. In addition, in some embodiments, one end of the first transmission line and one end of the second transmission line may be coupled to an open end of a radiator, and the other end of the first transmission line and the other end of the second transmission line may be coupled to a ground end of another radiator (as shown in FIG. 106). In some embodiments, two ends of the first transmission line are respectively coupled to a ground end of each of a first radiator and a second radiator, and two ends of the second transmission line are respectively coupled to an open end of each of the first radiator and the second radiator by using a capacitor, or are respectively coupled between a ground end and an open end of each of the first radiator and the second radiator by using a capacitor, as shown in FIG. 107 and FIG. 108.

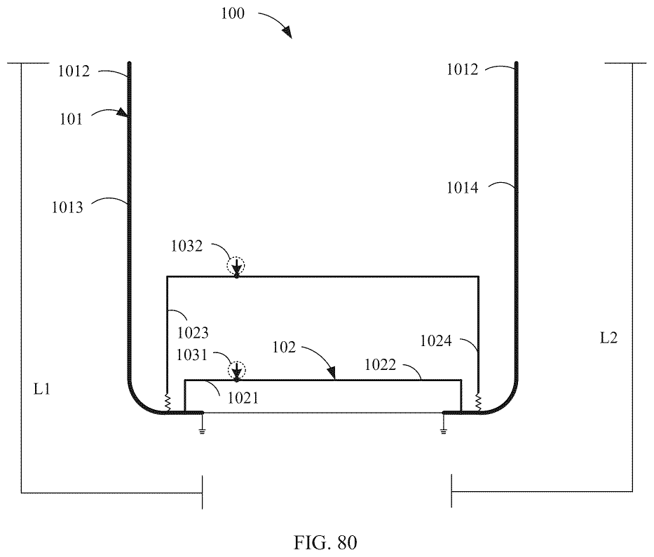

In some embodiments, a manner of connection between a transmission line and a radiator may have a plurality of variations. For example, FIG. 61 to FIG. 79 and FIG. 94 each show a case in which the transmission line is directly connected to the radiator by using a connecting piece such as a spring. FIG. 80 to FIG. 93 each show a case in which two ends (or any end) of one of transmission lines (or all the transmission lines) are connected to a radiator pair by using an inductor. FIG. 95 to FIG. 100 each show a case in which two ends (or any end) of one of transmission lines (or all the transmission lines) are connected to a radiator pair by using a capacitor.

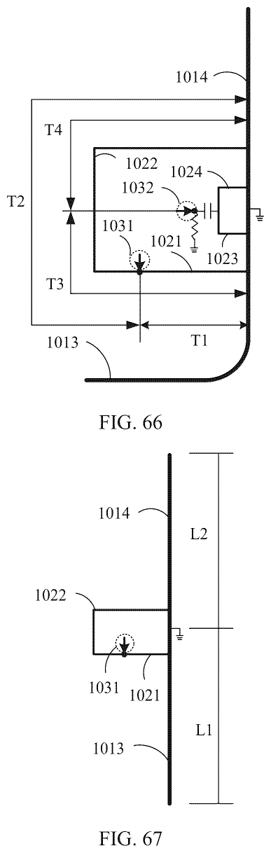

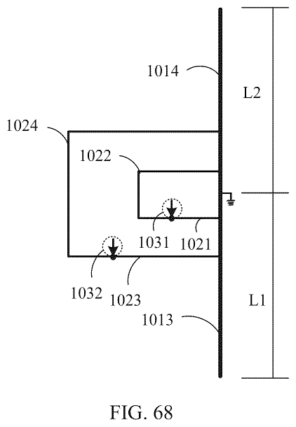

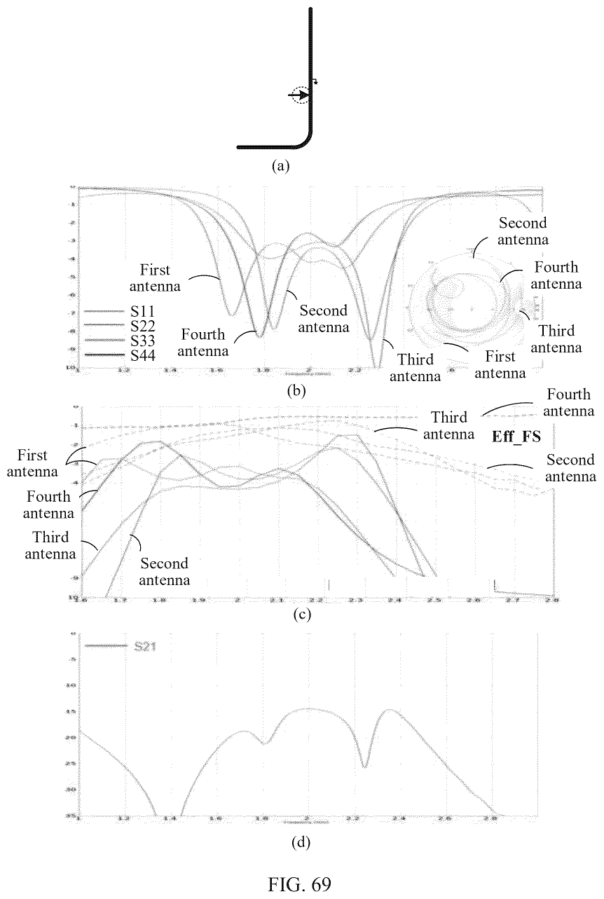

In some embodiments, a manner of connection between a feeding unit and a transmission line may have a plurality of variations. For example, in some embodiments, the feeding unit may be directly connected to the transmission line. In some embodiments, the feeding unit may be alternatively connected to the transmission line by using a matching circuit (for example, a case of the second feeding part 1032 and the second transmission line in FIG. 66).

The following mainly describes some example deformations and a combination of the deformations of the antenna according to embodiments of this application with reference to FIG. 61 to FIG. 109. It should be understood that the following describes a concept according to this application by using some antenna structures as examples. Embodiments shown in the following do not exhaust all possible variations and combinations of variations. There may further be different variations or combinations of various variations, which are not described in the following. As mentioned above, in an application according to embodiments of this application, a radiator pair of the antenna 100 uses a T antenna structure of a ½ wavelength. This may include cases in which one feeding part, two feeding parts, four feeding parts, and even another quantity of feeding parts perform feeding. These cases may be considered as variations of the embodiment described in FIG. 57. FIG. 61 and FIG. 62 each show an example of an embodiment in which the antenna 100 uses the T antenna structure. As shown in FIG. 61 and FIG. 62, when the antenna 100 according to embodiments of this application uses the T antenna structure and is used as a low frequency antenna 100, in some embodiments, a radiator pair 101 is a part in a lower right corner of a metal side frame of an electronic device. Certainly, it should be understood that the radiator pair 101 may be disposed at any other proper position on the side frame. This is not limited in this application. A first radiator 1013 and a second radiator 1014 may form a continuous section of the side frame as a whole. In this case, a ground end 1011 of the radiator pair 101 may be shared. In some alternative embodiments, when the radiator pair of the antenna 100 according to embodiments of this application uses the T antenna structure, ground ends 1011 of the radiator pair 101 may alternatively be separated, and therefore may be considered as two inverted-F antenna structures. This will be further described below.

FIG. 61 and FIG. 62 each show an embodiment in which the antenna 100 that uses the T antenna structure operates in a low frequency band according to an embodiment of this application. Certainly, it should be understood that the antenna 100 shown in FIG. 61 and FIG. 62 may alternatively operate in a medium and high frequency band. This will be further described below. As shown in FIG. 61, in some embodiments, the antenna 100 may use one feeding part to feed the radiator pair 101 through a first transmission line. The feeding part feeds the radiator pair 101 through the first transmission line, and is separately connected to the radiator pair 101 at two sides of the ground end 1011 through asymmetric feeding. In some alternative embodiments, as shown in FIG. 62, the antenna 100 uses two feeding parts to feed the radiator pair 101. The first feeding part 1031 of the two feeding parts feeds the radiator pair 101 through the shorter first transmission line, and is separately connected to the radiator pair 101 at two sides of the ground end 1011 through asymmetric feeding. A second feeding part 1032 performs asymmetric feeding through a longer second transmission line, and a total length of the second transmission line is approximately ½ of a dielectric wavelength longer than a length of the first transmission line.

When the radiator pair 101 operates in a low frequency band of 0.8 GHz to 1.2 GHz, a total length of the radiator pair 101 may be between ¼ of a dielectric wavelength and ¾ of a dielectric wavelength, for example, between 90 mm and 130 mm, where a length of the first radiator 1013 and a length of the second radiator 1014 may be respectively between 40 mm and 70 mm. For example, a length L1 of the first radiator 1013 may be approximately 50 mm, and a length L2 of the second radiator 1014 may be approximately 55 mm, where the second radiator 1014 includes a corner part of the side frame. In this case, the total length of the radiator pair 101 is 105 mm. A slot may be disposed between two open ends of the radiator pair 101 and another part of the side frame, and a width of the slot may be within 3 mm. For example, in some embodiments, the width may be 2 mm, 1 mm, or the like. The slot may be filled with a non-conductive material.

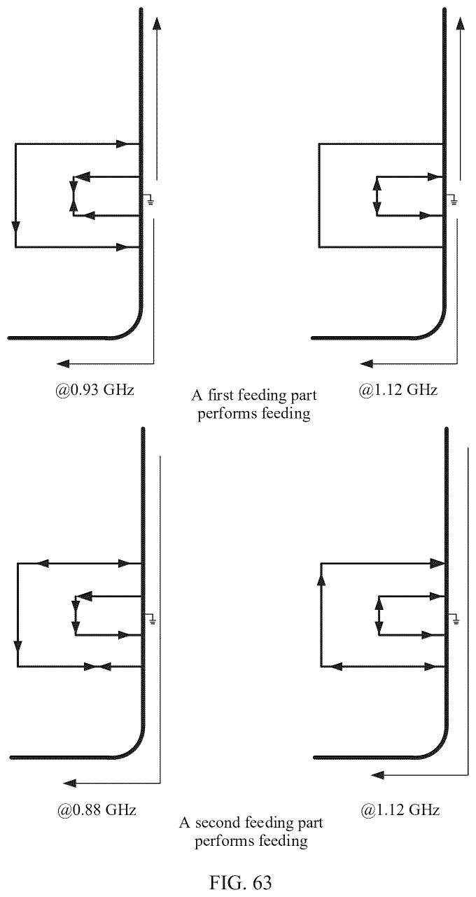

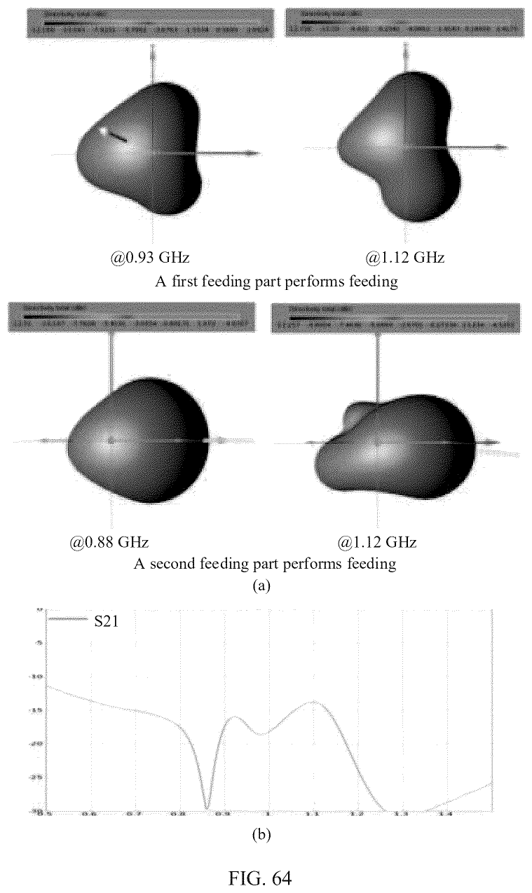

FIG. 63 shows current distribution on a transmission line and a radiator when the first feeding part 1031 and the second feeding part 1032 perform feeding. In FIG. 64, (a) shows a directivity pattern of the antenna 100 when the first feeding part 1031 and the second feeding part 1032 perform feeding, and (b) shows a diagram of an S21 curve of the antenna. It can be learned from FIG. 63 and FIG. 64 that, regardless of whether feeding is performed by the first feeding part 1031 or the second feeding part 1032, a first mode and a second mode of the antenna 100 may be excited at a low frequency band, and intra-frequency band isolation of the first mode and the second mode may reach more than 14 dB, as shown in (b) in FIG. 64.

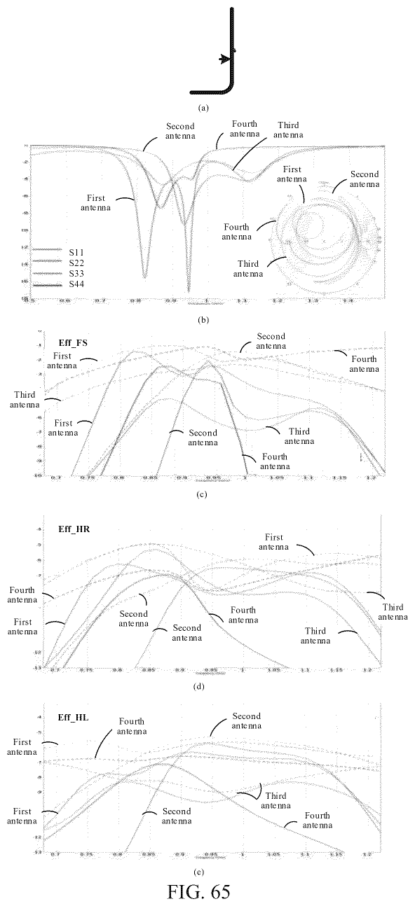

For comparison, by using the case shown in FIG. 61 as a first antenna, the antenna 100 in FIG. 62 when the first feeding part 1031 performs feeding as a second antenna, the antenna 100 in FIG. 62 when the second feeding part 1032 performs feeding as a third antenna, and the antenna 100 shown in (a) in FIG. 65 as a fourth antenna, (b) in FIG. 65 separately shows a diagram of S11 curves of the four types of antennas. It can be learned that both the second antenna and the third antenna have two operating modes, and high isolation between an antenna pair is implemented. However, the first antenna may have three operating modes. (c) in FIG. 65 shows a diagram of efficiency of each antenna 100 in a free space scenario. (d) in FIG. 65 shows a diagram of efficiency of each antenna 100 in a right-hand mode. (e) in FIG. 65 shows a diagram of efficiency of each antenna 100 in a left-hand mode. With reference to (c) in FIG. 65 to (e) in FIG. 65, it can be found that, in a free space mode and a handheld mode, an efficiency bandwidth of each of the first antenna and the second antenna is significantly improved compared to that of the fourth antenna.

For the first transmission line in FIG. 61, a ratio T1/T2 of lengths of a first section 1021 and a second section 1022 may satisfy ¼≤T1/T2≤½. Similarly, for the first transmission line and the second transmission line in FIG. 62, a ratio T1/T2 of lengths of a first section 1021 and a second section 1022 of the first transmission line may satisfy ¼≤T1/T2≤½, and a ratio T3/T4 of lengths of a third section 1023 and a fourth section 1024 of the second transmission line may satisfy ¼≤T3/T4≤½. When the antenna shown in FIG. 61 operates in a low frequency band like below 1.2 GHz, a difference between the lengths of the first section 1021 and the second section 1022 may be between 25 mm and 45 mm. When the antenna operates in a medium and high frequency band like below 3 GHz, a difference between the lengths of the first section and the second section may be between 12 mm and 22 mm. When the antenna shown in FIG. 62 operates in a low frequency band like below 1.2 GHz, a difference between lengths of the first transmission line and the second transmission line may be between 60 mm and 80 mm. When the antenna operates in a medium and high frequency band like below 3 GHz, a difference between lengths of the first transmission line and the second transmission line may be between 30 mm and 40 mm. The length mentioned above is an equivalent length of a transmission line existing when there is only one transmission line between the feeding unit and the radiator pair. In addition to the transmission line, a capacitor, an inductor, a phase shifter, and the like may further be disposed between the feeding unit and the radiator pair. Therefore, an actual physical length of the transmission line may be within a range of +⅓ of the equivalent length (the equivalent length×(1±⅓)), or an actual physical length of the transmission line may be within a range of ±¼ of the equivalent length (the equivalent length×(1±¼)).

In addition, in some embodiments, the antenna pair of this T antenna structure may alternatively be connected for feeding through a shorter transmission line. This embodiment is equivalent to a variation of the case shown in FIG. 57. As shown in FIG. 66, a total equivalent length of the first transmission line fed by the first feeding part 1031 is approximately ½ of a dielectric wavelength (corresponding to an odd multiple of ½ of a dielectric wavelength), and an equivalent length of the second transmission line fed by the second feeding part 1032 is only approximately 1/10 of a dielectric wavelength or even shorter. In this case, a feeding end of the second feeding part 1032 implements a dual second mode by using a broadband matching circuit, and the first feeding part 1031 forms a dual first mode by using a differential design of asymmetric feeding. Implementation effect thereof is similar to that in the foregoing embodiment.

For the two transmission lines in FIG. 66, a ratio T1/T2 of lengths of a first section 1021 and a second section 1022 of the first transmission line may satisfy ¼≤T1/T2≤½. Similarly, a ratio T3/T4 of lengths of a third section 1023 and a fourth section 1024 of the second transmission line may satisfy ½≤T3/T4≤2. When the antenna shown in FIG. 66 operates in a low frequency band like below 1.2 GHz, a difference between lengths of the first transmission line and the second transmission line may be between 50 mm and 65 mm. When the antenna operates in a medium and high frequency band like below 3 GHz, a difference between lengths of the first transmission line and the second transmission line may be between 25 mm and 35 mm. The length mentioned above is an equivalent length of a transmission line existing when there is only one transmission line between the feeding unit and the radiator pair. In addition to the transmission line, a capacitor, an inductor, a phase shifter, and the like may further be disposed between the feeding unit and the radiator pair. Therefore, an actual physical length of the transmission line may be within a range of ±⅓ of the equivalent length (the equivalent length×(1±⅓)), or an actual physical length of the transmission line may be within a range of ±¼ of the equivalent length (the equivalent length×(1+¼)).

In the foregoing descriptions, with reference to FIG. 61 to FIG. 66, it is illustrated that when the antenna 100 according to embodiments of this application uses the T antenna structure and is used as a low frequency band antenna 100, isolation between an antenna pair can be significantly improved, and performance of the antenna 100 can be improved. When the radiator pair of the antenna 100 according to embodiments of this application uses the T antenna structure, the antenna 100 may alternatively be used as a medium and high frequency antenna 100. In this case, the antenna 100 may also use a structure similar to that in FIG. 61 to FIG. 63. In some alternative embodiments, considering factors such as antenna efficiency during hand holding, the radiator pair 101 may alternatively be disposed on a side edge of the side frame.

In this case, when the radiator pair 101 is applied to a medium and high frequency band of 1.85 GHz to 2.25 GHz, a total length of the radiator pair 101 may be between ¼ of a dielectric wavelength and ¾ of a dielectric wavelength, for example, between 30 mm and 55 mm, where a length of the first radiator 1013 and a length of the second radiator 1014 may be respectively between 15 mm and 30 mm. For example, a length L1 of the first radiator 1013 and a length of the second radiator 1014 may be the same, for example, 21 mm. In this case, the total length of the radiator pair 101 is 42 mm. A slot may be disposed between the radiator pair 101 and another part of the side frame, and a width of the slot may be within 3 mm. For example, in some embodiments, the width may be 2 mm, 1 mm, or the like. The slot may be filled with a non-conductive material.

For comparison, by using the case shown in FIG. 67 as a first antenna, the antenna 100 in FIG. 68 when the first feeding part 1031 performs feeding as a second antenna, the antenna 100 in FIG. 68 when the second feeding part 1032 performs feeding as a third antenna, and the antenna 100 shown in (a) in FIG. 69 as a fourth antenna, (b) in FIG. 69 separately shows a diagram of S11 curves of the four antennas 100, (c) in FIG. 69 separately shows a diagram of efficiency of each antenna 100 in a free space scenario, and (d) in FIG. 69 shows an S21 diagram between the second antenna and the third antenna. It can be learned that when the antenna 100 according to embodiments of this application is used as the medium and high frequency antenna, high isolation can be implemented between an antenna pair, and the isolation can reach more than 15 dB, as shown in (d) in FIG. 69, and a difference between efficiency of two antennas 100 is small. Table 1 is an SAR simulation table when the first antenna, the second antenna, the third antenna, and the fourth antenna operate in a medium and high frequency band of 1.85 GHz to 2.25 GHz. It can be learned from the table that, SAR values of the first antenna and the second antenna decrease by 1 to 1.5 dB compared to that of the fourth antenna.

TABLE 1

| | | First antenna | | | Second antenna | | Third antenna | | Fourth antenna | |
|---|---|---|---|---|---|---|---|---|---|---|
| Input power | Resonance | 1.65 GHz | 2 GHz | 2.15 GHz | 1.85 GHz | 2.25 GHz | 1.85 GHz | 2.25 GHz | 1.8 GHz | 2.1 GHz |
| 24 dBm | frequency | | | | | | | | | |
| Radiation efficiency | | −1.85 | −1.06 | −1.91 | −1.79 | −1.51 | −1.96 | −0.78 | −1.16 | −0.6 |
| FS system | Rear −5 mm | −2 | −2.38 | −2.84 | −1.92 | −1.65 | −4.56 | −2.69 | −1.29 | −2.03 |
| efficiency | Left −5 mm | −1.89 | −2.23 | −2.79 | −1.96 | −1.84 | −4.16 | −3.25 | −1.57 | −2.57 |
| Simulation | Rear −5 mm | 1.12 | 1.37 | 1.40 | 1.38 | 1.71 | 1.29 | 2.86 | 1.76 | 2.10 |
| SAR value | Left −5 mm | 1.21 | 1.12 | 1.33 | 1.24 | 1.63 | 1.77 | 3.18 | 1.69 | 2.08 |
| Normalized | FS | −5 | −5 | −5 | −5 | −5 | −5 | −5 | −5 | −5 |
| efficiency | normalization | | | | | | | | | |
| Normalized | Rear −5 mm | 0.56 | 0.75 | 0.85 | 0.68 | 0.79 | 1.17 | 1.68 | 0.75 | 1.06 |
| SAR value | Left −5 mm | 0.59 | 0.59 | 0.80 | 0.62 | 0.79 | 1.46 | 2.13 | 0.77 | 1.19 |

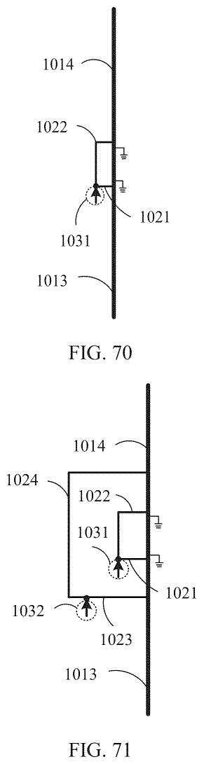

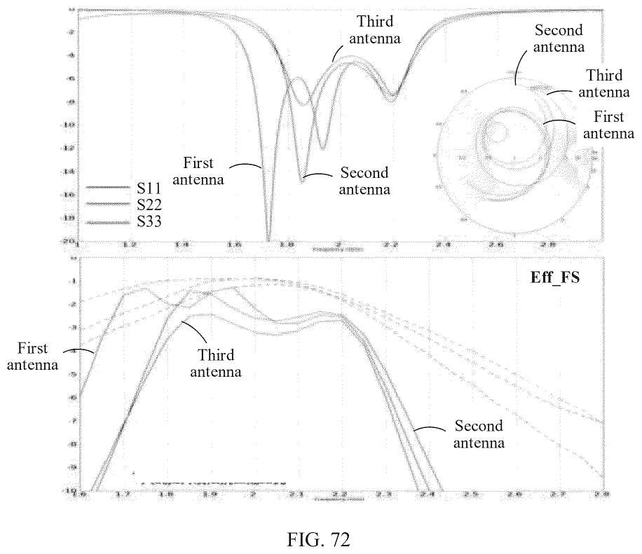

In some embodiments, a distance between radiators above and below a ground end 1011 of the antenna 100 according to embodiments of this application that uses the T antenna structure is increased, and it may be considered that two IFA structures are formed. Similarly, dual antennas 100 may be designed. This may be considered as a variant of the embodiment shown in FIG. 57, as shown in FIG. 70 and FIG. 71. The antenna structures in FIG. 70 and FIG. 71 are generally respectively similar to the structures of the antenna 100 shown in FIG. 67 and FIG. 68, except that ground ends 1011 of the first radiator 1013 and the second radiator 1014 are separated, so that the ground ends 1011 are at a specific distance, for example, between 5 mm and 30 mm. In an embodiment, another part of the side frame, or an insulation slot, or both may be disposed between the separate ground ends 1011 of the first radiator 1013 and the second radiator 1014. In the T antenna structures shown in FIG. 70 and FIG. 71, better impedance matching performance is obtained, and therefore performance of the antenna 100 is further improved. FIG. 72 shows design effect of the dual antennas 100 when a distance between the ground ends 1011 of the two radiators is 15 mm, and compares the design effect with that of a single distributed antenna 100 implemented through only a short transmission line. Efficiency of the three types of antennas is slightly better than that of the foregoing T antenna structure.

For comparison, by using the case shown in FIG. 70 as a first antenna, the antenna 100 in FIG. 71 when the first feeding part 1031 performs feeding as a second antenna, and the antenna 100 in FIG. 71 when the second feeding part 1032 performs feeding as a third antenna, FIG. 72 separately shows a diagram of S11 curves of the three types of antennas 100 and a diagram of efficiency of each antenna 100 in a free space scenario. It can be learned that, by extending a distance between the ground ends 1011 of the radiator pair 101 of the T antenna structure, antenna efficiency can be higher, and performance of the antenna 100 can be further improved.

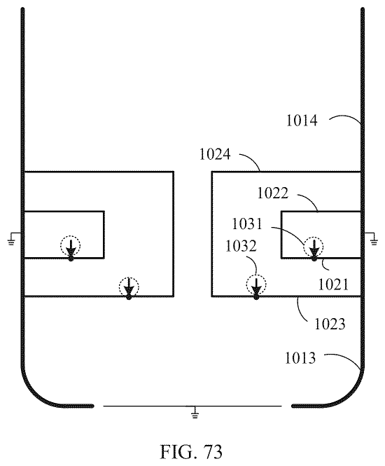

In some embodiments, two antennas 100 according to embodiments of this application may be further combined to form a 4×MIMO antenna. As shown in FIG. 73, two antennas 100 shown in FIG. 68 are included. In this manner, a combined T antenna can support a low frequency band and a medium and high frequency band at the same time, and has high isolation, so that the antenna 100 supports an ultra-broadband frequency band range, and further implements a MIMO antenna 100 that is increasingly widely applied.

The antenna 100 according to embodiments of this application may use the T antenna structure to support various frequency bands such as a low frequency band and a medium and high frequency band. In some embodiments, the antenna 100 according to embodiments of this application may further use an IFA antenna structure, as shown in FIG. 74. This may be considered as a variation of the antenna structure shown in FIG. 55. FIG. 74 shows a case in which a first transmission line is divided into a first section 1021 and a second section 1022 of unequal equivalent lengths to respectively feed a radiator pair 101. As mentioned above, by setting a difference between the equivalent lengths of the two sections to between ⅛ and ⅜ of a dielectric wavelength, for example, approximately ¼ of a dielectric wavelength, a phase difference Φ may be introduced at feeding points at which the two sections are respectively coupled to the radiator pair 101, and the phase difference is within a range of 90°±45°, to optimize performance of the antenna 100. The following mainly uses an example in which the antenna 100 that uses the IFA structure operates in a low frequency band (for example, 0.9 GHz) and a transmission line uses a 50 ohm microstrip to show improvement of various types of performance of the antenna 100 through asymmetric feeding.

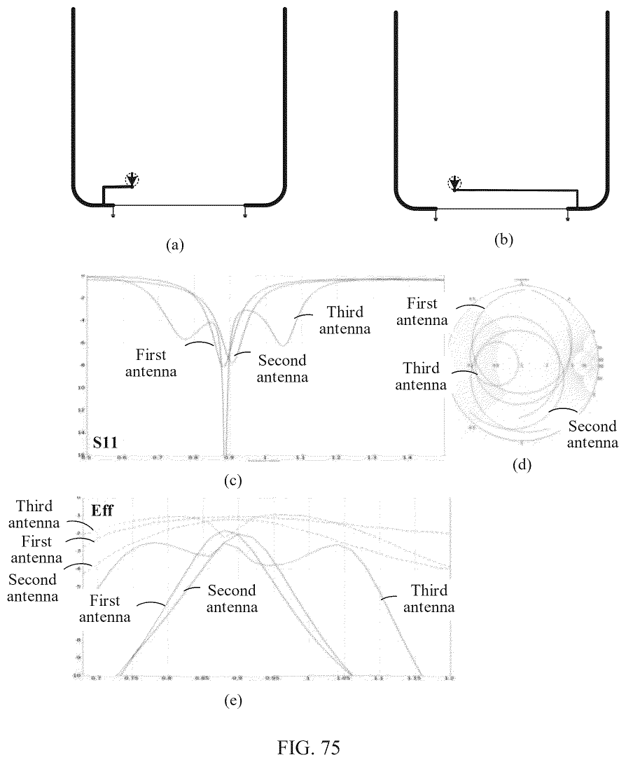

In the specific low frequency band, a total length of the radiator pair 101 may be between ¼ of a dielectric wavelength and ¾ of a dielectric wavelength, for example, between 90 mm and 135 mm, where a length of the first radiator 1013 and a length of the second radiator 1014 may be respectively between 40 mm and 70 mm. For example, in some embodiments, both the first radiator 1013 and the second radiator 1014 may include a corner part of a side frame, as shown in FIG. 74. In addition, a length L1 of the first radiator 1013 may be the same as a length L2 of the second radiator 1014, and is approximately 58.5 mm. In this case, the total length of the radiator pair 101 is 115 mm. A distance between ground ends 1011 of the two radiators may be within a range of 30 mm to 40 mm, for example, may be set to 36 mm. A slot may be disposed between the radiator pair 101 and another part of the side frame, and a width of the slot may be within 3 mm. For example, in some embodiments, the width may be 2 mm, 1 mm, or the like. The slot may be filled with a non-conductive material. In embodiments of this application, the first section 1021 of the first transmission line may be set to ¼ dielectric wavelength shorter than that of the second section 1022. In an embodiment, a current that is of the first transmission line and that is at the feeding points on the two radiators has a 90° phase difference. It should be understood that the 90° phase difference mentioned in this specification may allow a specific deviation, instead of mathematically strict 90°. For example, the current that is of the first transmission line and that is at the feeding points of the two radiators may have a 90°±45° phase difference, or a 90°±30° phase difference. For example, a ratio T1/T2 of the lengths of the first section 1021 and the second section 1022 may satisfy ¼≤T1/T2≤½. When the antenna shown in FIG. 74 operates in a low frequency band like below 1.2 GHz, a difference between the lengths of the first section 1021 and the second section 1022 may be between 25 mm and 45 mm. When the antenna operates in a medium and high frequency band like below 3 GHz, a difference between the lengths of the first section 1021 and the second section 1022 may be between 12 mm and 22 mm. The length mentioned above is an equivalent length of a transmission line existing when there is only one transmission line between the feeding unit and the radiator pair. In addition to the transmission line, a capacitor, an inductor, a phase shifter, and the like may further be disposed between the feeding unit and the radiator pair. Therefore, an actual physical length of the transmission line may be within a range of ±⅓ of the equivalent length (the equivalent length×(1±⅓)), or an actual physical length of the transmission line may be within a range of ±¼ of the equivalent length (the equivalent length×(1±¼)). In this way, antenna performance can be significantly improved. An antenna pair in an IFA form is used as an example for description. Specifically, by using the first radiator 1013 shown in (a) in FIG. 75 when being excited alone as a first antenna, the second radiator 1014 shown in (b) in FIG. 75 when being excited alone as a second antenna, and the two radiators shown in FIG. 74 when being simultaneously excited by a 90° phase difference as a third antenna. (c) in FIG. 75 shows a diagram of an S11 curve of each antenna, (d) in FIG. 75 shows a Smith chart of the antennas 100, and (e) in FIG. 75 shows a diagram of efficiency of each antenna 100. It can be found that a distributed antenna designed with the 90° phase difference can excite three resonances, and an efficiency bandwidth is improved by more than twice compared with a resonance generated by exciting a single radiator.

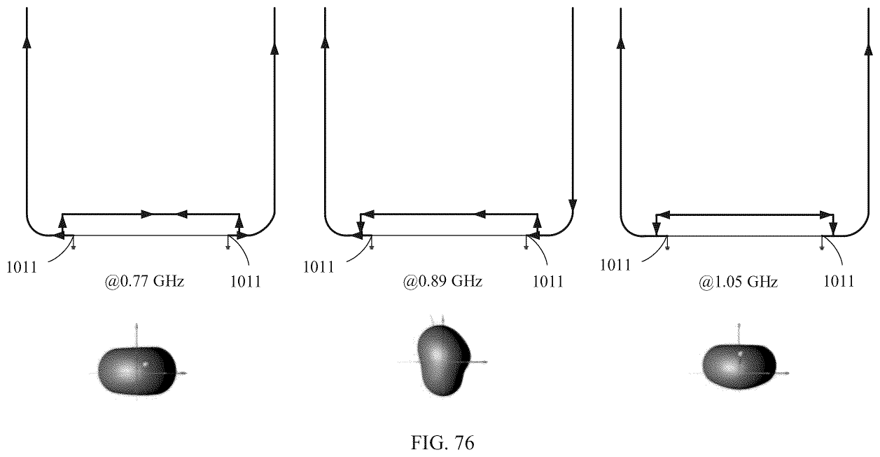

FIG. 76 further shows diagrams of current directions and radiation patterns corresponding to three resonance frequencies in a specific frequency band when the asymmetric feeding manner shown in FIG. 74 is used. It can be learned from FIG. 76 that, when the antenna 100 operates at resonance frequencies of 0.77 GHz and 1.05 GHz, a maximum radiation direction in the radiation pattern is horizontal distribution. In this case, the antenna 100 operates in a first mode. A difference lies in that when the resonance frequency is 0.77 GHz, a current path passes through the ground ends 1011 of the radiators, when the resonance frequency is 1.05 GHz, a current path passes through only the feeding points, but does not pass through the ground ends 1011. When the antenna 100 operates at a resonance frequency of 0.89 GHz, a maximum radiation direction in the radiation pattern is vertical distribution. In this case, the antenna 100 operates in a second mode. It can be found that the antenna 1M designed with the 90° phase difference can excite three resonances, and one more resonance can be excited than two radiators that are separately fed and excited, so that an efficiency bandwidth is significantly improved.

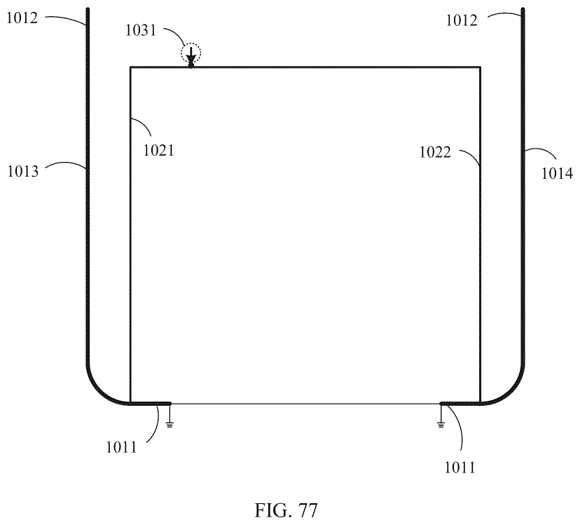

Based on the foregoing asymmetric distributed feeding, in some embodiments, an equivalent length of a transmission line may be extended. For example, FIG. 77 shows an example of a variation of an antenna structure according to an embodiment of this application, which is obtained based on the antenna structure shown in FIG. 74 by respectively extending the first section 1021 and the second section 1022 by ¼ of a dielectric wavelength. Therefore, a total equivalent length is extended by approximately ½ of a dielectric wavelength. A phase difference of a guided wave from a feeding part to a feeding point is still 90°. In a specific low frequency band (for example, 0.9 GHz mentioned above), a distance between a first feeding part 1031 and the first radiator 1013 is approximately between 15 mm and 25 mm, for example, approximately 19 mm.

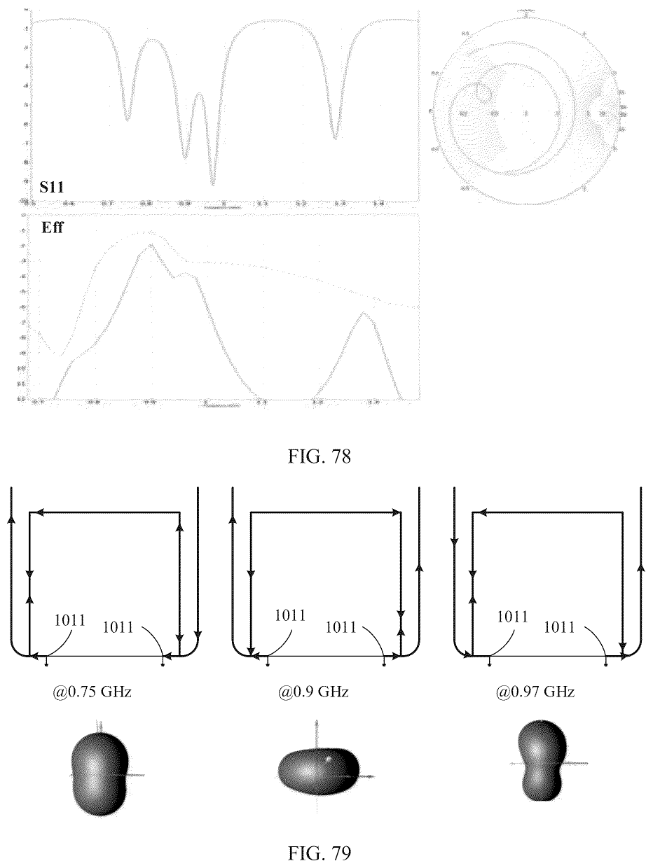

FIG. 78 shows a diagram of an S11 curve, a Smith chart, and a diagram of efficiency of the antenna 100 in this arrangement. It can be learned that, after distributed feeding is performed, the antenna 100 in this arrangement may still generate three resonance modes in a low frequency band. FIG. 79 shows diagrams of current directions and radiation patterns corresponding to the resonance frequencies. It can be learned from the figure that, when the antenna 100 operates at resonance frequencies of 0.75 GHz and 0.97 GHz, a maximum radiation direction in the radiation pattern is horizontal distribution. In this case, the antenna 100 operates in a first mode. A difference lies in that when the resonance frequency is 0.75 GHz, a current path passes through the ground ends 1011 of the radiators; when the resonance frequency is 0.97 GHz, a current path passes through only the feeding points, but does not pass through the ground ends 1011. When the antenna 100 operates at a resonance frequency of 0.9 GHz, a maximum radiation direction in the radiation pattern is vertical distribution. In this case, the antenna 100 operates in a second mode. It may be found that, similar to a case in which a shorter transmission line is used, when a longer transmission line is used, the antenna 100 designed with the 90° phase difference can excite three resonances, and one more resonance can be excited than two radiators that are separately fed and excited, so that an efficiency bandwidth is significantly improved.

Based on the foregoing two designs, two distributed feeding structures are combined to form a dual-antenna 100 system shown in FIG. 80. A difference from the case shown in FIG. 77 lies in that, to reduce a physical length of the second transmission line and ensure that an equivalent length of the second transmission line remains unchanged, an inductor of a predetermined size (for example, 2 nH to 10 nH) is connected in series to the antenna 100 corresponding to the second feeding part 1032 at a junction between a feeder and the radiators. Actually, when a physical length of a transmission line is limited, an equivalent length may be ensured to be within a proper range by using an inductor, a capacitor, or the like. This will be further described below. For the dual-antenna 100 system shown in FIG. 80, a total length of the radiator pair 101 may be between ¼ of a dielectric wavelength and ¾ of a dielectric wavelength, for example, between 90 mm and 135 mm, where a length of the first radiator 1013 and a length of the second radiator 1014 may be respectively between 40 mm and 70 mm. For example, in some embodiments, both the first radiator 1013 and the second radiator 1014 may include a corner part of a side frame, as shown in FIG. 80. In addition, a length L1 of the first radiator 1013 may be the same as a length L2 of the second radiator 1014, and is approximately 58.5 mm. In this case, the total length of the radiator pair 101 is 115 mm. A distance between ground ends 1011 of the two radiators may be within a range of 30 mm to 40 mm, for example, may be set to 36 mm. A slot may be disposed between the radiator pair 101 and another part of the side frame, and a width of the slot may be within 3 mm. For example, in some embodiments, the width may be 2 mm or 1 mm. The slot may be filled with a non-conductive material.

The transmission line structure in FIG. 80 is applicable to any embodiment of this application. For example, in the embodiment shown in FIG. 70 or FIG. 71, to obtain an appropriate equivalent length, a capacitor, an inductor, or even a phase shifter may be disposed on at least one transmission line when a physical length of the transmission line remains unchanged. In this case, an actual physical length of the transmission line may be within a range of ±⅓ of the equivalent length (equivalent length×(1±⅓)) or within a range of ±¼ of the equivalent length (equivalent length×(1±¼)).

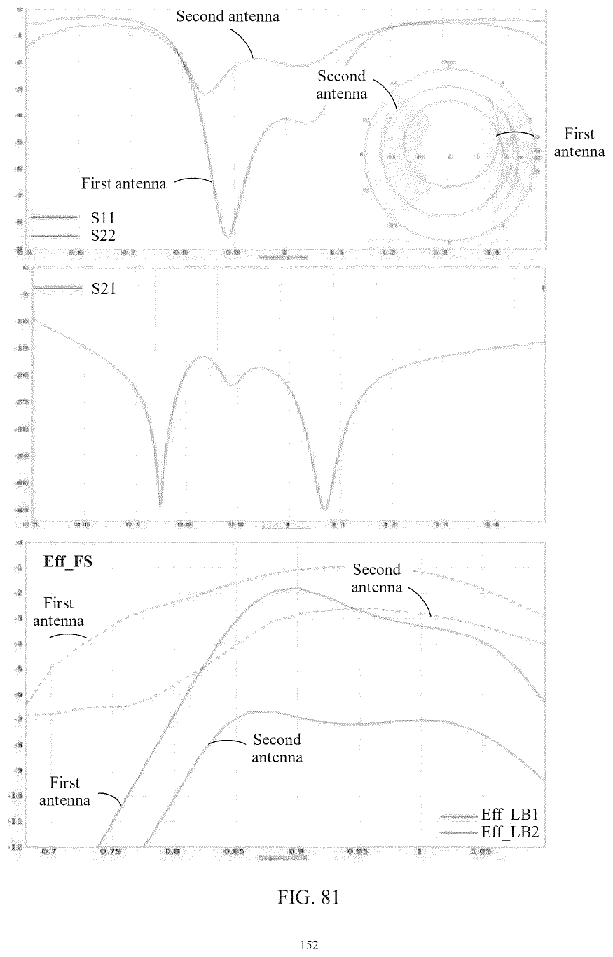

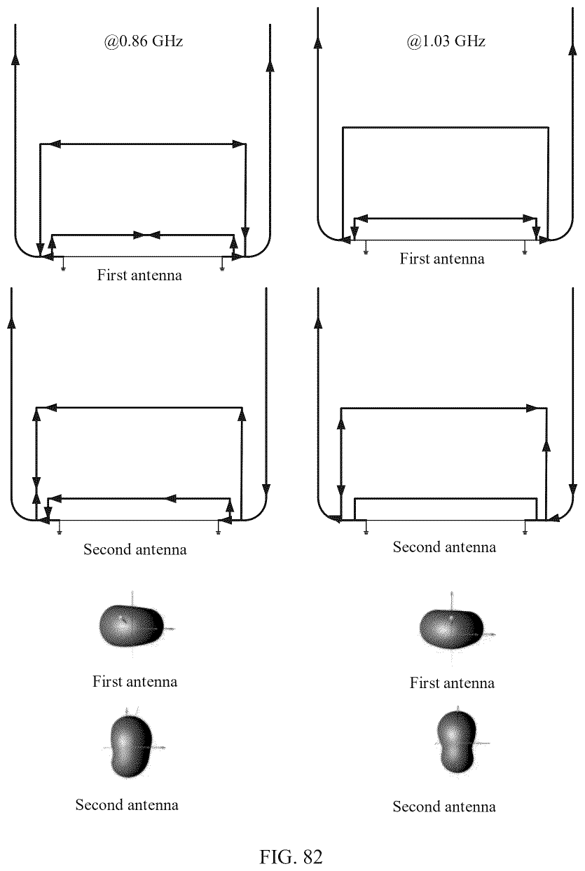

By using the first feeding part 1031 shown in FIG. 80 when performing feeding as a first antenna, and the second feeding part 1032 shown in FIG. 80 when performing feeding as a second antenna, FIG. 81 shows diagrams of S11 curves, S21 curves, and antenna efficiency and a Smith chart of the antennas 100. It can be learned from the figure that in a same frequency band, both the first antenna and the second antenna excite two modes, and isolation is greater than 16 dB. FIG. 82 shows diagrams of current directions and radiation patterns corresponding to the antenna shown in FIG. 80 when the antenna operates at resonance frequencies. It can be learned from the figure that, when the first antenna operates at resonance frequencies of 0.86 GHz and 1.03 GHz, a maximum radiation direction in the radiation pattern is horizontal distribution, and the first antenna operates in a first mode. A difference lies in that when the resonance frequency is 1.03 GHz, a current path passes through only the feeding points, but does not pass through the ground ends 1011. In the foregoing two resonance frequencies, a maximum radiation direction in the radiation pattern of the second antenna is vertical distribution. In other words, the second antenna operates in a second mode. It can be found that, by using the foregoing arrangement manner, the antennas 100 can implement broadband coverage and implement high isolation between the antenna pair.

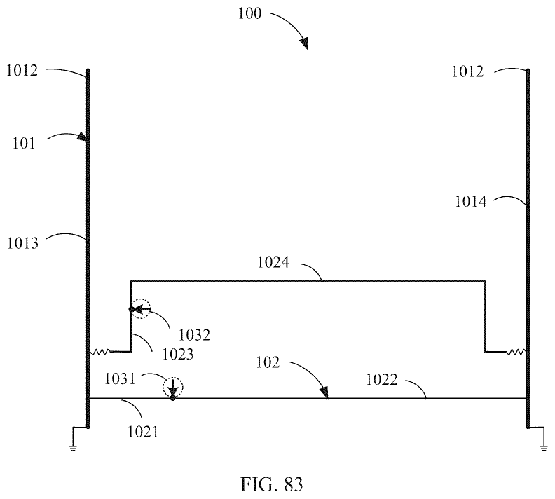

In some embodiments, a position of a radiator of the antenna may be further changed. For example, in some embodiments, to reduce impact of hand holding, the radiator pair of the antennas shown in FIG. 80 may be moved upward from the bottom of a mobile phone to the waist of an electronic device, as shown in FIG. 83. Similar to the foregoing case, after the radiators are moved upward, a total length of the radiator pair 101 may still be between ¼ dielectric wavelength and ¾ dielectric wavelength, for example, between 90 mm and 135 mm, where a length of the first radiator 1013 and a length of the second radiator 1014 may be respectively between 40 mm and 70 mm. For example, in some embodiments, the first radiator 1013 and the second radiator 1014 are respectively located on a left side edge and a right side edge of the side frame, and are parallel to each other, as shown in FIG. 83. In addition, a length L1 of the first radiator 1013 may be the same as a length L2 of the second radiator 1014, and is approximately 55 mm. In this case, the total length of the radiator pair 101 is 110 mm. A distance that is between ground ends 1011 of the two radiators and that is along the side frame may be within a range of 30 mm to 200 mm, for example, may be set to 145 mm. A slot may be disposed between the radiator pair 101 and another part of the side frame, and a width of the slot may be within a range of 1 mm to 3 mm. For example, in some embodiments, the width may be 2 mm. The slot may be filled with a non-conductive material.

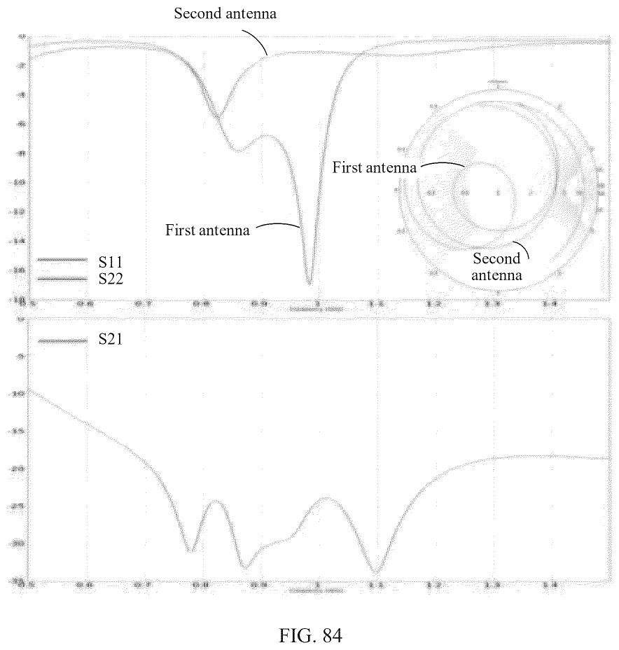

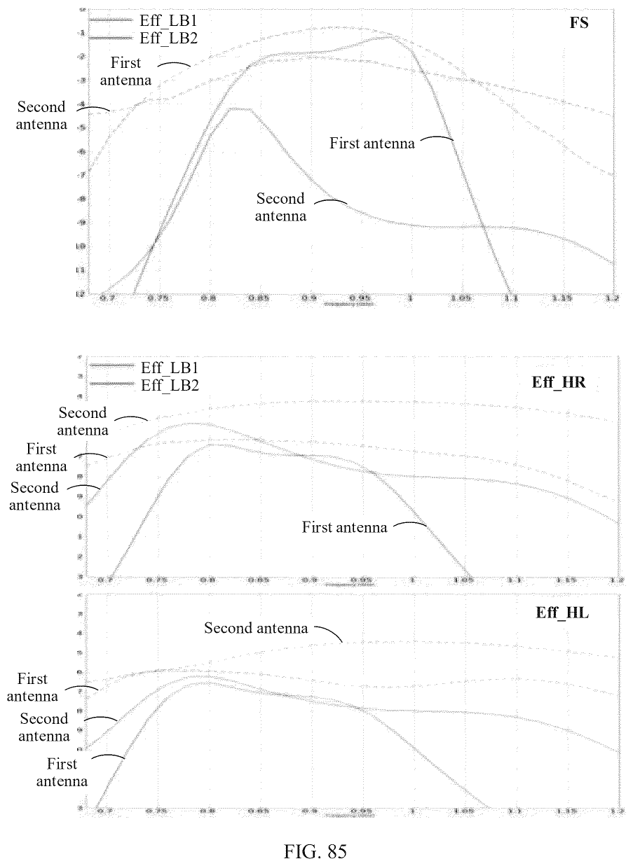

By using the first feeding part 1031 shown in FIG. 83 when performing feeding as a first antenna, and the second feeding part 1032 shown in FIG. 83 when performing feeding as a second antenna, FIG. 84 shows diagrams of S11 curves, S21 curves, and antenna efficiency and a Smith chart of the antennas 100. It can be learned from the figure that the dual antennas 100 in this arrangement can still maintain high isolation (as shown in the diagram of the S21 curves). FIG. 85 separately shows diagrams of efficiency of each antenna 100 in a free space scenario, a right-hand handheld mode, and a left-hand handheld mode. It can be found that, although the second antenna has low efficiency in a case of free space, in a handheld mode, an efficiency bandwidth of the second antenna is very good, and even exceeds that of the first antenna.

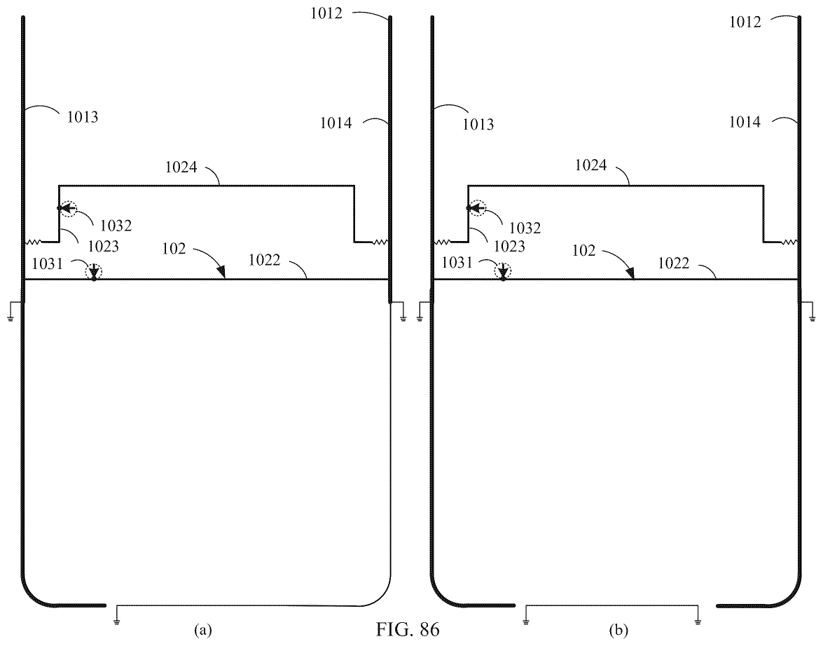

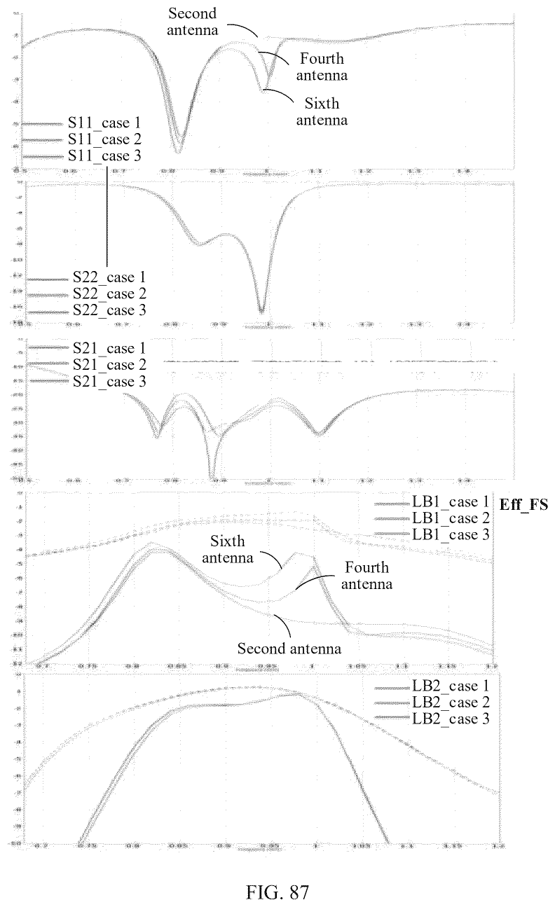

In some embodiments, structures of the radiators of the antenna 100 shown in FIG. 83 may be further adjusted to further optimize performance of the antenna 100. For example, a bandwidth of the antenna 100 may be further improved by increasing branches of the radiators, as shown in FIG. 86. In (a) in FIG. 86, a radiator of an IFA structure on one side is reversely extended by a length from the ground end 1011 to form a T antenna structure. Alternatively, as shown in (b) in FIG. 86, radiators of IFA structures on two sides are extended in a direction of the ground end 1011 to form a T antenna structure.

By using the first feeding part 1031 shown in FIG. 83 when performing feeding as a first antenna, the second feeding part 1032 shown in FIG. 83 when performing feeding as a second antenna, the first feeding part 1031 shown in (a) in FIG. 86 when performing feeding as a third antenna, the second feeding part 1032 shown in (a) in FIG. 86 when performing feeding as a fourth antenna, the first feeding part 1031 shown in (b) in FIG. 86 when performing feeding as a fifth antenna, and the second feeding part 1032 shown in (b) in FIG. 86 when performing feeding as a sixth antenna. FIG. 87 shows diagrams of S11 and S21 curves and antenna efficiency of the antennas 100. The diagrams of S11 curves and antenna efficiency of the first antenna, the third antenna, and the fifth antenna are not greatly different, and are not separately marked. It can be learned from the figure that, by continuously adjusting the structures of the radiators, an antenna mode may be increased, and isolation is basically not affected. In a single-side T antenna 100 (as shown in (a) in FIG. 86) and a dual-side T antenna structure (as shown in (b) in FIG. 86), free space performance of the fourth antenna and the sixth antenna in a part of a frequency band may be improved by 2 dB to 3 dB when compared with that of the second antenna.

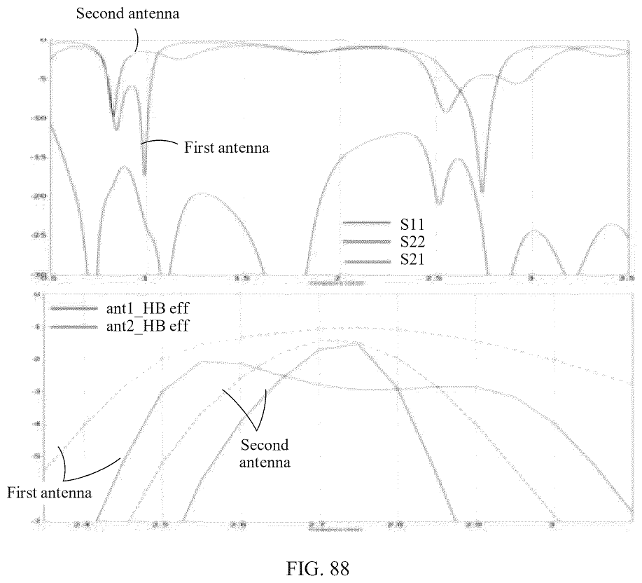

In addition, the antenna structure shown in FIG. 83 may further be applied to a high frequency band antenna. FIG. 88 shows diagrams of S11 and S21 curves and efficiency of the antenna structure shown in FIG. 83 when the antenna structure operates in a frequency band of 2.5 GHz to 2.9 GHz. In FIG. 88, the first feeding part 1031 in the antenna 100 shown in FIG. 83 when performing feeding is used as a first antenna, and the second feeding part 1032 is used as a second antenna. It can be learned that the dual-antenna structure shown in FIG. 83 can still achieve isolation of more than 15 dB in the frequency band of 2.5 GHz to 2.9 GHz.

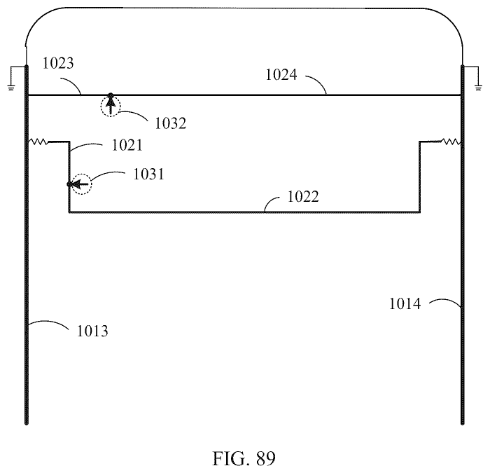

In addition, when the antenna 100 that uses the IFA structure according to embodiments of this application is used in a medium and high frequency band, in some embodiments, the radiator pair 101 of the antenna 100 may be symmetrically disposed in areas on two top sides of a side frame of an electronic device, as shown in FIG. 89. FIG. 89 shows a dual-antenna 100 system formed by asymmetrically feeding a shorter transmission line (a first transmission line) and a longer transmission line (a second transmission line) with an approximately ½ additional dielectric wavelength (for example, based on 2 GHz).

For the dual-antenna 100 system shown in FIG. 89, a total length of the radiator pair 101 may be between ¼ of a dielectric wavelength and ¾ of a dielectric wavelength, for example, in a frequency band of 2 GHz, between 25 mm and 55 mm, where a length of the first radiator 1013 and a length of the second radiator 1014 may be respectively between 12 mm and 30 mm. For example, in some embodiments, a length L1 of the first radiator 1013 and a length L2 of the second radiator 1014 may be the same, for example, approximately 20 mm in a frequency band corresponding to 2 GHz. In this case, the total length of the radiator pair 101 is 40 mm. A distance between ground ends 1011 of the two radiators may be within a range of 90 mm to 150 mm, for example, may be set to 129 mm. A slot may be disposed between the radiator pair 101 and another part of the side frame, and a width of the slot may be within a range of 1 mm to 3 mm. For example, in some embodiments, the width may be 2 mm. The slot may be filled with a non-conductive material.

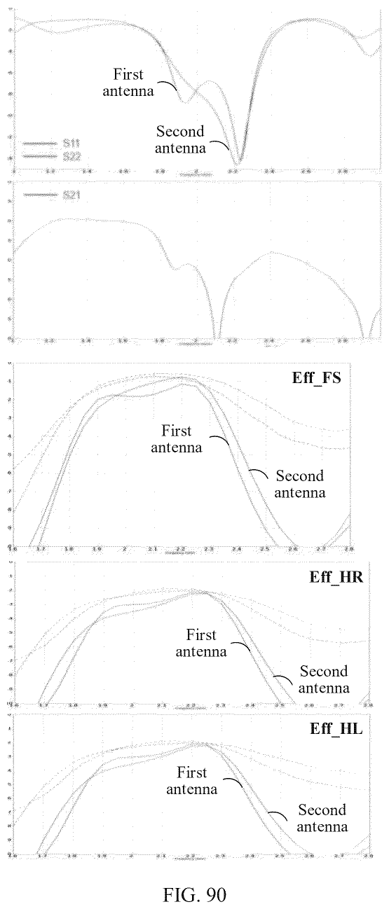

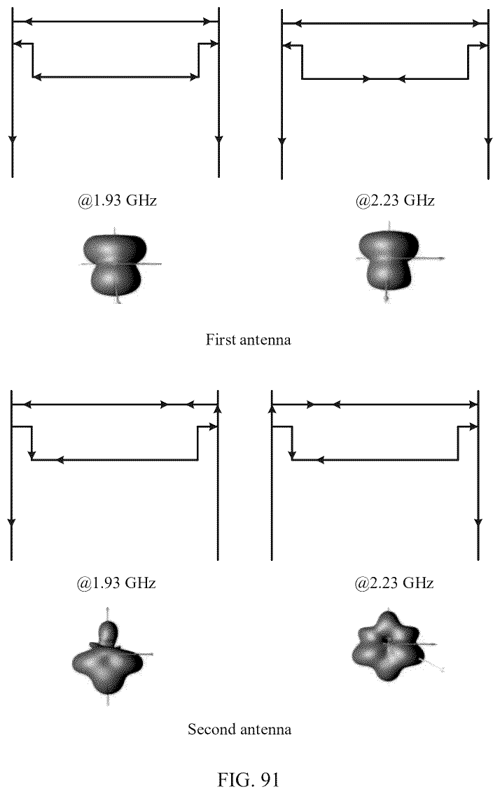

By using the first feeding part 1031 shown in FIG. 89 when performing feeding as a first antenna, and the second feeding part 1032 when performing feeding as a second antenna. FIG. 90 shows, from top to bottom, diagrams of S11 and S21 curves and diagrams of antenna efficiency in a free space mode, a right-hand handheld mode, and a left-hand handheld mode of the antennas 100. It can be learned from the figure that, in a frequency band of 1.8 GHz to 2.4 GHz, each antenna 100 has a dual mode, and isolation reaches more than 15 dB. The diagrams of efficiency curves in the free space and handheld modes also show that performance of the two antennas is very close. FIG. 91 further provides diagrams of current directions and radiation patterns of the two antennas 100 at different resonance frequencies. An ECC of each of the two antennas is less than 0.1. In addition, it may be found that excitation currents of the first antenna on the radiator pair 101 are codirectional, and excitation currents of the second antenna on the radiator pair 101 are reverse, so that the two antennas 100 can implement high isolation. In addition, because of a relative high frequency, the first transmission line is basically close to a 3/2 dielectric wavelength, that is, is basically approximately 115 mm, and the second transmission line is basically close to 1-fold dielectric wavelength, that is, is basically approximately 75 mm.

Table 2 is an SAR simulation table when the first antenna, the second antenna, and a single-side IFA antenna 100 (a third antenna) operate in a medium and high frequency band of 1.8 GHz to 2.4 GHz. It can be learned from Table 2 that the first antenna and the second antenna are low SAR antennas. SAR values of the first antenna and the second antenna are reduced by 2 dB to 3 dB when compared with that of the third antenna.

TABLE 2

| | | First antenna | | Second antenna | | Third antenna |
|---|---|---|---|---|---|---|
| Input power | Resonance | 1.9 GHz | 2.25 GHz | 1.9 GHz | 2.22 GHz | 2 GHz |
| 24 dBm | frequency | | | | | |
| Radiation efficiency | | −1.46 | −0.95 | −1.13 | −0.65 | −0.4 |
| FS system | Rear −5 mm | −2.28 | −1.13 | −2.41 | −0.78 | −0.62 |
| efficiency | Right −5 mm | −2.03 | −1.05 | −2.12 | −1.09 | |
| | Left −5 mm | −2.12 | −0.99 | −2.29 | −1.05 | −0.58 |
| Simulation | Rear −5 mm | 1.15 | 1.66 | 0.72 | 1.29 | 2.30 |
| SAR value | Right −5 mm | 1.08 | 1.02 | 0.70 | 1.64 | |
| | Left −5 mm | 1.13 | 1.13 | 0.89 | 1.51 | 2.59 |
| Normalized | FS | −5 | −5 | −5 | −5 | −5 |
| efficiency | normalization | | | | | |
| Normalized | Rear −5 mm | 0.61 | 0.68 | 0.40 | 0.49 | 0.84 |
| SAR value | Right −5 mm | 0.55 | 0.41 | 0.36 | 0.67 | |
| | Left −5 mm | 0.58 | 0.45 | 0.48 | 0.61 | 0.94 |

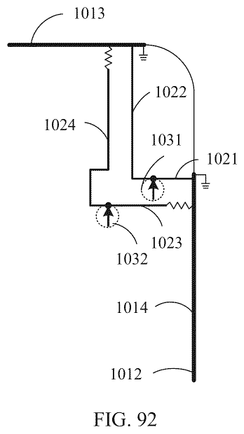

For an antenna 100 that uses a radiator with an IFA structure, in some embodiments, especially when the antenna 100 is used in a medium and high frequency band, at least a part of a first radiator 1013 and at least a part of a second radiator 1014 are located on different edges of a side frame, and the different edges are connected at a corner of the side frame. For an electronic device whose frame is basically rectangular, in some embodiments, one radiator in a radiator pair 101 may be disposed on a top side edge or a bottom side edge of the side frame of the electronic device, and the other radiator is disposed on a left side edge or a right side edge. FIG. 92 shows a case in which the first radiator 1013 is disposed on the top side edge and the second radiator 1014 is disposed on the right side edge. It should be understood that this application is not limited thereto, and any other arrangement manner may be used. In this manner, the antenna 100 may still be ensured to implement a broadband dual-antenna design.

For the dual-antenna 100 system shown in FIG. 92, a total length of the radiator pair 101 may be between ¼ of a dielectric wavelength and ¾ of a dielectric wavelength. For example, in a frequency band of 2 GHz, the total length is between 25 mm and 55 mm, where a length of the first radiator 1013 and a length of the second radiator 1014 may be respectively between 12 mm and 30 mm. For example, in some embodiments, a length L1 of the first radiator 1013 may be the same as a length L2 of the second radiator 1014, for example, approximately 20 mm in a frequency band corresponding to 2 GHz. In this case, the total length of the radiator pair 101 is 40 mm. A distance between ground ends 1011 of the two radiators may be within a range of 15 mm to 40 mm, for example, may be set to 23 mm. To reduce a physical length of the second transmission line, an inductor of a predetermined size (for example, 2 nH to 10 nH) is connected in series to the antenna 100 corresponding to the second feeding part 1032 at a junction between a feeder and the radiators. In an embodiment, there is a clearance slot of at least 1 mm between a radiator and a circuit board. In addition, a slot may be disposed between the radiator pair 101 and another part of the side frame, and a width of the slot may be within a range of 1 mm to 3 GHz. For example, in some embodiments, the width may be 2 mm. The slot may be filled with a non-conductive material.

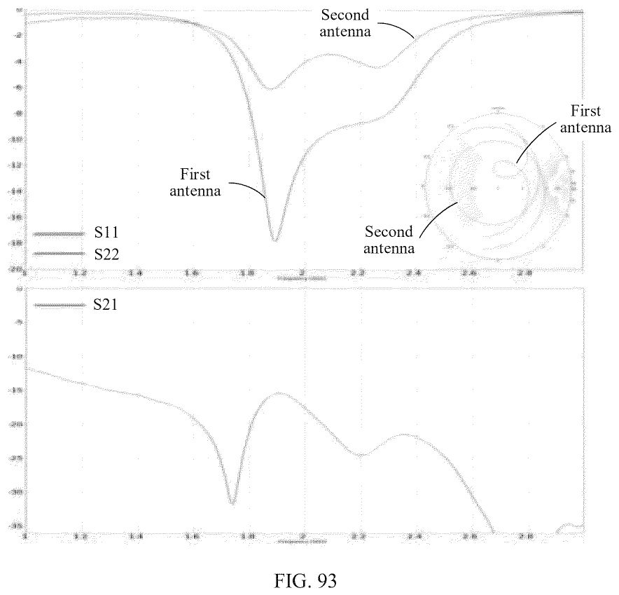

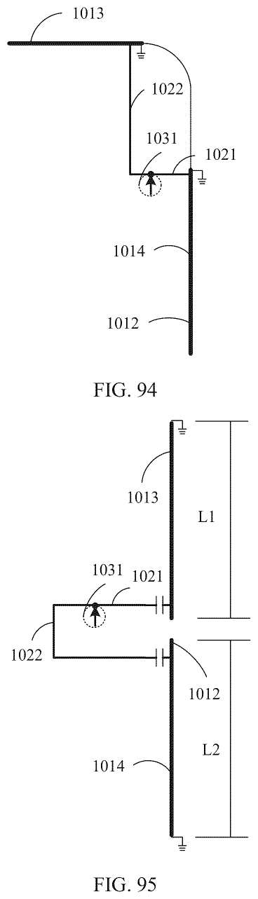

By using the first feeding part 1031 shown in FIG. 92 when performing feeding as a first antenna, and the second feeding part 1032 when performing feeding as a second antenna, FIG. 93 shows, from top to bottom, a diagram of S11 curves, a Smith chart, and a diagram of S21 curves of the antennas 100. It can be learned from the figure that, in a frequency band of 1.8 GHz to 2.4 GHz, each antenna 100 has a dual mode, thereby implementing a broadband dual-antenna 100 design. Table 3 is an SAR simulation table when the first antenna, the second antenna, and a single distributed antenna 100 based on a short transmission line (as shown in FIG. 94, a third antenna) operate in a medium and high frequency band of 1.8 GHz to 2.4 GHz. It can be learned from Table 3 that the first antenna and the third antenna have lower SAR values.

TABLE 3

| | | First antenna | | Second antenna | | Third antenna | | |
|---|---|---|---|---|---|---|---|---|
| Input power | Resonance | 1.9 GHz | 2.25 GHz | 1.9 GHz | 2.25 GHz | 1.7 GHz | 1.98 GHz | 2.3 GHz |
| 24 dBm | frequency | | | | | | | |
| Radiation efficiency | | −0.66 | −0.64 | −1.88 | −1.75 | −0.55 | −0.62 | −0.95 |
| FS system | Top −5 mm | −0.83 | −0.94 | −2.44 | −3.17 | −1.11 | −1.48 | −2.22 |
| efficiency | Rear −5 mm | −1.01 | −1.02 | −3.07 | −3.38 | −1.25 | −1.29 | −1.98 |
| | Left −5 mm | −1.19 | −1.19 | −3.4 | −3.23 | −1.07 | −1.87 | −2.14 |
| Simulation | Top −5 mm | 0.85 | 1.71 | 1.05 | 0.84 | 0.95 | 0.25 | 1.39 |
| SAR value | Rear −5 mm | 1.11 | 1.09 | 2.65 | 2.92 | 1.05 | 2.08 | 1.03 |
| | Left −5 mm | 1.18 | 1.03 | 1.76 | 1.96 | 1.08 | 1.58 | 1.10 |
| Normalized | FS | −5 | −5 | −5 | −5 | −5 | −5 | −5 |
| efficiency | normalization | | | | | | | |
| Normalized | Top −5 mm | 0.33 | 0.67 | 0.58 | 0.55 | 0.39 | 0.11 | 0.73 |
| SAR value | Rear −5 mm | 0.44 | 0.44 | 1.70 | 2.01 | 0.44 | 0.89 | 0.51 |
| | Left −5 mm | 0.49 | 0.43 | 1.22 | 1.30 | 0.44 | 0.77 | 0.57 |

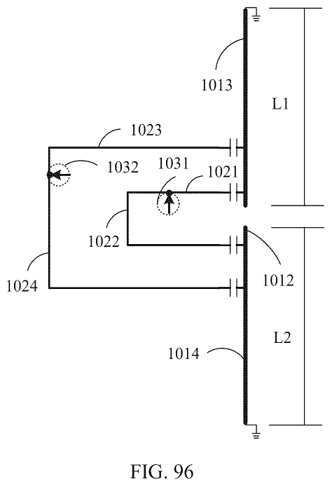

In addition to the foregoing T antenna structure and the IFA antenna structure, in some embodiments, the antenna 100 according to embodiments of this application may further use a slot antenna structure, as shown in FIG. 95 and FIG. 96. To be specific, in some embodiments, open ends 1012 of the radiator pair 101 are opposite to each other and form a slot. In an embodiment, a width of the slot may be within 3 mm, for example, 2 mm or 1 mm. For the antenna 100 shown in each of FIG. 95 and FIG. 96, a total length of the radiator pair 101 may be between ¼ of a dielectric wavelength and ¾ of a dielectric wavelength, for example, in a frequency band of 0.9 GHz, between 70 mm and 110 mm, where a length of the first radiator 1013 and a length of the second radiator 1014 may be respectively between 35 mm and 60 mm. For example, in some embodiments, a length L1 of the first radiator 1013 and a length L2 of the second radiator 1014 may be the same, for example, approximately 45 mm in a frequency band corresponding to 0.9 GHz. In this case, the total length of the radiator pair 101 is 90 mm. To reduce a physical length of a transmission line, a capacitor of a predetermined size (for example, 0.6 pF to 0.9 pF) may be disposed between the transmission line and a radiator. For example, a 0.7 pF capacitor is disposed between a first transmission line and the radiator pair 101, and a 0.8 pF capacitor is disposed between a second transmission line and the radiator pair 101, as shown in FIG. 95 and FIG. 96. In an embodiment, the capacitor disposed between the transmission line and the radiator may further be used to optimize impedance matching.

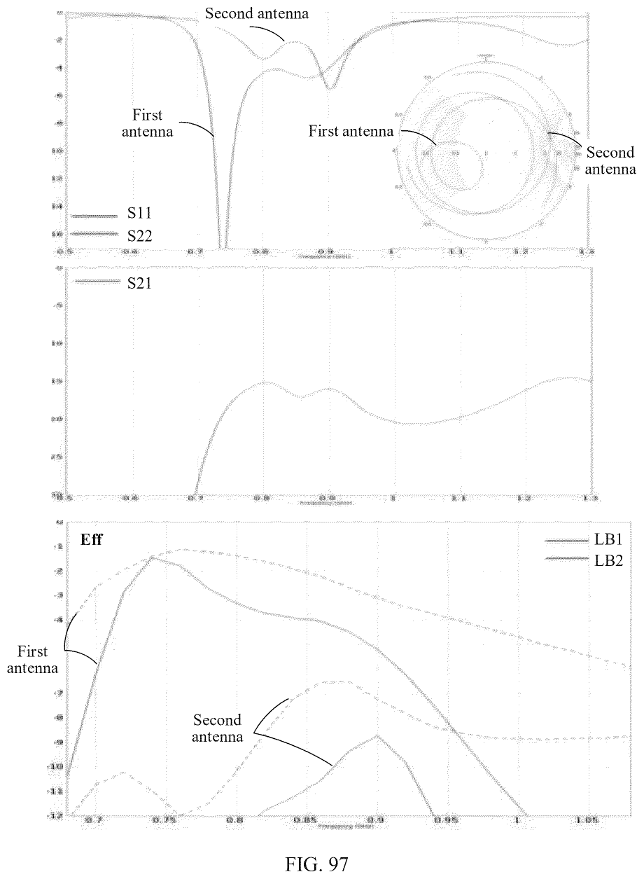

By using a first feeding part 1031 shown in FIG. 96 when performing feeding as a first antenna, and a second feeding part 1032 when performing feeding as a second antenna. FIG. 97 shows, from top to bottom, a diagram of S11 curves, a Smith chart, a diagram of S21 curves, and a diagram of antenna efficiency in a free space mode of the antennas 100. It can be learned from the figure that, in a frequency band of 0.9 GHz, each antenna 100 has a dual mode, and isolation reaches more than 15 dB. FIG. 98 further provides diagrams of current directions and radiation patterns of the two antennas 100 at different resonance frequencies. It may be found that excitation currents of the first antenna on the radiator pair 101 are codirectional, and excitation currents of the second antenna on the radiator pair 101 are reverse, so that the two antennas 100 can implement high isolation.

In addition, for comparison, by using the first feeding part 1031 shown in FIG. 96 when performing feeding as a first antenna, the second feeding part 1032 shown in FIG. 96 when performing feeding as a second antenna, the antenna 100 shown in FIG. 95 as a third antenna, and the antenna 100 shown in (a) in FIG. 99 as a fourth antenna, (b) in FIG. 99 separately shows a diagram of S11 curves and a Smith chart of the four types of antennas 100, and (c) in FIG. 99 shows a diagram of efficiency in a free space scenario of the antennas 100. It can be learned that the first antenna and the second antenna use distributed dual-antenna 100 feeding designs of the slot antenna structure, and each has two modes. The third antenna uses a distributed single-antenna 100 design of the slot antenna structure (only a short transmission line feeding structure is implemented, and there are three modes). The fourth antenna uses a coupled feeding antenna design, and has two modes. It may be found that, in free space, an efficiency bandwidth of the third antenna still has an advantage when compared with that of the fourth antenna.

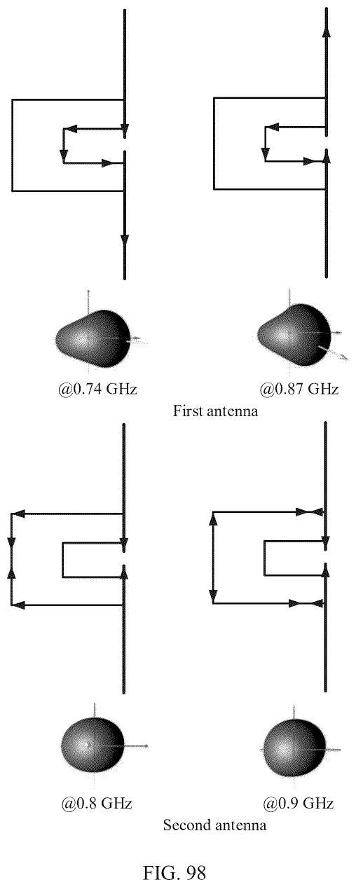

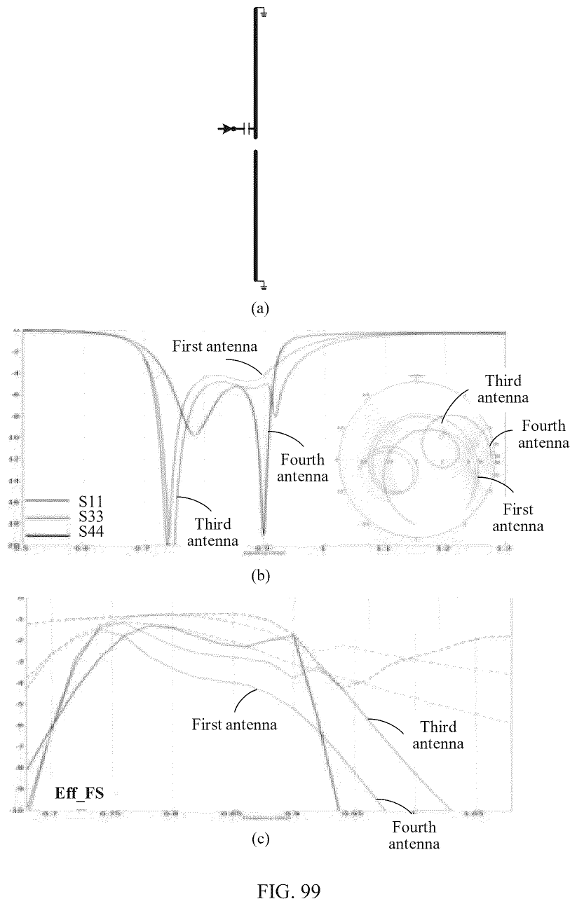

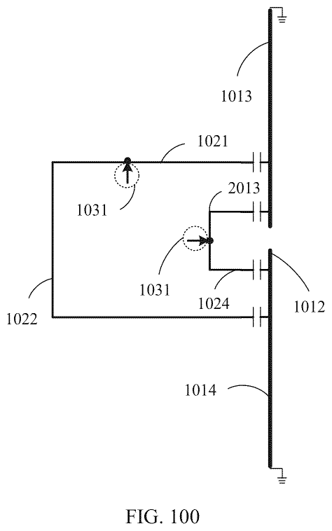

In addition, in some embodiments, the radiator pair 101 of this slot antenna structure may alternatively be connected for feeding through a shorter transmission line. As shown in FIG. 100, a total equivalent length of a first transmission line fed by a first feeding part 1031 is approximately ½ of a dielectric wavelength (corresponding to an odd multiple of ½ of a dielectric wavelength), and an equivalent length of a second transmission line fed by a second feeding part 1032 is only approximately 1/10 of a dielectric wavelength or even shorter. This may be considered as a deformation of the antenna structure shown in FIG. 58. In this case, a difference between the equivalent lengths of the two transmission lines is still within a range of 50 mm to 65 mm.

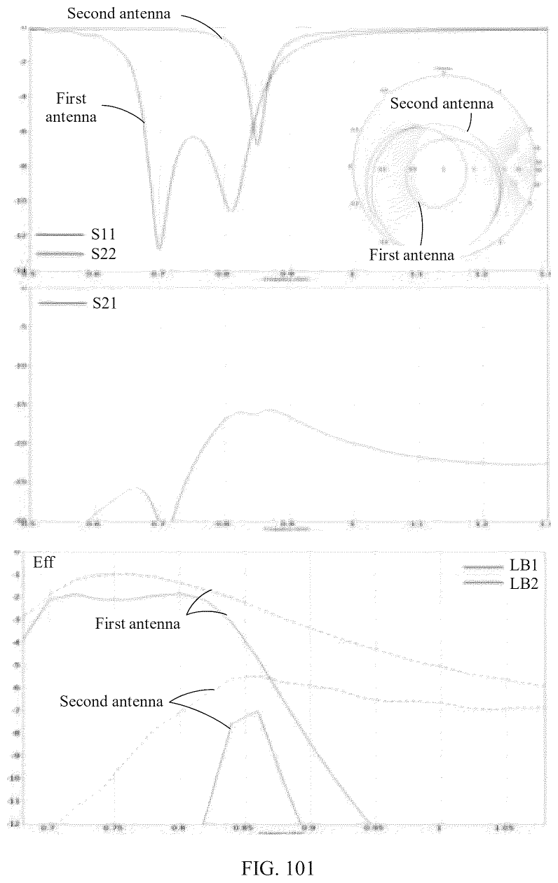

By using the first feeding part 1031 shown in FIG. 100 when performing feeding as a first antenna, and the second feeding part 1032 when performing feeding as a second antenna, FIG. 101 shows, from top to bottom, a diagram of S11 curves, a Smith chart, a diagram of S21 curves, and a diagram of antenna efficiency in a free space mode of the antennas. It can be learned from the figure that, in a frequency band of 0.9 GHz, two antenna pairs can implement high isolation.

The foregoing describes, by using examples, embodiments of the antenna 100 that is considered to use the T antenna structure, the IFA antenna structure, and the slot antenna structure. It should be understood that the foregoing embodiments are described merely to illustrate an inventive concept according to embodiments of this application, and are not exhaustive. Any other proper variations or structures may exist.

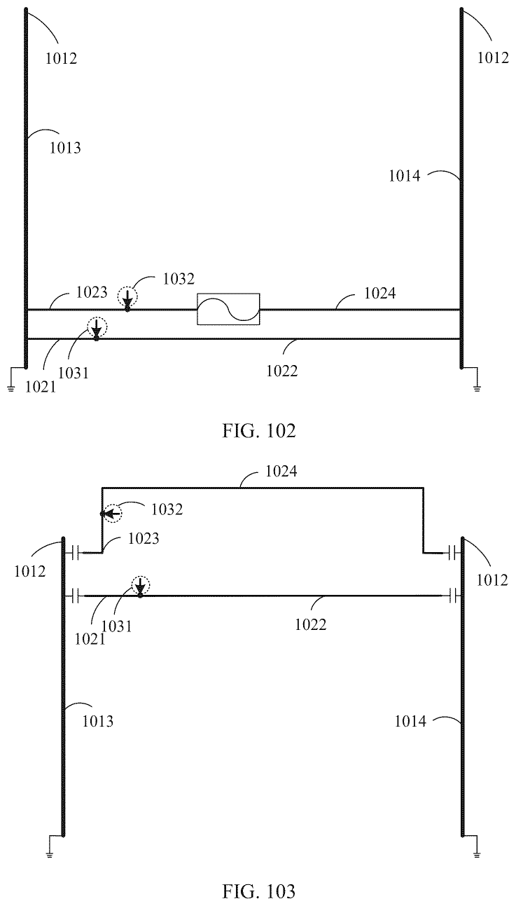

For example, in some embodiments, the equivalent lengths of the first transmission line and/or the second transmission line may be determined based on the physical lengths of the first transmission line and/or the second transmission line, or may be determined by using at least one of the following: a capacitor or an inductor disposed between a corresponding transmission line and a radiator pair 101, a phase shifter disposed on a corresponding transmission line, and a position at which a corresponding transmission line is coupled to the radiator pair 101, or the like. For example, in the foregoing embodiments, it is mentioned that a capacitor is disposed between the transmission line and the feeding point near the open end 1012 of the radiator, and an inductor is disposed between the transmission line and the feeding point near the ground end 1011 of the radiator, so that impedance matching can be optimized and the equivalent length of the transmission line is within the range mentioned above. In addition, FIG. 102 shows a case in which a phase shifter is disposed on one of transmission lines so that a difference of equivalent lengths of the two transmission lines is approximately ½ of a dielectric wavelength. In this manner, when the physical length is limited, another proper manner may be used to ensure that the equivalent length of the transmission line is within the range mentioned above, thereby improving performance of the antenna and even the electronic device.

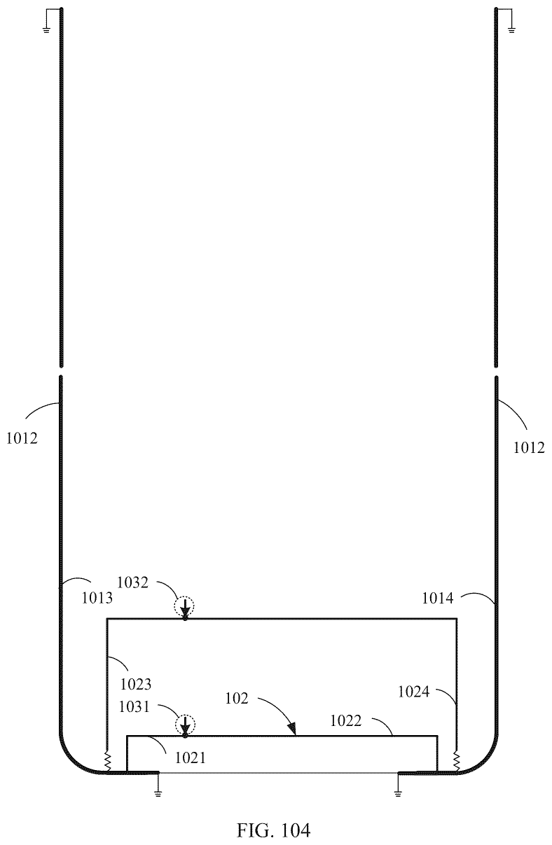

In addition, for a position of a feeding point relative to a radiator, in most of the foregoing embodiments, the feeding point is disposed near the ground end 1011 of the radiator. Certainly, it should be understood that, during actual application, for the IFA antenna 100, based on different application scenarios, both feeding points at which the transmission line and the radiator are connected may be disposed close to the open end 1012, as shown in FIG. 103. In this case, a capacitor of a predetermined size may be disposed at feeding points between the transmission line and the radiator pair 101 to ensure impedance matching while keeping the equivalent length within an appropriate range. In addition, for the slot antenna structure, both feeding points at which the transmission line and the radiator are connected may be disposed close to the ground end 1011, as shown in FIG. 104, to form a combined structure of the slot antenna 100 and the IFA antenna 100. In this case, an inductor of a predetermined size may be disposed at feeding points between the transmission line and the radiator pair 101 to ensure impedance matching while keeping the equivalent length within an appropriate range.

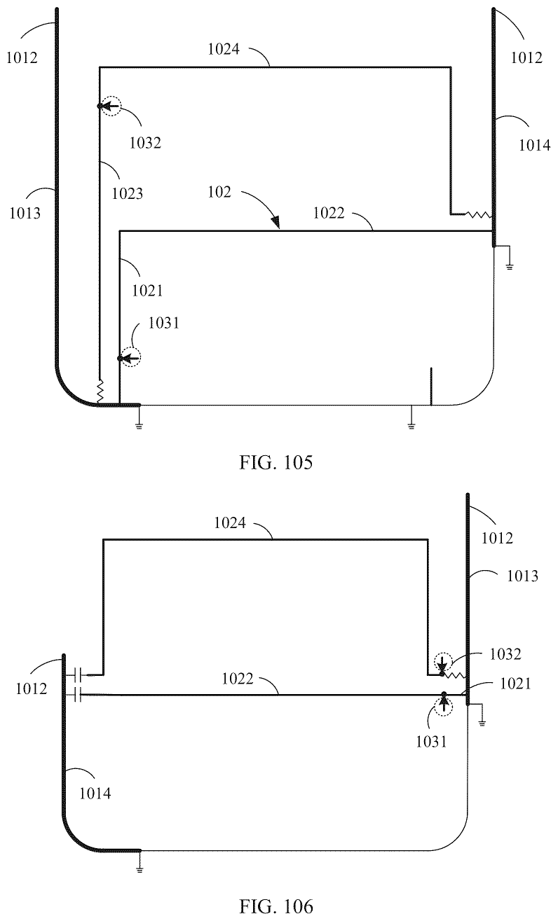

In some embodiments, for the antenna 100 of the IFA antenna structure, that at least a part of a first radiator 1013 and at least a part of a second radiator 1014 are located on different edges of a side frame may also include the case shown in FIG. 105. In such embodiments, the first radiator 1013 may extend from a left side edge (or a right side edge) of the side frame to a bottom edge (or a top edge) through a corner, and the second radiator 1014 may be located on a right side edge (or a left side edge) of the side frame. The antenna 100 of the IFA structure in this arrangement can still implement performance similar to the foregoing performance.

In addition, for the IFA antenna structure, the two transmission lines may be respectively coupled to the open end 1012 and the ground end 1011 of the radiator pair 101, as shown in FIG. 106 and FIG. 107. For example, in some embodiments, the first transmission line is coupled to a first feeding point near the ground end 1011 of the radiator pair 101 by using an inductor, and the second transmission line is coupled to a second feeding point near the open end 1012 of the radiator pair 101 by using a capacitor. In this case, an equivalent length of the second transmission line includes the disposed capacitor and further includes a length between the first feeding point and the second feeding point of the radiator pair 101. The antenna structure obtained in this way can also obtain similar performance as the antenna 100 described in the foregoing embodiments.

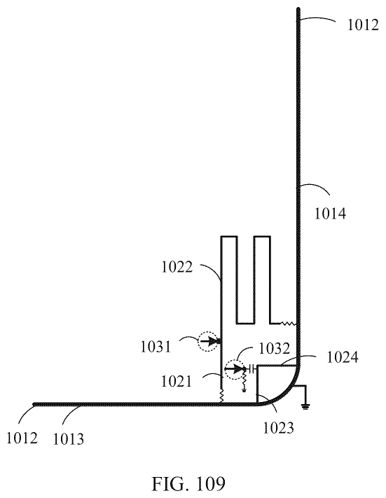

In some embodiments, for the antenna 100 of the T antenna structure, in addition to the case shown in FIG. 66, a consecutive radiator pair 101 may alternatively be disposed on different side edges of the side frame. For example, the radiator pair 101 that is continuously disposed on the side frame may extend from a side edge to a bottom edge or a top edge of the side frame through a corner part. FIG. 108 and FIG. 109 each show a case in which the radiator pair 101 extends from a right side edge to the bottom edge or the top edge of the side frame through the corner part. As shown in FIG. 108, the first transmission line is separately connected close to a ground end of the radiator pair 101 by using an inductor, and the second transmission line is separately connected between the ground end of the radiator pair 101 and two open ends by using a capacitor. As shown in FIG. 109, an equivalent length of the first transmission line may be extended by using a fold line or the like, so that a total equivalent length of the first transmission line is approximately ½ of a dielectric wavelength (corresponding to an odd multiple of ½ of a dielectric wavelength), and an equivalent length of the second transmission line fed by the second feeding part 1032 is only approximately 1/10 of a dielectric wavelength or even shorter (corresponding to an even multiple of ½ of a dielectric wavelength, and the even multiple is 0). In this case, a difference between the equivalent lengths of the two transmission lines is still approximately ½ of a dielectric wavelength, thereby optimizing antenna performance.

In addition, as mentioned above, an existing structure in the side frame of the electronic device may further be used as a transmission line or at least a part of a transmission line. For example, in some embodiments, when a transmission line is shorter (for example, less than or equal to 1/10 of a dielectric wavelength), a protruding part that is integrally formed with a conductive side frame and that protrudes inward may be used as a part of the transmission line or the transmission line, thereby improving integration of the electronic device and optimizing antenna performance.

Although the subject matter is described in a language specific to structural features and/or method logic actions, it should be understood that the subject matter defined in the appended claims is not necessarily limited to the particular features or actions described above. On the contrary, the particular features and actions described above are merely example forms for implementing the claims.

1-24. (canceled)

25. An antenna, comprising:
a first radiator comprising a ground end and an open end;
a transmission line comprising:
a first end coupled to the ground end or to the open end of the first radiator
a second end that is open or grounded; and
a coupling point;
a feeding circuit coupled to the coupling point and configured for feeding the first radiator through the transmission line,
wherein the first radiator is configured to generate a first resonance in a first frequency band, and
wherein the transmission line is configured to generate a second resonance in a second frequency band adjacent to the first frequency band when the feeding circuit performs feeding.

26. The antenna of claim 25, wherein the coupling point deviates from a midpoint of the transmission line.

27. The antenna of claim 25, further comprising a second radiator comprising a second ground end and a second open end, wherein the second end is coupled to either the second ground end or the second open end, wherein the second radiator is configured to generate a third resonance in a third frequency band, and wherein the transmission line is further configured to generate a fourth resonance in a fourth frequency band adjacent to the third frequency band when the feeding circuit performs feeding.

28. The antenna of claim 27, wherein the first end of the transmission line is coupled to the ground end of the first radiator, the second end is grounded or coupled to the ground end of the second radiator, and the coupling point is located proximate to the first end or proximate to the second end, or wherein the first end of the transmission line is coupled to the open end of the first radiator, the second end is open or coupled to the open end of the second radiator, and the coupling point is located proximate to a midpoint of the transmission line.

29. The antenna of claim 27, wherein the first end of the transmission line is coupled to the ground end of the first radiator, wherein the second end is open or coupled to the open end of the second radiator and wherein the coupling point is located proximate to the first end.

30. The antenna of claim 28, wherein a length T of the transmission line satisfies ½λ1≤T≤½λ2, wherein λ1 denotes a minimum dielectric wavelength and λ2 denotes a maximum dielectric wavelength of an operating frequency band corresponding to a lowest resonance generated by the antenna when the feeding circuit performs feeding.

31. The antenna of claim 29, wherein a length T of the transmission line satisfies ¼λ1≤T≤¼λ2, wherein λ1 denotes a minimum dielectric wavelength and λ2 denotes a maximum dielectric wavelength of an operating frequency band corresponding to a lowest resonance generated by the antenna when the feeding circuit performs feeding.

32. The antenna of claim 27, wherein the transmission line is coupled to the first radiator through a first matching circuit, and wherein the transmission line is coupled to the second radiator through a second matching circuit.

33. An antenna, comprising:
a radiator pair comprising:
a first radiator comprising a first ground end and a first open end; and
a second radiator comprising a second ground end and a second open end;
at least one transmission line coupled to the radiator pair, wherein the at least one transmission line comprises a first transmission line, and wherein the first transmission line comprises a first section and a second section of unequal lengths; and
a feeding circuit comprising a first feeding part coupled to the first radiator through the first section and coupled to the second radiator through the second section.

34. The antenna of claim 33, further comprising a matching circuit coupled between the first feeding part and the first transmission line and comprising a capacitor and an inductor, wherein a length of the first transmission line is less than or equal to 1/10 of a dielectric wavelength corresponding to a lowest operating frequency band of the antenna.

35. The antenna of claim 33, wherein either a difference (T2−T1) between lengths of the first section and the second section satisfies 0 mm≤(T2−T1)≤8 millimeters (mm), or a ratio T1/T2 of the lengths of the sections satisfies ½≤T1/T2≤2, wherein T1 is a first length of the first section, and wherein T2 is a second length of the second section.

36. The antenna of claim 33, wherein the at least one transmission line further comprises a second transmission line, wherein the second transmission line comprises a third section and a fourth section of unequal lengths, and wherein the feeding circuit comprises a second feeding part separately coupled to the radiator pair through the third section and the fourth section.

37. The antenna of claim 36, wherein both the first feeding part and the second feeding part are coupled to the first ground end or are coupled to the first open end, and both the first feeding part and the second feeding part are coupled to the second open end or are coupled to the second ground end, or the first feeding part is coupled to the first ground end and the second feeding part is coupled to the first open end, and the first feeding part is coupled to the second open end and the second feeding part is coupled to the second ground end.

38. The antenna of claim 36, wherein the antenna is configured to:
generate a first resonance when the first feeding part performs feeding; and
generate a second resonance when the second feeding part performs feeding.

39. The antenna of claim 36, wherein a ratio T1/T2 of lengths of the first section and the second section of the first transmission line satisfies ¼≤T1/T2≤½; and/or a ratio T3/T4 of the lengths of the third section and the fourth section of the second transmission line satisfies ¼≤T3/T4≤½.

40. The antenna of claim 38, wherein a difference (T6−T5) between a length T6 of the second transmission line and a length T5 of the first transmission line and a first dielectric wavelength λ1 of the first resonance or a second dielectric wavelength λ1 of the second resonance satisfy ¼λ1≤(T6−T5)≤¾λ1 or ¼λ≤(T6−T5)≤¾λ2.

41. The antenna of claim 38, wherein a difference (T6−T5) between lengths of the second transmission line and the first transmission line satisfies 50 mm≤(T6−T5)≤80 mm when the first resonance and the second resonance are in a low frequency band less than 1.2 GigaHertz (GHz); or wherein a difference (T6−T5) between the lengths of the second transmission line and the first transmission line satisfies 25 mm≤(T6−T5)≤40 mm when the first resonance and the second resonance are in a medium and high frequency band less than 3 GHz.

42. An electronic device, comprising:
a housing comprising a side frame;
a circuit board within the housing and comprising a feeding circuit; and
an antenna, comprising:
a first radiator, comprising a ground end and an open end;
a transmission line comprising:
a first end coupled to the ground end or to the open end of the first radiator;
a second end that is open or grounded; and
a coupling point;
a feeding circuit coupled to the coupling point and configured for feeding the first radiator through the transmission line,
wherein the first radiator is configured to generate a first resonance in a first frequency band, and
wherein the transmission line is configured to generate a second resonance in a second frequency band adjacent to the first frequency band when the feeding circuit performs feeding.

43. The electronic device of claim 42, wherein the first radiator and a second radiator are separated on the side frame.

44. The electronic device of claim 42, wherein the first radiator and a second radiator are continuous on the side frame.
